(19) United States
(12) Patent Application Publication
(10) Pub. No.: US 2005/0034083 A1
(43) Pub. Date: Feb. 10, 2005

(54) Intuitive graphic user interface with universal tools

(76) Inventor: Denny Jaeger, Oakland, CA (US)

Correspondence Address: Harris Zimmerman;Law Offices of Harris Zimmerman, Suite 710, 1330 Broadway, Oakland, CA, 94612-2506, US

(21) Appl. No.: 10/671,953

(22) Filed: Sep. 26, 2003

Related U.S. Application Data
(63) Continuation-in-part of application No. 10/635,742, filed on Aug. 5, 2003.

(51) Int. Cl. G09G 5/00

(52) U.S. Cl. 715/863; 715/764; 715/810

(57) ABSTRACT

A graphic user interface (GUI) and method for providing a computer operating environment utilizes a set of universal tools so that an intuitive computer environment. A tool in this universal tool set is a display-and-control graphic element that manages other graphic elements, including other display-and-control graphic elements. The display-and-control graphic elements can be used to create other graphic elements, which are displayed on the display-and-control graphic elements. However, these created graphic elements exist on a global drawing surface. Thus, the graphic elements can interact with any other graphic element, including graphic elements on the global drawing surface, on other display-and-control graphic elements and/or on the same display-and-control graphic element. Another tool in the universal tool set is an information display-and-control graphic element. These graphic elements can be used to modify the appearance or a functionality of an associated graphic element, as well as other operations.

### CROSS REFERENCE TO RELATED APPLICATION

The present application is a continuation-in-part of U.S. patent application Ser. No. 10/635,742, filed Aug. 5, 2003 for which priority is claimed.

### FIELD OF THE INVENTION

The invention relates generally to computer systems, and more particularly to a graphic user interface (GUI) for user input and control functions.

### BACKGROUND OF THE INVENTION

In the early days of computer development, it was determined that an essential component for programming a computer machine is an operating system that links the processor, memory, and peripheral inputs. The operating system was the structural framework that ran the machine, and programs (or applications) were devised that interfaced with the operating system to accomplish desired tasks. Typically, each program was directed toward a particular type of task, such as list processing, word processing, communications, and the like. The operating system ran in the background, and, as a task was taken up, the corresponding program was loaded and run to process the relevant data. User inputs were typically made by punch cards that contained data and commands.

The advent of video display terminals greatly eased the chore of programming and controlling a computer. Programs were written to take advantage of the video interface, but it is important to note that the underlying structure of the machine control remained: an operating system ran the communications between the major components of the computer, and separate programs interacted with the operating system to carry out specific tasks.

Over the past decades, a variety of graphic user interfaces have been developed to ease human interaction with computer systems. It is well known that designing software around a familiar metaphor helps reduce human learning time. Many computer user interfaces incorporate metaphors into their design to maximize human familiarity and better convey information between the user and computer. Interface metaphors such as windows, desktops and menus permit the user to draw upon models or analogies that enable or ease comprehension of the requirements of the particular computer system or program. Today's computer systems increasingly are designed to incorporate so-called “object oriented” display systems that utilize multiple “windows” as interfaces. Using a desktop metaphor, the windows can take the form of a variety of objects such a file folders, documents, or notepads. The windows may overlap one another with the “top” window constituting the current work file. A non-expert user working within the context of a window-based graphic user interface (“GUI”) operates on objects commonly found in an office, and therefore finds him or herself more comfortably interacting with the computer environment.

Despite the apparent sophistication of the multiple windows approach to computing, the fundamental software structures of conventional computers and software still comprise an operating system and separate programs for respective tasks. It is necessary to find and open separate programs to carry out disparate tasks, such as photo editing, music mixing or editing, video editing, spreadsheet processing, word processing, and Internet interactions. Each program creates at least one display window and each window is dedicated to user interaction with the program that created it, and generally no other. Although some word processing programs will permit the (limited) introduction of graphics or sound files, the user will find that it is not possible to perform typical audio program operations (recording, editing and playing) on the imported files while “in” the word processing program.

Computer users take for granted the concept of being “in” a program and the limitations that this implies; that is, when they are interacting with an onscreen window that window is dedicated to and limited to the functions carried out by one program. In order for the user to change tasks or functions, it is often necessary for them to get “out” of one program and into another one, generally by starting a new program or activating an otherwise inactive onscreen window that is dedicated to the second program. This requirement is due to the fact that each program embeds objects in its own designated window(s), and these embedded objects are typically not transferable between windows of different programs.

In fact, transferring data or files or images from one program to another (moving from one window to another on the computer display) is often difficult or impossible without at least altering their form or data type. The acceptance of this enormous limitation on computer users is surprising, given that all the transferred data actually resides within the same machine, but cannot be utilized because most programs from different manufacturers cannot successfully interact with programs from other manufacturers and sometimes not even with programs from the same manufacturer. Consider, for example, that a graphic picture from one program must be “exported” as some other type of file in order for the file to be “read” by another program. A specific program format file (a saved picture, graphic or layout) as created in one program may not be readable by another graphics program, let alone by any non-graphics program. If such a program file is readable by another program, it is usually because the other program includes specially written code to provide for this. Graphics may be saved or exported in many formats, such as (but not limited to) the following:

| Program | File type |
|---|---|
| Adobe illustrator | .AI |
| Word Metafile | .WMF |
| Windows bitmap | .bmp |
| Corel Paint | .cpt |
| WordPerfect | .wpd |

The proliferation of file types raises a number of challenges for users and their computer systems: Which file type is readable by which program? Which file export option is most likely to be readable by the greatest number of other graphic programs? To effectively and efficiently utilize software programs a user is required to have learned an extensive body of information relating to file format compatibility. The user must apply this knowledge in “program management” whenever the user needs to transfer data or files between programs.

Some windows generated by prior art software are dedicated to operating system housekeeping chores and can do nothing else. For example, a window that lists available files under an operating system is generally not capable of enabling the user to do other than select a file, add, delete, copy or search for a file. There is no possibility of entering text within the file display window, such as a text note that describes a file, nor to input a graphic to represent the file, or to input a video in such a window or link a one file to another file. To make a text note, the user will find it necessary to go to a word processing program to provide a cursor to type text, thereby shifting the computer from the file display window (typically an operating system window, like a recall, save or save as window) to a word processing window, which does not support the typing of text into the file display windows just mentioned. Likewise, it is necessary for the user to access a graphic program to draw or import a graphic object, which typically may not be transferable into the file display window. This illustrates the confined, single-minded, single-use nature of windows as they are known in the prior art.

Thus, although the windows environment promises “drag-and-drop” compatibility between program windows that are open on the desktop display, there is rarely a seamless interaction between the programs.

Windows are often programmatically isolated from one another. Typically, a variety of “pull-down” menus are also displayed by a program window and subcommand items corresponding to the command options may branch off from main menus. However, each separate program from each program manufacturer generates its own dedicated window or windows with their own unique arrangement of pull-down menus. It is therefore necessary for the user to know and remember where in the menu selections the particular command or choice that is needed is located. These menu choices and their placement obey no standards or logic beyond those of the manufacturer. Indeed, in some programs the menu offerings change depending on the task or item that has been selected. This makes the task of remembering placement of items in a menu even more difficult. How does one find the Fax Out command in the word processing program, compared to locating the Fax Out command in a page layout program? Even when a user locates a likely menu choice there may be some question as to whether the choice will yield the desired function or whether it will lead to an undesired action including the possible loss of data or work input. Furthermore, when these manufacturers update their software the names of and the very placement of commands in pull down menus that have finally been learned by a user often change making it necessary for a user to relearn how to utilize many aspects of the software all over again.

As software becomes more complex the number of possible actions and commands within each program rapidly multiplies. Menus become larger and longer, dialog boxes proliferate, and the number of required floating palettes (menus that can be pulled down and dragged onto the desktop as a stable display) grows larger. Thus, one of the most important tasks of the software creator is to manage the growing complexity of a program's user interface. The developer's objective is to make all of a program's capabilities easily accessible and understandable while keeping as much as possible of the document itself fully accessible and visible. This requires the minimization of the screen “real estate” or space used for the user interface elements discussed above, particularly those that remain on the screen for long periods of time. This minimization approach is based on the underlying concept that all controls and commands must be made available through selections shown onscreen through continuously available pull-down menus and floating palettes.

The “windows environment” that is the graphical user interface with a window for each program or document is considered by software publishers to be the most advanced format for interaction between a computer and its user. However, many individuals are fearful of computers and feel that they must undergo a great deal of training and learning in order to be able to understand the windows environment and use a computer effectively. A significant segment of the public has reacted to their perception of the difficulty of learning to use computers by choosing to avoid them as much as possible. This has resulted in a more limited penetration of computers into the market of potential users and has resulted in many users utilizing only a small fraction of their computer's capabilities. In other words, the most modern computer interface is still seen by a large portion of the public as unfriendly and unwieldy and is a limiting factor in the adoption and diffusions of computers into the marketplace.

Computer users have also discovered that many programs designed to operate in a windows-type environment are not necessarily compatible with each other. That is, running two incompatible programs at the same time, each of which may be properly designed to run on the same operating system, will sometimes cause the operating system to crash. Other times, such programs will have incompatible needs and impacts on the continuum of operations from printing to communications. Such incompatibilities are idiosyncratic and unpredictable and may be caused by variety of factors including from the machine's microprocessor type, the amount of RAM available, the particular command selected for each program, as well as the peripheral devices setup and other factors about which the user may not be aware. Recovery from such system “crashes” may be far more complicated and arduous than merely restarting or rebooting the computer; data and work input may be permanently lost. Fear of these occurrences is common among computer users. Three factors in particular have caused the problem of system collapse to become both endemic and epidemic. The availability of large amounts of RAM, for example, now enables a computer user to open and run many divergent programs at the same time. Also, the proliferation of programs written for the windows environment greatly multiplies the chances of potential incompatibilities; any given combination of programs running on a computer can cause a crash. Finally, incompatibility problems are further exacerbated by the fact that programs often have proprietary file structures that are incompatible with other programs that, in many cases, cannot even be read by other programs.

The proliferation of software that is increasingly complex for users and prone to unpredictable incompatibilities that induce system crashes gives rise to a need for a user-friendly environment for computers that addresses the above-described concerns.

### SUMMARY OF THE INVENTION

A graphic user interface (GUI) and method for providing a computer operating environment utilizes a set of universal tools so that an intuitive computer environment. A tool in this universal tool set is a display-and-control graphic element that manages other graphic elements, including other display-and-control graphic elements. The display-and-control graphic elements can be used to create other graphic elements, which are displayed on the display-and-control graphic elements. However, these created graphic elements exist on a global drawing surface. Thus, the graphic elements can interact with any other graphic element, including graphic elements on the global drawing surface, on other display-and-control graphic elements and/or on the same display-and-control graphic element. Another tool in the universal tool set is an information display-and-control graphic element. These graphic elements can be used to modify the appearance or a functionality of an associated graphic element, as well as other operations.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts Blackspace with one VDACC situated on it.

FIG. 2 depicts Blackspace with two VDACCs situated on it with an arrow drawn between objects in two VDACCs and between an object in one VDACC and an object in Blackspace.

FIG. 3a depicts an object that is larger than the visible area of a VDACC being clipped into that VDACC.

FIG. 3b depicts an object that is smaller than the visible area of a VDACC being clipped into that VDACC.

FIG. 4 creating a VDACC by using the VRT tool.

FIG. 5 depicts moving a VDACC by left-clicking on it and dragging.

FIG. 6 depicts resizing a VDACC in the portal mode.

FIG. 7 depicts rescaling a VDACC.

FIG. 8 depicts clipping a picture into a VDACC.

FIG. 9 depicts dragging a picture out of a VDACC.

FIG. 10a is a description of the VDACC scrollers.

FIG. 10b depicts a VDACC with no scrollers.

FIG. 11 depicts the placement of numerous scroller markers along the right and bottom edge of a VDACC.

FIG. 12 depicts the use of a VDACC scroller marker Info Canvas.

FIG. 13 depicts moving an item in a VDACC where it becomes the top layer and moves over any other object in that VDACC.

FIG. 14 depicts a layer fader.

FIG. 15 illustrates the action of lassoing the top and bottom vertical scroller markers on a VDACC and by this action selecting every item in the VDACC.

FIG. 16 illustrates the action of lassoing a hand placed marker and the bottom marker of a VDACC to select part of the objects in the VDACC.

FIG. 17 shows the method of activating Allow Ripple in one object's Info Canvas and therefore activating this function for every item in a VDACC.

FIG. 18 depicts the function “Wrap to Edge” in a VDACC.

FIG. 19 illustrates the agglomeration of objects to a VDACC.

FIG. 20 show a photo clipped into a VDACC where the photo fills the entire visible area of the VDACC. The entry “Lock to VDACC” is selected in the Info Canvas for the photo to enable a user to drag both the photo and VDACC as a unit.

FIG. 21 shows multiple VDACCs nested inside one another with numerous objects in the various VDACCs.

FIG. 22 depicts the elements of an Info Canvas.

FIG. 23 depicts the three elements of an IVDACC invisible identifier.

FIG. 24 depicts a secondary Info Canvas.

FIG. 25 depicts the various types of IVDACCs in an Info Canvas.

FIG. 26 illustrates the replacing of an IVDACC text label with different text.

FIG. 27 illustrates the resizing of an individual IVDACC in an Info Canvas.

FIG. 28 illustrates the replacing of an IVDACC text label with a hand drawn graphic.

FIG. 29 depicts various graphic and text elements agglomerated to an IVDACC in an Info Canvas.

FIG. 30 depicts the use of an inkwell to change the color of a VDACC perimeter line and the color of a VDACC background, referred to figuratively as VDACC Blackspace.

FIG. 31 depicts removing an IVDACC from an Info Canvas and duplicating an IVDACC and removing it from an Info Canvas.

FIG. 32 depicts changing the order of an IVDACC in an Info Canvas.

FIG. 33 shows a flow diagram for placing an object in a VDACC.

FIG. 34 shows a flow diagram of the general mouse release process.

FIG. 35 shows a flow diagram for performing a VDACC collision routine for incoming object.

FIG. 36 shows a flow diagram for adding an object to a VDACC.

FIG. 37 shows a flow diagram for moving and removing an object from a VDACC.

FIG. 38a shows a flow diagram of a procedure when an object collides with an Info Canvas.

FIG. 38b shows a flow diagram of a procedure when an object collides with an IVDACC.

FIG. 39, a flow diagram of a procedure in an Info Canvas to insert a new item.

FIG. 40 shows a flow diagram for recalculating the geometry of an Info Canvas.

FIG. 41 shows a flow diagram of IVDACC procedure for receiving a passed on mouse press event.

FIG. 42 shows a flow diagram of IVDACC procedure for receiving a passed on mouse release event.

FIG. 43 shows a flow diagram for setting the status of an IVDACC (behavior in an Info Canvas).

FIG. 44 shows a flow diagram for setting the status of an IVDACC (behavior in an entry IVDACC).

FIG. 45 shows a flow diagram for a glue procedure.

FIG. 46 shows a flow diagram for a “set new title” procedure of an Info Canvas/IVDACC.

FIG. 47a-47c illustrates the use of a hide switch to crop a picture.

FIG. 48 shows a flow diagram of action when clicking on an arrowhead.

FIG. 49 shows a flow diagram for clicking on a switch in an arrow logic.

FIG. 50 shows a flow diagram for a control switch pressed routine for a VDACC.

FIG. 51 shows a flow diagram for saving a picture.

FIG. 52 illustrates an entry “Draw VDACC” for creating VDACCs.

### DETAILED DESCRIPTION

A graphic user interface (GUI) in accordance with an embodiment of the invention provides an intuitive and user-friendly operating environment for a computer or any electronic device with a display. This operating environment will be referred to herein as the Blackspace environment. The term “Blackspace” is a trademark of NBOR Corporation, as well as the terms “VDACC” and “Info Canvas”, which are also used herein. The GUI requires a set of elements that rely upon a set of “universal tools” for their operation. This set of elements comprises Blackspace. The set of universal tools is employed by the user to accomplish any of the tasks that formerly required individual programs. These universal tools remain essentially the same (in terms of access, function and appearance) in any process or task, so that the user is always working with the same familiar implements. In contrast to conventional operating environments, the need for pull-down menus and task bars is eliminated, so the display screen can be devoid of predefined selections for command and control. Even floating palettes can be eliminated when desired. Commands and user directions need not be shown onscreen at all times. Rather, the user calls forth the needed functions by drawing or typing onscreen the switch(es) and/or symbol(s) and/or specifier(s) that are associated with the desired function or command or file. Furthermore, these switches and/or symbols may be user-defined.

The set of tools is provided by the software for the GUI but their presence and/or functions need not be continuously shown onscreen, as with the prior art pull-down menus. As the name implies, Blackspace refers to a computer display environment without any visible objects, colors, or fill. Blackspace, as utilized in this disclosure, does not refer to a black color. Rather, the name refers to a “tabula rasa” or “clean slate” operational approach that can be implemented by the user who can work as he/she wants, with any color background. The universal tools encompassed by Blackspace may be employed by the user by inputting and interacting with onscreen objects and drawn inputs in Blackspace to carry out whatever tasks he/she may desire. Note: for purposes of this disclosure the words “object” and “item” may be used interchangeably. Items include: recognized graphic objects (stars, squares, circles, arrows, etc.), free drawn objects (sketches, drawings, lines, etc.), pictures (.png, .jpeg, .bmp, .gif, etc., picture files), devices (switches, faders, knobs, joysticks, etc.), video (various video formats), text (text is a graphic object in Blackspace), and VDACCs (VDACCs are graphic objects and will be discussed in detail below).

Blackspace.

Blackspace presents one universal drawing surface that is shared by all graphic objects in the software. Blackspace is analogous to a giant drawing “canvas” on which all graphic items generated by the software exist and can be applied. Each of these objects can have a user-created relationship to any or all the other objects. There are no barriers between any of the objects that are created for or exist on this canvas.

Underlying the use of the set of universal tools are several concepts that are fundamental to the invention. These are: the context in which the tools are used and combined, assignment of functionality to onscreen objects or computer items, and the use of equivalents to represent tools or computer items. In turn, underlying these concepts are elements that enable the realization or actualization of these universal tool concepts. These elements are:
A. Object Recognition of hand drawn inputs.
B. Arrows and Arrow Logics
C. VRT Virtual Recall Tool—previously named Digital Recall Tool (DRT)
D. VDACCs.
E. Layering.
F. Info Canvases
G. Contexts
H. Specifiers and Known Text
   These concepts and elements are discussed in detail below.
   A. Object Recognition of Hand Drawn Inputs.

An essential tool of the universal tools is object recognition of hand drawn inputs. The software accepts hand drawn user inputs, determines if they are recognizable as any one of a large number of recognizable shapes and places a computer-drawn object in place of any recognized hand drawn input. This recognition of hand drawn objects is described in a co-pending application Ser. No. 09/785,049. This software also recognizes hand drawn alphanumeric character inputs, so that text and numbers may be inputted through the use of a mouse, stylus and touch screen, or other medium, and that the meaning and importance of the letters, numbers, and words may be understood by this software.

B. Arrows and Arrow Logics.

Arrows are the operational protocols that can be applied between any one or more objects within Blackspace to affect their actions and functions based on how a user chooses to utilize that particular arrow's function or action. Arrows can be drawn between VDACCs (Visual Design and Control Canvases), which are described below in section D. Note: VDACCs may resemble windows to some but are in reality not windows, but simply graphic objects. VDACCs permit arrows to act as graphical linkers between objects that exist on this global drawing surface, whether inside a VDACC or outside the VDACC. Therefore, arrows can be drawn from VDACCs to VDACCs, from objects to VDACCs, from VDACCs to objects, from Blackspace to VDACCs and from VDACCs to Blackspace. Because Blackspace is a unified drawing surface, an arrow is meaningful in all of these apparent environments because there is really only one environment.

The hand drawn input recognition software also enables the introduction of arrow logics, as described in pending U.S. patent application Ser. No. 09/880,397, entitled “Arrow Logic System for Creating and Operating Control Systems”, filed in Jun. 12, 2001, which is incorporated herein by reference. Briefly, arrow logics are lines or arrows drawn by the user onscreen to cause a transaction to occur between two or more onscreen objects. The software recognizes the objects at the tail and head of the drawn arrow and associates these objects in accordance with user-defined parameters, contexts, and actions. Arrow logics permit the user to set up graphic interactions with intuitive ease, and to perform sophisticated manipulations of objects, files, pictures, text, etc. to achieve at least the following:
a) Control of one or more objects from another object.
b) Copy/Replace or Copy/Replace/Delete from screen.
c) Place Inside (another object).
d) Assignment of one or more objects to another object.
e) Send the signal or contents to (another object or device).
f) Change to.
g) Auto Sequence.

Specialty Arrows which are determined by context, not necessarily by color, include the following actions:
a) Insert an action or function in the stem of an arrow.
b) Rotational direction for a knob.
c) Apply the control of a device to one or more objects, devices, pictures, drawings, video, text, etc.
d) Reorder or redirect a signal path among screen objects.
e) Create multiple copies of, and place these copies on the screen display.
f) Swap.

The software enables the user to impart functional meanings to graphic symbols and objects, and to selectively change the functional meanings or transmit them to other objects. Such functional meanings may result in enabling a single hand drawn graphic to represent and implement, upon the drawing of such object, a complex machine, a list of files or a photo.

The user may employ an arrow to circumscribe a number of pictures on the display and extend the arrow to a blue circle object. The arrowhead is automatically replaced with a machine drawn arrowhead, and upon the user tapping the machine drawn arrowhead, the circumscribed pictures are removed from the display and placed into the blue circle object. Thereafter, the user may at any time tap the blue circle the same pictures will emerge or “fly out” of the blue circle to their original position on the display. Likewise, at any time the user may recall these pictures onto the display by drawing and then tapping a blue circle.

Similarly, the GUI enables the user to connect or associate functional graphic objects on-screen to define and/or control an action, transaction, a machine that processes an input to produce a desired output, or to alter the function of one or more of the graphic objects. For example, a user may draw a fader onscreen, bring a sound file onto the display (as explained below regarding Specifiers), and draw an arrow from the fader to the sound file. The arrow logic for this context (detailed below) is that the fader becomes the volume control for audio play of the sound file. In contrast, if the arrow is drawn from the fader to a picture or a photo file, the arrow logic for this context determines that the fader becomes a brightness control for display of the picture or photo. In all these examples, the software converts the functional arrangement of the graphic objects on-screen to algorithms that carry out the machine functions using programmable digital signal processing devices, microprocessors or one or more computer processors.

C. VRT (Virtual Recall Tool).

This element is described in pending U.S. patent application Ser. No. 10/053,075 as a DRT (Digital Recall Tool). The pending U.S. patent application Ser. No. 10/053,075, entitled “Method for Controlling Electronic Devices Using Digital Recall Tool”, filed on Jan. 18, 2002, is incorporated herein by reference. The VRT has many functions. The default operational function for a VRT is the drawing of a VDACC, which is described in next section. When a user turns on the VRT (by clicking on the VRT switch or its equivalent), a diagonal can be drawn onscreen, such that the length and angle of the diagonal directly determines the height and width of the VDACC being drawn. Upon the mouse up-click after the diagonal line is drawn, the VDACC appears. The default background color for the newly created VDACC is black, although this background color can be changed to any color found in a color wheel, which can be 24 bit, 32 bit etc. This provides millions of different background and perimeter line colors for the VDACC.

D. VDACC.

Note: Layering (Outline item E above) will be discussed under this section. Another primary Blackspace tool is the Virtual Display and Control Canvas (VDACC). A VDACC is a defined onscreen workspace manager that does not have any simple counterpart in prior art computer terminology, such as a window, desktop, dialog box, or the like.

D-1. VDACCs are not separate windows. VDACCs are graphic objects that are part of the software's global drawing surface called Blackspace. As objects in Blackspace a VDACC can interact with other objects in Blackspace that are not VDACCs. VDACs are organizational tools for working in Blackspace.

D-2. VDACC is a graphic object manager. The VDACC allows all of the objects within its perimeter to be grouped together (agglomerated within it). However, all these objects always exist on the global drawing surface, Blackspace. The VDACC itself is a graphic object. But in addition to its own graphical elements, such as a background which can be opaque to transparent, a close and maximize switch and a resize switch, it also owns a data object called a graphic linker. This linker is a list of graphic objects that are managed by the VDACC. Operations such as moving and resizing generally operate first on the VDACC itself and then on the list of objects held in the graphic linker.

D-3. All the functionality of Blackspace is available in every VDACC. VDACCs have no individual programmed uniqueness that separates one VDACC from another. All VDACCs have exactly the same operability and capability. What makes each VDACC different is what the user puts into them and the arrows that are drawn to create functions and actions between one or more objects in one or more VDACCs and in Blackspace itself. In fact, there is only Blackspace as an operational environment; Blackspace is the only drawing surface.

D-4. VDACCs are not separate operational environments. VDACCs are not programming boundaries to the software with regards to how it utilizes its global drawing surface, Blackspace. VDACCs are organizational structures that group graphical items together according to a user's discretion. VDACCs do not have their own independent drawing surfaces; they only manage collections of objects that exist in Blackspace. This management role has two overall aspects:
(1) The physical location and alteration or manipulation of the appearance of the graphical objects in Blackspace.
(2) The linking of actions, functions and operations from one or more objects to one or more other objects in Blackspace.

In the case of aspect 2, the linking is always in Blackspace, on the global drawing surface, as VDACCs do not act as barriers to this drawing surface; VDACCs act as organizational tools for Blackspace. The VDACCs appear to users as separate entities, which may be akin to windows, but (as noted above) they are not windows in any regard.

When a VDACC has been created in Blackspace, what has been created is an object that is a manager for other graphical objects, which can be moved scrolled and clipped by the rectangular outline of the VDACC. However, the objects are still being drawn on a global drawing surface. So these objects have the ability to interact with other objects in Blackspace and/or in other VDACCs. This is directly the opposite of the Windows environment in which you have individual windows that represent unique and completely self-contained environments that are designed by a programmer. So the behavior of conventional windows is controlled by computer programs written by programmers not the user.

When a user drags an object so that the tip of the mouse cursor being used to drag that object is within the perimeter of a VDACC, that object “clips” into the VDACC. The term “clip” with respect to VDACCs is described in more detail blow in sub-section D-12. The VDACC's data structures then know about that item and manage this item. This item can be moved and scrolled along with all the other items being managed by the VDACC, but the VDACC is managing them on one global drawing surface, Blackspace. All graphic items, such as drawings, recognized objects, pictures, text, videos or music that are placed on a VDACC remain part of the Blackspace global drawing surface.

The VDACC uses Blackspace by manipulating the items on it that are clipped to the VDACC. When a VDACC containing objects that have been clipped into it is moved, all these clipped objects' data structures are moved with the VDACC. This is accomplished by the VDACC telling its objects where to go to, by adding X and Y coordinate offsets to all of the objects that are within its data structure, even if the objects are not within its perimeter.

Items can be dragged to a VDACC that are much larger than the visible surface area of the VDACC. But if the tip of the mouse cursor is within the perimeter of the VDACC when a mouse up-click is performed, the dragged item will be clipped into the VDACC and the VDACC's internal area will be automatically enlarged to accommodate the larger item, even though its full size will not be visible by looking at the available surface area of the VDACC. However, after being clipped into a VDACC these larger items produce one or more “scrollers” to appear along one or more edges of the VDACC. These clipped items can then be scrolled so they can be viewed through the available surface area of the VDACC. It should be noted that when the visible surface area of a VDACC is smaller than its full working area, the VDACC can be scrolled to view items clipped to the VDACC that are outside the visible perimeter of a VDACC as needed, since clipped items are not visible unless they are within the visible perimeter of the VDACC.

D-5. VDACC provides a clipping mechanism for drawing and for placing graphics within it. A VDACC will not allow the items that it contains to be visible except those parts of these items that are within the borders of the VDACC. One may argue that this is the same process that governs the operation of a window, but there is a key difference here. The objects being scrolled in a VDACC are not separated from the rest of the objects onscreen. The objects are merely being managed by the VDACC as they exist on the Blackspace global drawing surface. Since they exist on a global drawing surface, they can directly interact with any other object on that drawing surface whether that object is in another VDACC or sitting directly on the global drawing surface. So a VDACC does not present any type of impediment to the immediate and direct interaction of any object with another object in Blackspace.

D-6. VDACCs represent and act as individual environments where their behaviors are not controlled by a programmer. Users control what is managed by a VDACC by what the users put into the VDACC and where they put it. Whatever is put into a VDACC, no matter how complicated it may be (for example, 100 pages of documentation), those materials remain a part of the Blackspace global drawing surface. VDACCs are portals onto this global drawing surface and manage groups of objects without limiting their functionality.

In a comparison, users cannot create their own window in a Windows environment. Only programmers can do this. In Blackspace, however, users can create their own VDACCs simply by drawing them, as many as the user desire.

What happens when a user draws a VDACC? How does the VDACC know it controls a part of Blackspace and that this “part” is not unique to that VDACC? Also how does a VDACC share this “part” of Blackspace with the many other VDACCs that may be on the same Blackspace global drawing surface?

A VDACC is a container for graphical objects. Objects that are dragged to the VDACC where the tip of the mouse cursor is within the perimeter of the VDACC when an up-click is performed become managed by that particular VDACC. The VDACC controls the position of objects within it, but the user determines what those objects are.

If you have a window, the programmer for that window's application decide what is in it and what you can do with it and what the rules are for operating it. In Blackspace, the user decides what is in or on a VDACC. Arrows control the operations or rules for engaging with the objects on the Blackspace global drawing surface, even objects that appear in separate VDACCs.

A VDACC is created in Blackspace or within another VDACC by a user to manage onscreen objects that may be drawn or otherwise created, contained and recalled. The onscreen objects may be combined in functional relationships, assigned to other onscreen objects, operated, revised, edited, added to, or otherwise used to carry out the intent of the user. Any number of VDACCs may be created and presented onscreen. Any onscreen object may be contained within a VDACC, moved between VDACCs, or assigned, linked and or controlled by or in control of any other object within any other VDACC.

D-7. A VDACC is a graphic object. A VDACC is itself an onscreen object. A VDACC appears onscreen with a definable (i.e., rectangular) perimeter defined by a continuous line. In fact, any closed perimeter defining an interior space may be used as a VDACC, whether a circle, octagon or any other polygon. The interior of a VDACC is Blackspace although it may be set to any user-defined color. As such, the operations of a VDACC are controlled and defined by the software, which controls the computer, provides all interface interactions with the user, generates all the VDACCs, and carries out all the various computer functions that in the prior art were divided among a large multitude of separate programs running under an operating system.

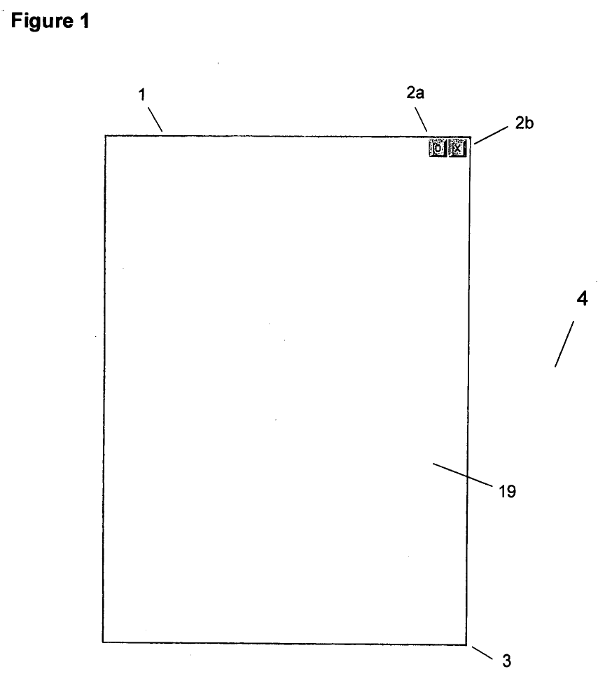

In FIG. 1, a VDACC 1 situated on a global drawing surface 4, referred to as Primary Blackspace or simply Blackspace, is shown. The VDACC 1 includes a drawing area 19, which is referred to as the VDACC Blackspace or the working area of the VDACC. The VDACC 1 is defined by a perimeter line, shown in FIG. 1 as a black rectangular outline. The color of this outline and the color of the VDACC Blackspace 19 can be independently changed. To so, a user would select a color from an inkwell and use a fill command to change the color of the VDACC's perimeter line or the color of its VDACC Blackspace 19. Using a fill color from an inkwell is common in the art and there are many ways to accomplish this.

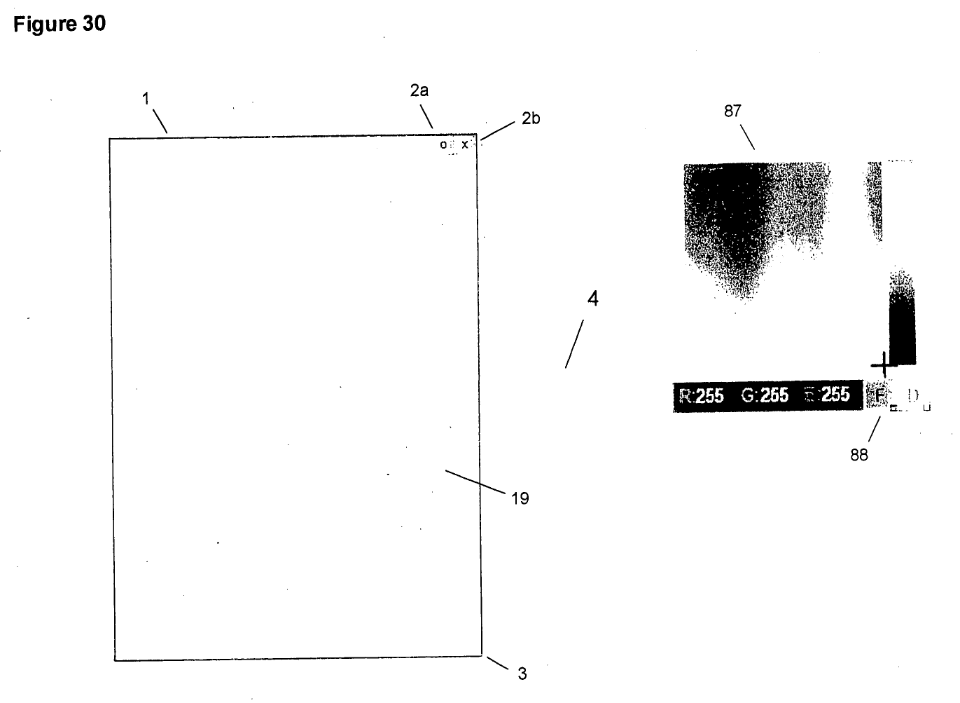

One such way is illustrated in FIG. 30. In FIG. 30, an inkwell 67 is shown. The inkwell 67 is a 24-bit inkwell, offering approximately 16 million colors. The inkwell 67 includes an “F” switch 88, which sets the inkwell into Fill mode. Once the “F” switch is turned on, the mouse cursor is left-clicked anywhere inside the perimeter of the VDACC 1. This changes the color of the VDACC Blackspace 19 to the currently selected color in the Free Draw Inkwell. In the illustrated case, it is the color white.

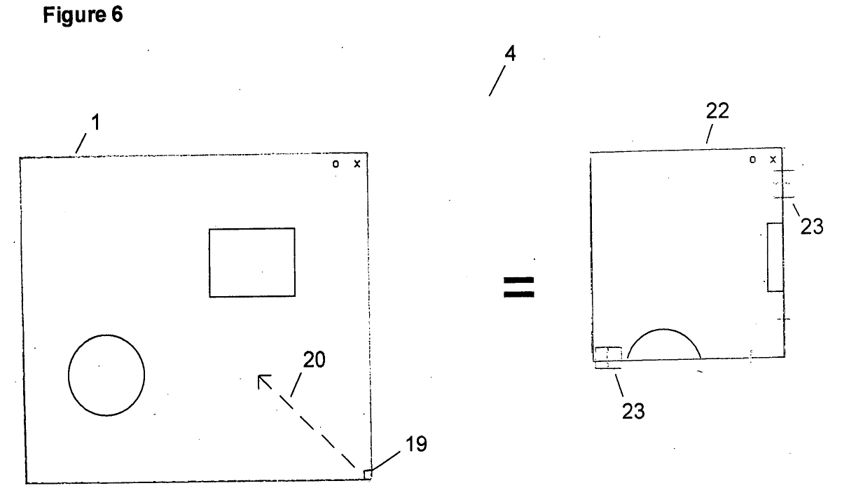

Like all VDACCs, the VDACC 1 is a graphic object that is a manager for other graphic objects that exist within its borders. All of the objects managed by a VDACC 1 are managed on the single drawing surface—Blackspace. The terms Primary Blackspace and VDACC Blackspace are not used herein to indicate separate drawing surfaces, but rather to indicate sections of this same drawing surface. Objects placed in a VDACC or directly in Primary Blackspace have the same ability to interact with each other, because they are all on the same drawing surface. As shown in FIGS. 1 and 30, in the upper right corner of the VDACC 1, there are two switches: (1) a maximize switch 2a, which automatically causes the VDACC to zoom to fill the entire screen (full screen view)+ and (2) a close switch 2b which causes the VDACC to permanently disappear. Note: if the VDACC 1 is assigned to another object, then left-clicking on close switch 2b will only temporarily cause the VDACC to disappear and then left-clicking on the object to which the VDACC is assigned will cause the VDACC 1 to reappear. In the lower right corner of the VDACC 1 is a resize button 19, which is used to resize the VDACC in what is referred to as the portal mode. This is described below with reference to FIG. 6.

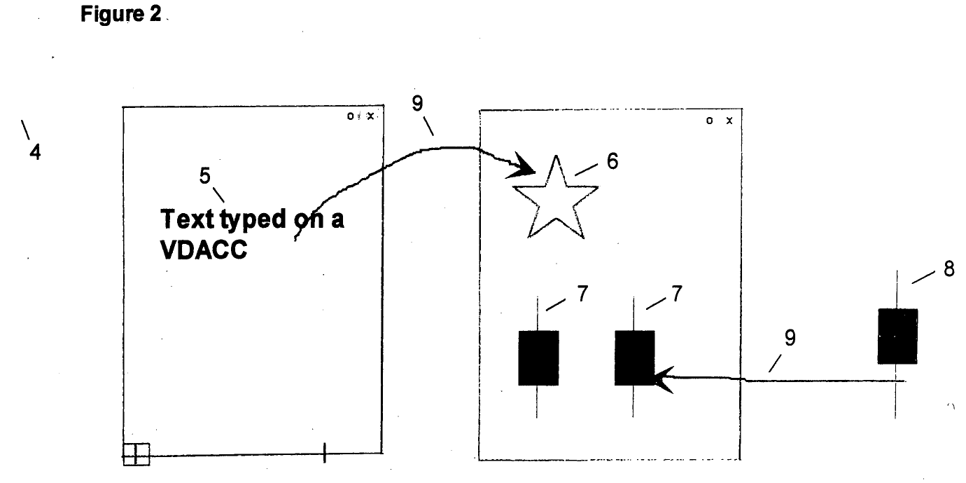

D-8. Multiple VDACCs onscreen. Many VDACCs may be displayed onscreen at any time, as illustrated in FIG. 2, and all of them will be active. All VDACCs are created by the same software, and all are fully and mutually compatible. A VDACC never needs to be closed in order to perform a specific function or action. Since VDACCs manage the same global Blackspace, any number of VDACCs can remain open without preventing any supported operation from taking place in Blackspace.

FIG. 2 shows a left VDACC in which a text object 5 has been written. An “assign to” arrow 9 has been used to assign the text in the left VDACC to a dark red star 6 in the right VDACC. Upon the mouse up-click, the left VDACC containing the text 5 will disappear. Then the dark red star 6 will become filled. Left-clicking on the red star 6 will cause the left VDACC containing the text 5 to reappear. Clicking on the red star 6 again will cause the text 5 to disappear and so on. Both the text 5 and red star 6 are being operated on the same global drawing surface 4, Blackspace. In a similar manner, a fader 8 (sitting in Primary Blackspace 4) has another arrow 9 drawn from it pointing to a fader 7 sitting in the right VDACC. In making this link, the fader 8 is assigned control over the fader 7. Even though one of these faders 7 and 8 is in a VDACC, i.e., the left VDACC, and the other one is not, both faders are being operated on the same drawing surface 4, Blackspace.

D-9. Familiar operations. A VDACC typically is provided with a close button and maximize button in its upper right corner. If a VDACC has been assigned to something else, then touching the close button causes the VDACC to temporarily disappear, and to reappear whenever the object to which it has been assigned is touched or clicked. If a VDACC is unassigned, however, touching the close button will cause the VDACC to be deleted.

The maximize button has a particular value for a VDACC that contains a number of items whose perimeters extend beyond the visible perimeter of the VDACC. By activating the maximize button on the VDACC, the surface of the VDACC expands to fill the screen so the user can immediately see all of the contents of that VDACC. Thus, some of the clipped objects in the VDACC that would otherwise have remained hidden will become visible due to the expansion of the VDACC.

D-10. Moving a VDACC. A VDACC does not have a grab bar or marquee with which it can be moved. Rather, clicking or touching any place within the VDACC that is not occupied by some item clipped into the VDACC and dragging will cause the VDACC to move in the dragging direction.

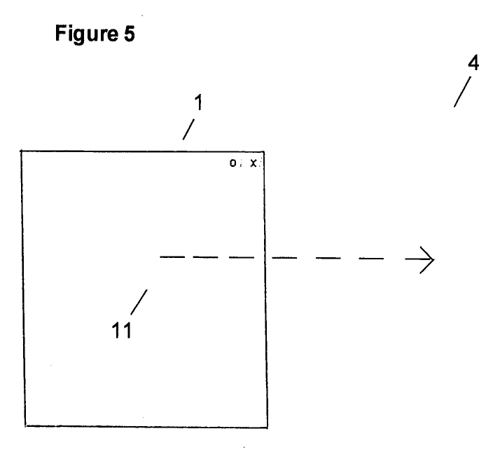

FIG. 5 illustrates a VDACC 1 being moved by left-clicking anywhere within it's perimeter and dragging along path 11. A VDACC can be moved to any position in Blackspace through this method.

D-11. Two types of VDACC resize: A VDACC may be any size when it is created and can be resized by the user at any time thereafter. The resize function for a VDACC may be in portal mode, in which the VDACC perimeter is re-dimensioned while the objects within the VDACC remain unchanged (a scroll function is added automatically to access unseen objects). Alternatively, the resize function may be set to be carried out in proportional mode (rescale), in which the depiction of all the objects within the VDACC are resized in proportion to the change in the VDACC size, and all the visible objects in the VDACC remain visible but resized.

D-12. Clipping. A very important aspect of a VDACC is called “clipping.” All objects that become part of a VDACC's management system are “clipped” to that VDACC. Clipping occurs when an object is dragged to a VDACC such that the tip of the mouse cursor dragging the object is within the perimeter of the VDACC when a mouse up-click is performed.

An additional aspect of clipping is the fact that a VDACC's usable surface area automatically increases if an object is clipped into it where the object's perimeter exceeds the visible perimeter of the VDACC. In other words, if something bigger than the size of a VDACC is placed into that VDACC, the VDACC's working surface expands automatically.

The larger object is then made accessible therein by scrollers appearing automatically along one or more edges of the VDACC. Thus the internal working surface of a VDACC may be far larger than the visible perimeter. Furthermore, if this larger object that is clipped into the VDACC is removed from the VDACC, then the VDACC is automatically resized to equal the size of the next largest item still clipped into it.

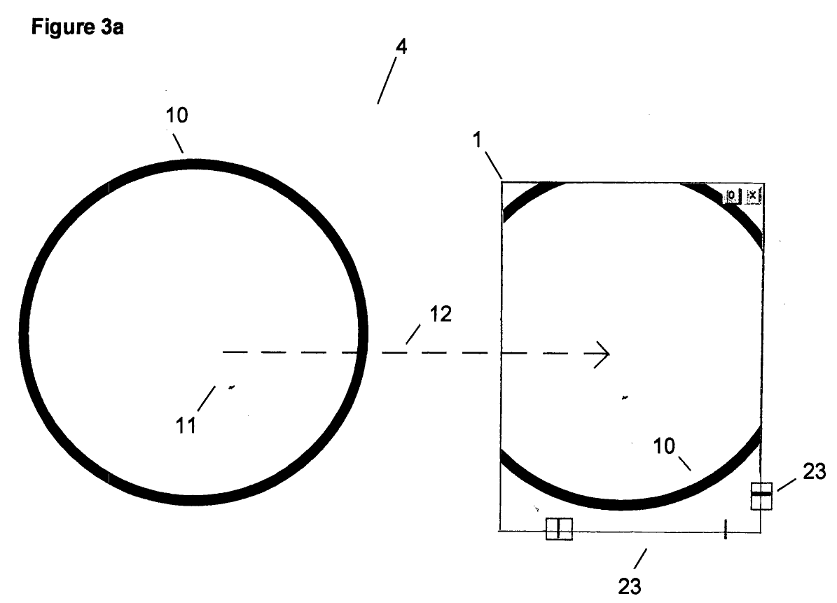

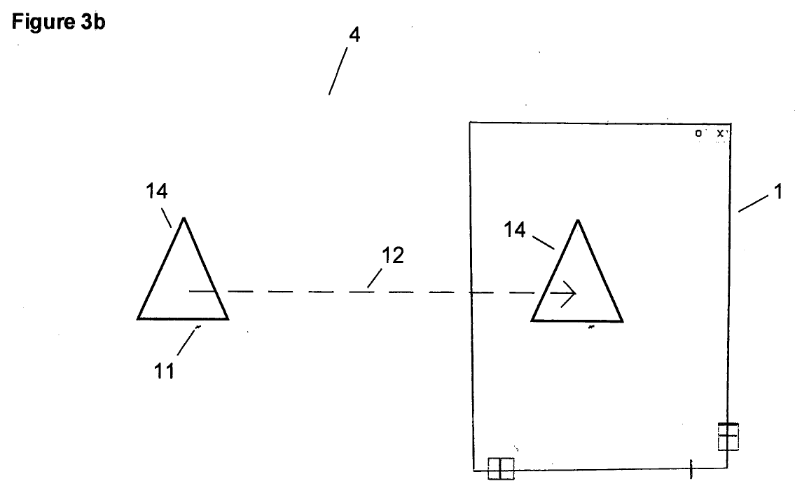

FIG. 3a depicts an object 10 that is larger than the visible area of a VDACC 1. This object 10 has been clipped into the VDACC 1. The area encompassed by the object 10 in the VDACC 1 is enlarged. The perimeter of the VDACC 1, however, does not enlarge, thus a user can only see a portion of the object 10 that is clipped into it. The clipping of the object 10 into the VDACC 1 is achieved by the mouse cursor 11 being left-clicked on the object 10 and then dragging the object (along the dotted line 12) to the adjacent VDACC 1 in such a manner that the tip of the mouse cursor that is dragging the object is within the perimeter of the VDACC when a mouse up-click is carried out. At the completion of this step, the object 10 is clipped into the VDACC 1 and every part of the object that extends outside the VDACC's perimeter is hidden from view, while still being accessible on the global drawing surface 4. The VDACC 1 is a portal for viewing the object 10. When the object 10 is clipped into VDACC 1, two scroller caps 23 appear, one along the right edge and the other along the bottom edge of the VDACC 1. These scrollers 23 are used to view the entire object 10, as described below.

FIG. 3b depicts a triangular object 14 that is smaller than the visible area of a VDACC 1 being left-clicked on and dragged along the dotted line 12 until the tip of the mouse cursor is over the VDACC 1. Upon the mouse up-click, the object 14 is clipped into the VDACC 1. The object 14 remains visible and accessible, and can be moved by the mouse cursor 11 within the VDACC 1, or if pulled out beyond the perimeter of the VDACC 1, it will no longer be clipped to the VDACC 1 and will once again be situated in the Primary Blackspace 4.

Clipping is defined as this ability to place an item into a VDACC, where the perimeter of that item extends in one or more directions beyond the visible perimeter of a VDACC. For instance, if a VDACC is 1½ inches high and 2 inches wide and you drag a picture that is 8 inches square over the top of the VDACC, the picture will clip into the VDACC.

One example of this is that an item is dragged into a VDACC, where the tip of the mouse cursor or pen, used to drag this item, is inside the perimeter area of the VDACC. Then, upon the mouse up-click, the item will “clip” into the VDACC. When this happens the position of the item over the VDACC is preserved (the item appears in the VDACC in the same location to which you dragged it). Furthermore, upon the mouse up-click, the perimeter of the VDACC, which has been temporarily hidden by the picture which has been dragged on top of it, comes to the top layer. Then every part of the picture that extends outside the VDACC's perimeter is hidden from view. At this point, only the portion of the picture that is inside the perimeter of the VDACC can be viewed, as though one is looking through the VDACC as a portal to view just a portion of the picture.

Another aspect of clipping is that once an item has been clipped into a VDACC, the item can be clicked on and dragged to reposition which portion of that item can be viewed “through” the VDACC's visible surface area. As long as the tip of the mouse cursor or pen does not move outside the perimeter of the VDACC, the picture can be repositioned anywhere “inside” the VDACC.

If, however, a user clicks on the picture and drags such that the tip of the mouse cursor goes outside the perimeter of the VDACC, the picture will “pop out” of the VDACC and become visible in its entirety. At this point, the picture will no longer be part of the VDACC. Furthermore, it will become the top layer and will obscure any part of the VDACC that lies directly under it.

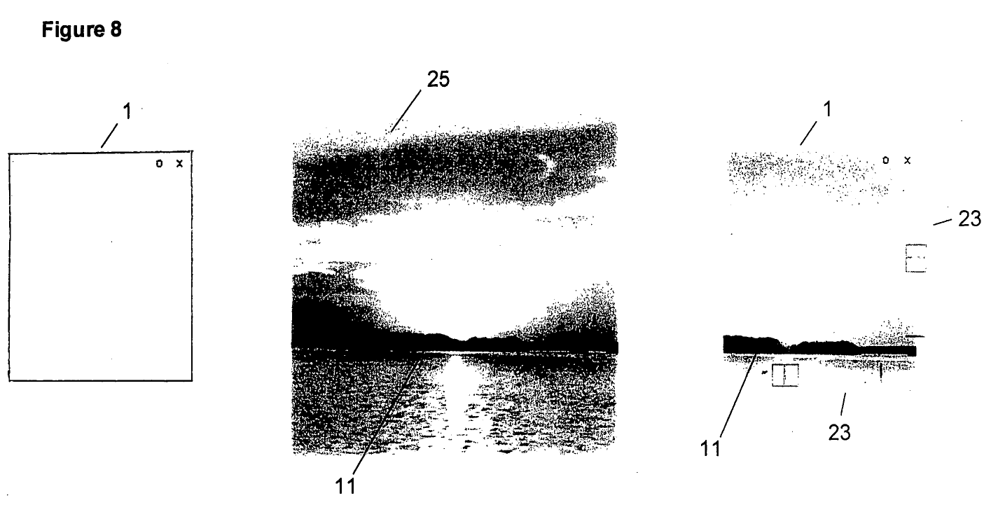

FIG. 8 depicts a VDACC 1 with no object in it. Then, a picture 25 is left-clicked on with the mouse cursor 11 and dragged so that the picture 25 overlaps the perimeter of the VDACC 1. Upon the mouse up-click, the picture 25 is clipped into the VDACC 1. This VDACC 1 will then show the portion of the picture that does not exceed the perimeter of the VDACC's current size. The picture 25 can be viewed in its entirety through using either the horizontal or vertical scroller caps 23 (described in the next section), which appear when the picture is clipped into the VDACC 1.

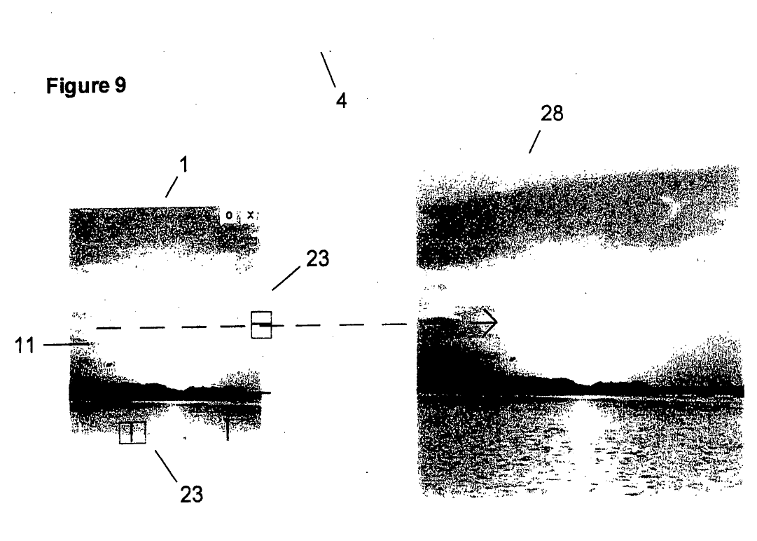

FIG. 9 illustrates a VDACC 1 containing a clipped picture 25. On being left-clicked with the mouse cursor and dragged to the right such that the tip of the mouse cursor extends beyond the perimeter of the VDACC 1, the picture 25 pops out of (emerges from) the VDACC 1 into Blackspace 4 and is no longer clipped to the VDACC 1. It should be noted here that if the picture 25 is left-clicked on (or its equivalent) and moved such that the tip of the mouse cursor does not extend outside the perimeter of the VDACC 1, the picture 25 will be repositioned in the VDACC and remain clipped to it.

D-13. VDACC Scrollers. A VDACC is automatically provided with scrollers whenever the actual size of its drawing surface exceeds its visible perimeter in height or width. Whenever the size of the internal working surface of a VDACC exceeds the size of the VDACC's perimeter in the X or Y directions, a fader-type sliding “cap” appears at the respective Y or X perimeter of the VDACC, so that the user may drag the cap along the perimeter to scroll the internal working surface past the VDACC perimeter. Any size VDACC can have scrollers. Thus, scrollers are not dependent upon the size of the perimeter of a VDACC. One modification to VDACC scrollers can be that when a VDACC is reduced to a certain size, e.g., less than 2 inches square, the size of its scroller caps will automatically be decreased in size so they take up less space. A VDACC scroller has several properties. They are described below.

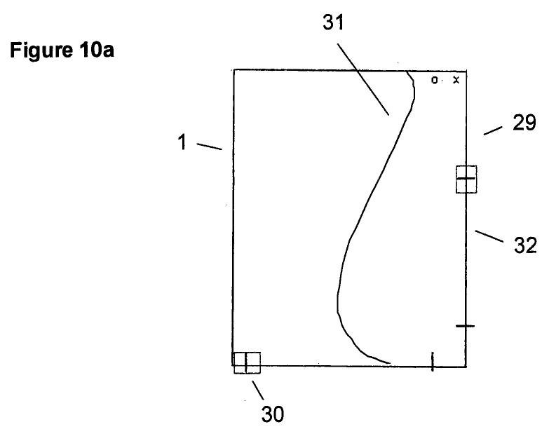

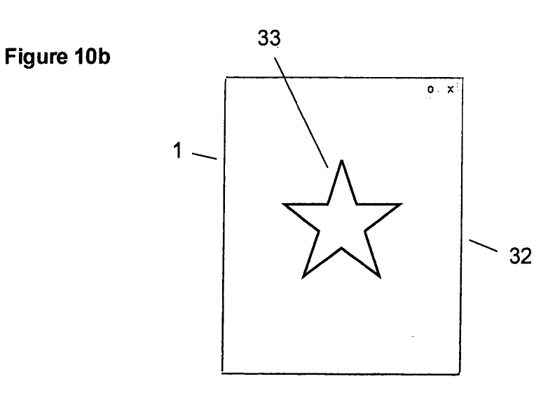

FIG. 10a depicts a VDACC 1 that contains an object 31 that is larger than the perimeter of the VDACC. All VDACCs are automatically provided with scrollers whenever the actual size of their drawing surface exceeds its visible perimeter in height or width. Because the size of the internal working surface of this VDACC 1 exceeds the size of the its perimeter in the X or Y direction, a fader-type sliding “cap” automatically appears at the respective Y or X perimeter of the VDACC 1. This permits the user to drag the cap along the perimeter to scroll the internal working surface past the VDACC's perimeter. Accordingly, in FIG. 10a, a vertical scroller cap 29 appears on the right edge 32 of VDACC 1. This cap 29 can be moved vertically to display the hidden portions of the object 31 within VDACC 1. A horizontal scroller cap 30 appears on the bottom of VDACC 1 that can be moved laterally to display the hidden portions of the object 31 within VDACC 1.

FIG. 10b depicts a VDACC 1 containing a recognized star object 33. No scrollers appear along the perimeter 32 of VDACC 1 because the star object 33 within does not exceed the VDACC's external dimensions.

D-13-A. A visually transparent but touch sensitive cap. A VDACC scroller cap is visually transparent. It is visually a wire frame that consists of a perimeter line and may or may not have a horizontal or vertical centerline. All of the surface area of a VDACC scroller cap can be transparent. However, the entire surface area of a VDACC scroller cap is touch sensitive to allow a user to readily move the cap. A benefit of this is that the cap will not obscure items that are under it when it is being moved over objects clipped into a VDACC to perform scrolling.

D-13-B. The VDACC scroller can ride along a 1 pixel wide line. The VDACC scroller cap can move up and down or left to right along an edge of a VDACC. This edge can be as thin as one pixel. The benefit of this is that it greatly reduces the amount of space required for a scroller.

D-13-C. Scrollers only appear when needed. If no item exists on the surface of a VDACC where the perimeter of the item exceeds the perimeter of the VDACC, no scrollers will appear for that VDACC. Furthermore, if an item exists on a VDACC where its perimeter exceeds the perimeter of the VDACC only in one direction, i.e., horizontally or vertically, then only a horizontal or vertical scroller will appear for that VDACC. The benefit of this is both saving space and achieving a simpler operation of the VDACC, as you don't have scrollers appearing that are not needed to perform useful tasks.

D-13D. Scroller caps are used to place scroller markers. VDACC scrollers can be scrolled to any desired position and then clicked on in some manner (e.g., double clicked) to place a scroller marker. This marker marks the exact location of the scroller cap along a vertical or horizontal edge of the VDACC. The advantage of these markers is that they can be clicked on to enable a user to instantly navigate to the exact position marked by the scroller marker. These markers can also be labeled so users can read these labels to see what each marker is marking in their VDACC.

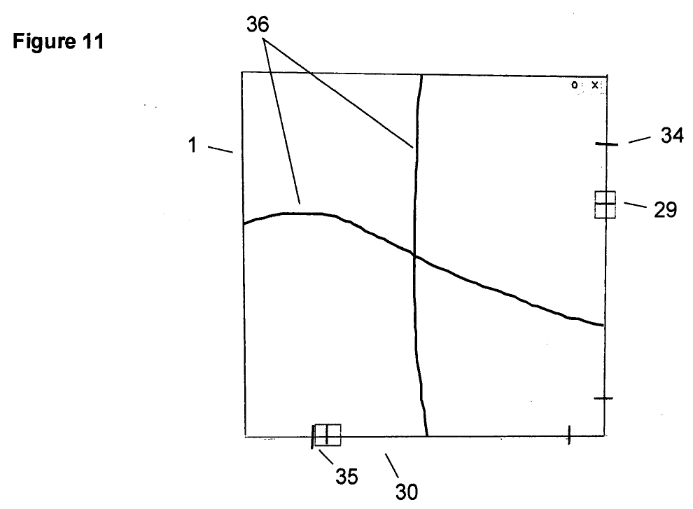

FIG. 11 depicts a VDACC 1 containing two line objects 36 that exceed the VDACC's 1 external perimeter. For this reason a vertical scroller cap 29 automatically appears on the right edge and a horizontal scroller cap 30 appears along the bottom edge. The scroller cap 29 has been double-left clicked on to generate a vertical scroller marker 34 and a horizontal scroller marker 35. These scroller markers 34 and 35 can be double-clicked on (or the equivalent) at any time and the VDACC 1 will scroll to the position marked by each marker to bring the user to an exact position with respect to viewing the content of VDACC 1.

D-13E. Labeling a scroller marker. One way to label a scroller marker is to right-click on the scroller marker and in the Info Canvas for that marker (see the section entitled “Info Canvas” below), select the entry “Label”. This will automatically place a text cursor next to the marker. Then, a user need only type text and the label is defined. Another way to provide a label for a marker is that when the marker is first placed, a text cursor automatically appears next to the marker. The user then types to define the label.

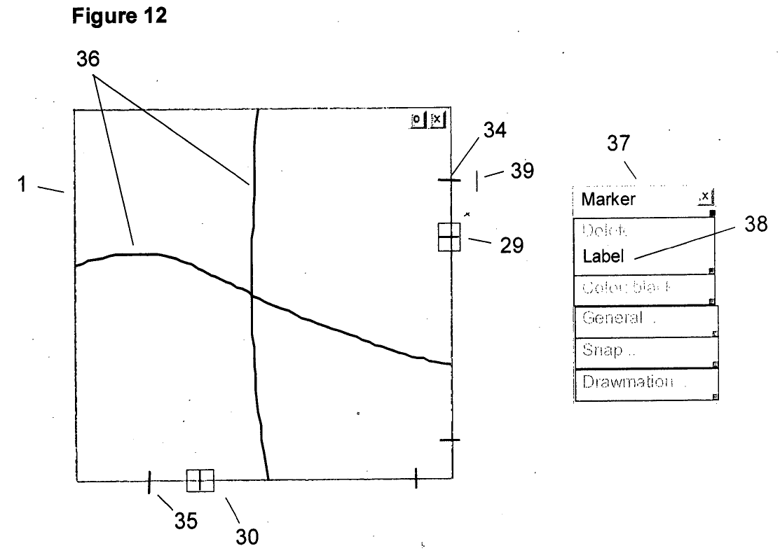

FIG. 12 illustrates the use of an Info Canvas to insert a label for a VDACC scroller marker. FIG. 12 depicts a VDACC 1 containing two line objects 36 which extend beyond the perimeter of the VDACC. For this reason vertical and horizontal scroller caps 29 and 30 appear automatically. In this illustration, vertical scroller marker 34 and horizontal scroller marker 35 have been placed on the right edge and bottom edge of the VDACC 1 for the purposes of enabling instant navigational positioning of the VDACC content. When the scroller marker 34 is right-clicked on, an Info Canvas 37 for that marker appears. In this Info Canvas 37, the entry “Label” 38 is activated and upon activation, a text cursor 39 automatically appears next to the scroller marker 34. With a text cursor next to the scroller marker 34, the user now types text to label the scroller marker 34. This labeling operation can be repeated as required for every scroller marker that is placed along the perimeter of the VDACC 1.

D-14. Automatic agglomeration of items on a VDACC. A key aspect of a VDACC is that any item that is dragged onto it and is clipped to it is agglomerated to that VDACC. Agglomeration means that all objects associated with a VDACC automatically maintain and adjust their relative positioning no matter how the VDACC perimeter or items within the VDACC are moved, unless the user wishes to control the position differently. This offers major advantages to the layout of documents and the organization of graphical information onscreen.

The following is a comparison between a VDACC and the graphical environment that would exist in a conventional graphics program. Let's say a user working with a conventional program creates a 6″×5″ black rectangle onscreen. Let us further say that this user draws a green star, a yellow circle and imports a picture. Now what the user desires here is to have these three items laid out on this black rectangle in a specific way such that the star, the circle and the picture are inside the perimeter of the black rectangle and that they comprise a pleasing layout. To accomplish this task, the user places the star, the circle and the picture on top of the 6″×5″ black rectangle by dragging them or copying and pasting them onto the rectangle.

The user then clicks on the black rectangle and drags to move it. The rectangle moves, but in the conventional program, the items that the user just spent time placing on this black rectangle in a specific layout do not move and the layout is disturbed. To recreate the original layout, the black rectangle needs to be moved back into its original location and the objects need to be repositioned on top of it.

Continuing with this example, if the user wishes to move the black rectangle and have the items that have been placed on it move with it, what is done in conventional graphics programs is that the black rectangle and the items placed on it must be grouped together. This is done by first selecting all of the items (including the rectangle), either by clicking on each of them while holding down a key, like the Control key, or by lassoing them all with a lasso, or some similar method. Then a user goes to a pull down menu, a pop up menu, a floating task bar or the equivalent and finds the feature “group” and then clicks on it. This procedure groups all of the items together.

When all of the items described above are grouped together, they can be moved as a single item. Only after the black rectangle and the items placed on it have been glued together can the black rectangle and all of the items that have been placed on it be moved as a single unit.

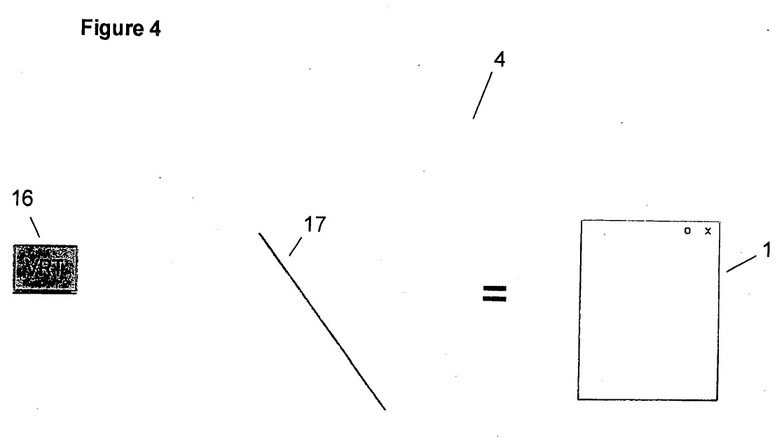

Let's now consider this same process using a VDACC. A VDACC is created onscreen using a VRT, which is disclosed in pending U.S. patent application Ser. No. 10/053,075 as a DRT. The creation of a VDACC in this manner requires the simple drawing a diagonal line, as illustrated in FIG. 4. FIG. 4 shows a VRT 16 that is used to create a VDACC 1 by drawing a diagonal line 17. The VDACC creating process is as follows. The VRT switch 16 is activated by a mouse cursor click. The mouse is then left-clicked and in that position is used to the diagonal line 17, which creates the VDACC 1. Once the VRT switch 16 is activated, as many VDACCs as desired can be created through drawing diagonal lines onscreen.

Referring back to the example, the length and angle of the diagonal line determine the height and width of the VDACC. So a VDACC is drawn to be 6″×5″. The default background color for the VDACC is black. Then the green star, yellow circle and picture are each dragged onto the VDACC and placed where the user wishes them to be. These items can be clicked on and repositioned once they are on the VDACC to get them into the exact desired positions. Then to move all of the items on this black rectangle (VDACC) as a unit, the user clicks on the VDACC and drags in any direction and all of the items move perfectly with the VDACC. Furthermore, all of these items' relative positions to each other and to the VDACC are preserved regardless of the location to which the VDACC is moved. There is no need to group these items to each other and to the VDACC. This is because as each item is placed onto the VDACC is automatically agglomerates to the VDACC.

There are more advantages to the agglomeration feature than just the convenience of moving a VDACC and having items placed on it move with it, as described below.

D-14-A. Items on a VDACC can be repositioned any time. Once a number of items are placed on a VDACC, they can be repositioned at any time. So a user can change his or her mind as often as he/she desires and never have to concern themselves with having to ungroup items, move one or more of them and then regroup these items to preserve their relationship to themselves and to the background on which they have been placed.

D-14-B. A VDACC can be resized without affecting the size of the items sitting on it. The default condition for a VDACC is called the Portal Mode. In this mode, the perimeter size of the VDACC can be adjusted bigger or smaller in any direction without changing any of the positions of the items clipped into the VDACC or affect the sizes of these items.

FIG. 6 depicts resizing a VDACC 1 in the portal mode. The VDACC 1 contains a collection of objects including a folder, a circle and a rectangle. The lower right corner of the VDACC 1 shows the portal resize button 19. Using the mouse cursor, the resize button 19 is left-clicked on by the user and moved diagonally towards the upper left of VDACC 1 along path 20. The VDACC 22 illustrates the appearance of the VDACC 1 after its size has been reduced using the resize button 19. Upon reducing the size of the VDACC 1 such that the perimeter of the VDACC 1 intersects the perimeter of one or more of the objects within it (as illustrated by the VDACC 22), scroller caps 23 appear. The scroller caps 23 are positioned at the bottom left (horizontal axis) and upper right (vertical axis) of the VDACC 1. The scroller caps 23 travel along a one pixel wide perimeter line of the VDACC 1 and they are transparent, which permits the user to view objects through them.

D-14-C. A VDACC can be resealed where all of the items on it are proportionately resealed with it. If a VDACC is switched to the “rescale” mode, then when the VDACC has its perimeter size altered, every item clipped into it, will be proportionately rescaled. This enables a user to place a number of items on a VDACC and then alter the overall size of the VDACC and proportionately change the size of object clipped into it. In this way, a VDACC can be made smaller or larger either proportionally or non-proportionally and all of the items on it will have their geometry altered accordingly.

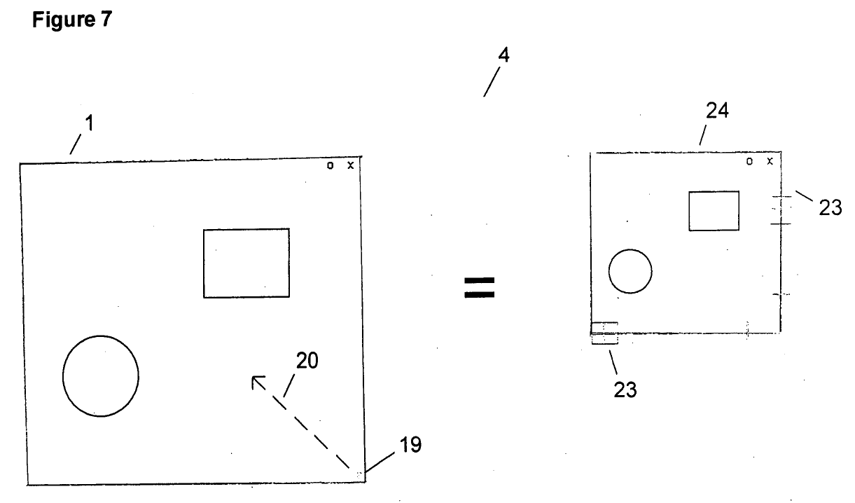

FIG. 7 depicts resealing a VDACC 1. There are two types of “resize” for a VDACC: (1) portal resize, and (1) rescale. When a VDACC is in the portal resize mode, the resize button 19 in the lower right corner of the VDACC is a particular color, e.g., the color gray. When a VDACC is in the rescale mode, the resize button 19 in its lower right corner is a different color, e.g., the color green. Selection of the rescale mode is made in the Info Canvas for a VDACC. This is accessed by right-clicking on the VDACC and in the Info Canvas left-clicking on the entry “rescale” so it turns, for example, green (on).

In FIG. 7, the lower right corner button 19 for VDACC 1 is green indicating that this VDACC is in the rescale mode. This green button is left-clicked on and dragged along path 20. In doing this every item clipped into VDACC 1 (the folder, the circle and the rectangle) are proportionately rescaled. The VDACC 23 illustrates the appearance of the VDACC 1 after its size has been reduced in the rescale mode.

D-15. VDACC layering. Let's return to the example of a 6″×5″ black rectangle containing a green star, a yellow circle and a picture. In existing graphics programs, a popular layering scheme is simply this: the 1^{st} item placed is layer 1 (the bottom most layer), the 2^{nd} item placed is the 2^{nd} layer, the 3^{rd} item placed is the 3^{rd} layer and so on. This means that the choices a user makes (which items are placed on the black background 1^{st}, 2^{nd}, 3^{rd}, etc.) determine their layers. Then if a user wants to change these layers, the user must go to a menu and select through a group of “arrangement” or “layer” choices, e.g., “back one”, “forward one”, “send to the back”, “bring to the front”, “in front of”, “in back of”, etc. The more items a user places on the black background, the more complex the management of the layers becomes. This can become particularly troublesome when one is trying to place a number of items on a picture. In short, layering in graphics programs presents a complex and challenging management task, which grows more difficult as the number of graphic items increases onscreen. Using existing graphics programs the black rectangle would have the bottom layer designated to it. The green star would be layer 2, the yellow circle, layer 3 and the picture would be layer 4. So, if you drag the green star to the yellow circle, the green star will go under the yellow circle. If you drag the yellow circle to the picture, it will go under the picture. If you drag the picture to the green star, it will go over the green star. So, in this scenario, placing the green star and the yellow circle on top of the picture would not be possible without changing the layer of these items. While this may not seem like a major organizational problem with three items, imagine how careful a user would have to be if the user was managing 100 items or 1000 items onscreen at one time. The need to constantly change the layer of each of these items in order to get them to go over or under a given item is not an easy prospect. Here's why.

If you consider the prevalent graphics program scheme of assigning each new item that is placed onscreen with a progressively higher layer number, this means that to change the layer of item 60 to be under item 20 is not so easy. Using the “back one” layer approach is tedious and not practical. By this method, each time you select “back one” the layer of the item that has been selected will move down one layer, i.e., from 60 to 59. Using the feature “in back of” is more practical, but it still requires going to a pull down menu or task bar and making a choice every time a layer choice is required for an item. The following steps would be required to operate the “in back of” instruction for an item with a layer of 60 to make it appear under an item with a layer of 20:
A. Select the item with a layer of 60.
B. Click on a pull down menu or task bar and find the category “arrangement” or “layers”.
C. Under this category find the entry “in back of”.
D. Click on this entry.
E. Then click on the item that you want the item with a layer of 60 to be behind, in this case, it's the item with a layer of 20. So click on this item to select it.
F. Hit the Enter key to program this change.

At this point, the item that had a layer of 60 will now have a layer of 19 and will now be behind the item with a layer of 20. The question arises, what does this do to the layer number of all the other items onscreen? The answer is that all of these layer numbers are generally changed accordingly. In other words, the item that was layer 61 now has a layer of 60 and the item that had a layer of 19 now has a layer of 18. In addition, the item that had a layer of 20 now has a layer of 21, the item that previously had a layer of 60 is now layer 20, the item that had a layer of 59 is now 60 and so on. No matter how one thinks of this, the layering issue is not simple. At best users are forced to constantly access pull down menus or task bars every time they wish to move one item above or below another item and at worst, users spend considerable time searching to understand why certain items are no longer visible onscreen. If anything, these problems have been understated. And most certainly this layering issue has been one factor that has kept complex graphics out of the hands of beginners and in the hands of professionals.

D-15-A. VDACC layer management. When you move an item in a VDACC, the item being moved automatically becomes the top layer after it has been dragged a certain distance, e.g., 3 pixels, and a mouse up-click is performed. At no time does a user have to access a pull down menu or a task bar to change the layer of an item to the top layer. To make any item go on top of any other item, the user just moves it. Although users can alter the prescribed required distance, the default distance is three pixels. So, if any item is moved just three pixels, it becomes the top layer and will go above any item it is dragged to. This same principle applies to objects being moved in Primary Blackspace as well as in VDACCs

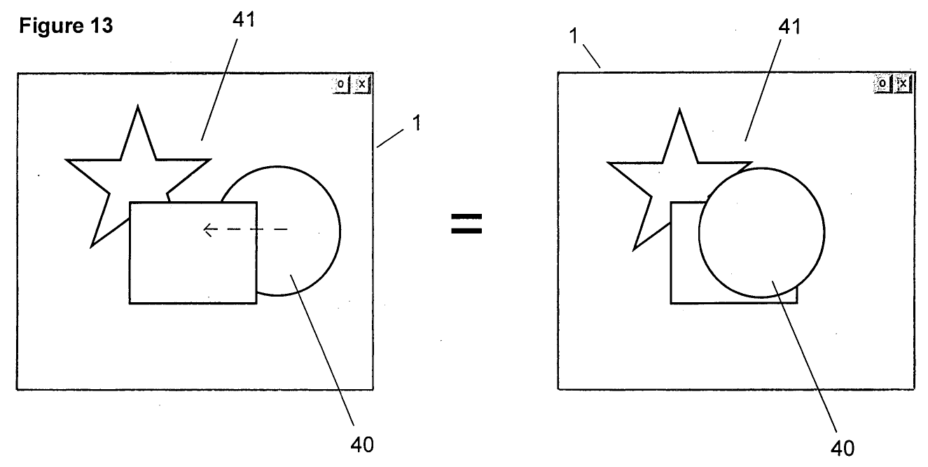

FIG. 13 depicts a VDACC 1 containing a group 41 of objects, a recognized star, a circle 40 and a rectangle positioned in layers relative to each other. By left-clicking and moving the circle 40, the circle automatically moves to the top layer of the group 41 of objects contained in the VDACC 1. Any object that is left-clicked on and moved within the VDACC 1 automatically moves to the highest level of objects contained therein.

D-15-B. Layer Fader. If you have multiple items overlapping each other or if you have multiple items underneath a larger item such that you cannot see the other items, it is possible to alter the layer of any of these items without moving them. This is accomplished with a layer fader. Note: a knob or a switch, or a joystick or any other suitable device for more making incremental changes could be substituted for a fader in Blackspace.

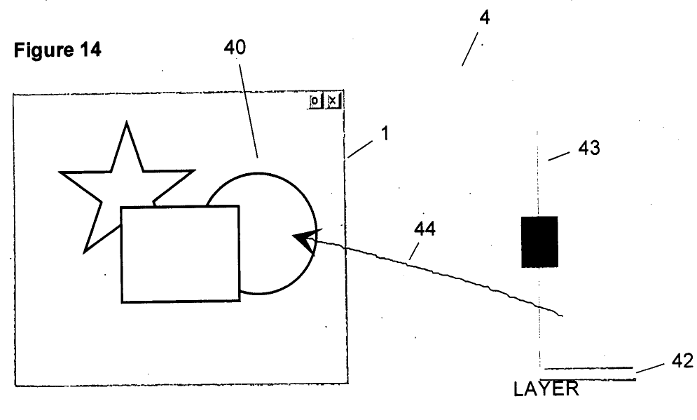

FIG. 14 illustrates how a fader can be used to control the layering of objects in a VDACC. In FIG. 14, a VDACC 1 containing three objects, including a star, a circle 40 and a rectangle positioned in specific layers with respect to each other, is shown. The user then draws a fader 43 in Primary Blackspace 4. The user then types the text label “layer” within a predefined gap 42 of the fader 43. The default for this gap in Blackspace is 1/4 inch, but it is a user-selectable function controlled by a selection made in an Info Canvas. If this label is typed within the gap required for programming a fader, the fader 43 instantly turns into a layer fader.

After this label is typed, the user activates the Draw Mode, for instance, by left-clicking on a Draw switch and then drawing an arrow 44 (containing the log: “control the object that the arrow is pointing to with the object that the arrow is drawn from”). This arrow is drawn to intersect the fader 43 and the circle 40. After drawing the arrow 44, the user does a mouse up-click and then touches the head of the arrow to initiate the arrow's action. In this case, the action is enabling the fader to adjust the layer of the circle object 40. To adjust the layer of the circle object 40, the fader cap of the fader 43 is moved up or down. As the fader cap is moved up or down, the layer of the object 40 is changed to a higher or lower layer.

D-15-B1: Creating a layer fader. To create a layer fader, the user would draw a fader that will be recognized by the software as described in pending U.S. patent application Ser. No. 09/785,049, entitled “Method for Creating and Operating Control Systems”, filed on Feb. 15, 2001, which is incorporated herein by reference. Once the fader is drawn, the user can type or say “layer” or its equivalent. If a user types “layer”, it must be typed so that it is within the gap default of the fader or so that it overlaps part of the fader. A typical gap default for Blackspace is one quarter inch. If the user utilizes a verbal command directly after drawing the fader, the verbal command will immediately program the fader and it will become a “layer fader”. If a verbal command is used later, then the fader will first need to be selected and then the verbal command “layer” (or its equivalent) will be verbalized and the fader will then be programmed to be a layer fader. Another approach to programming the fader is to type “layer” and then drag the text until it overlaps some portion of the fader or is within the default gap of the fader and then do a mouse up-click. Upon the up-click, the fader will be programmed to be a layer fader.

Once a user has created a layer fader, it can be kept for later use. One way to keep it is to assign it to an item.

D-15-B2: Assigning a layer fader to an item. To assign a layer fader to an object, the following can be carried out:
(1) Draw an arrow that equals the logic “assign the item(s) that the arrow is drawn from to the item at which the arrow is pointing.”
(2) After drawing the arrow, do a mouse up-click and then touch the head of the arrow or its equivalent to initiate the assignment.

When this is done, the fader will disappear into the item to which it was assigned. Then clicking on the item will make the fader reappear. Clicking on the item again will toggle the fader to disappear again and so on.

D-15-B3: Operating a layer fader. There are two common methods to operate a layer fader.

Method 1: To operate a layer fader, draw an arrow that equals the logic “control the item from which the arrow is drawn by the item(s) to which the arrow is drawn”. In this case, draw such an arrow to originate from the layer fader and point to any item that is either overlapping other items or being overlapped by other items.

To change the layer of any of these four items in the current example, move the fader cap for the layer fader up or down. If the layer fader cap is moved upward, the item to which the arrow was drawn to will adjust its layer toward the top layer. If the layer fader cap is moved downward, the layer of that item layer will change toward the bottom layer. When the fader cap is at the bottom of its travel, the layer for the item that the arrow was pointed to will be at the bottom. Likewise, if the fader cap is moved all the way to the top of its travel, the layer of the item it controls will be at the top, over the other three items that previously overlapped it.

Method 2: Click on any of the four items in this example. Then move the layer fader's cap. This will automatically change the layer of the item that was clicked on.

An alternative to method 2 is that when a user clicks on any item that is overlapping or is overlapped by another item, the number of overlapping items automatically appears along the side of the layer fader. Then the user can click on any of these numbers to select any of the overlapping items and then move the fader up or down to adjust their layer in relation to the other three items.

Disconnecting the control of the layer fader from any item. For method 1, do the following: select “Show Arrow” in the Info Canvas of Blackspace (see the section entitled “Info Canvas” below) or create a switch and label it “Show Arrow,”which will then show the arrow that was drawn between the layer fader and one of the overlapping items. Then either right-click on the arrow that appears and select “Delete” in its Info Canvas or turn on the “Draw Mode” and scribble over the arrow that is shown to delete it.

Generally the first approach for using the layer fader is more useful when you have many items overlapping each other or there are multiple items on top of a single item. But the second approach is generally better when you have less than 10 items overlapping each other, as 10 numbers fit easily along side a layer fader of modest length. Of course, a user could draw a fader to be longer and this would provide more room along its side for numbers representing each item in a group of overlapping items. Note: layering as described above is not limited to a VDACC. It works the same way in Primary Blackspace.

D-16. VDACC “Allow Ripple”. The scroller markers along the sides of a VDACC can be used to select all of the contents in a VDACC or any portion of these contents. The following describes how this is accomplished. Every VDACC has two scroller markers that are automatically placed the moment a scroller appears on one of its vertical or horizontal edges. These automatic scroller markers have a default location and color. Regarding the vertical edge of the VDACC, a white marker is placed at the very top of the VDACC, just under the top edge of the VDACC. This marks the beginning of the scrollable area of the VDACC. A blue scroller marker is placed very near the bottom of this edge. This marker marks the end of the scrollable area of the VDACC. To click (or double click) on the white marker will instantly take a user to the beginning of the VDACC's scrollable area. To click on the blue marker will instantly take a user to the end of the VDACC's scrollable area.

D-16-A. Users can set their own VDACC scroller markers. (See pending U.S. patent application Ser. No. 10/188,625 entitled “Improved Scroll Bar for Computer Display”, filed on Jul. 1, 2002, which is incorporated herein by reference). Many methods can be used to create a scroller marker along the edge of a VDACC. They can include, for example, using a verbal command, like “set marker”, drawing an arrow from a marker switch to a point along the edge of a VDACC, or double clicking on the scroller cap where it sits along the edge of a VDACC.

Regarding the last method, if a user wishes to mark a particular spot along the edge of a VDACC, the user can double click on the scroller cap and the software will place a marker of some color (e.g., yellow) that intersects or is adjacent to the exact spot where the scroller cap is sitting. One visual implementation of a marker is using a short line that is perpendicular to the vertical edge for a vertical marker or perpendicular to the horizontal edge of the VDACC for a horizontal marker.

Let's say that a user moves a scroller cap halfway down along the vertical edge of a VDACC and then double clicks on the scroller cap. This will place a short line perpendicular to the right perimeter line of the VDACC. Later when this line is double or single clicked on or touched once followed by a verbal command, e.g., “search”, the VDACC will immediately scroll to the position that it was in when this marker was created. In this manner users can quickly navigate to any marked position in the VDACC's scrollable working surface. These markers can be used to navigate vertically or horizontally, enabling the VDACC's working surface to be very large and still be easily navigatable.

D-16-B. Using Scroller Markers for operating Allow Ripple. Allow Ripple is the ability to enable items in a VDACC to move up or down, or to the right or left when other items are added to or deleted from the VDACC, or existing items are increased or decreased in size. The objective of this function is to be able to add or subtract from the number of items in the VDACC or to be able to change the sizes of existing items without altering the horizontal or vertical spacing between existing items.

For instance, with Allow Ripple turned on for every object in a VDACC, a user can type more text, which adds multiple sentences to an existing text object, which in turn adds vertical height to that text object. In this process of adding more vertical height to the text object, all of the items that exist in the VDACC will automatically be adjusted downward by the exact amount of vertical distance that was added by typing the additional sentences in the existing text object.

Any item that can be placed on or in a VDACC can be controlled by Allow Ripple. This includes recognized graphics (stars, circles, squares, check marks, etc.), free drawn lines (sketches, doodling, notes, etc.), text objects (any typed text of any size, font type, style, etc.), pictures (any type of picture format that can be read by the software, i.e., .png, .bmp, .jpeg, .gif, etc.), video (any type of video format read by the software, i.e., DVIX, MPEG1, 2 and 4, etc.), animations, etc.

The benefit of Allow Ripple is that it enables a user to place multiple graphic objects into a VDACC and then type text. As more text is typed and vertical lines are added below the text, all objects below this text are pushed downward by a distance that equals the height of the added sentences to the text. Here's how Allow Ripple works.

Let's say that a user wishes to insert a picture into a VDACC. The white and blue vertical markers are lassoed to select them. When they are lassoed, the lasso remains visible to indicate that all of the items in the VDACC have been selected. Then any of these items are right clicked on and the entry Allow Ripple is selected in the Info Canvas for that item (see the section entitled “Info Canvas” below). When Allow Ripple is selected for just one item, every item that is selected in the VDACC has its Allow Ripple feature turned on as well. This only needs to be done once and all VDACC items will remain with their Allow Ripple feature engaged.

Now the user inserts an object into the VDACC. There are various methods to do this. In a first method, an arrow is drawn from a picture that is sitting outside the perimeter of the VDACC where the arrowhead of the arrow points to the place where the top edge of the picture is to be inserted. If it is a horizontal insertion then the tip of the arrowhead will point to the left edge of the picture to be inserted. On the mouse up click or its equivalent, the picture will be moved from outside the VDACC to inside the VDACC and all of the items below (in the case of a vertical insertion) will be move downward by distance that equals the exact height of the inserted picture. In the case of a horizontal insertion, all of the items to the right of the picture will be moved to the right by a distance that equals the width of the picture.

The fact that “Allow Ripple” works equally efficient and accurate on both horizontal and vertical planes is part of its benefit. In addition, once engaged, “Allow Ripple” does not require the grouping of graphics, text, pictures, devices, etc. in a VDACC. All of these items can remain independent (ungrouped to each other) and can therefore be easily moved or altered at any time independent of any other item in the VDACC.

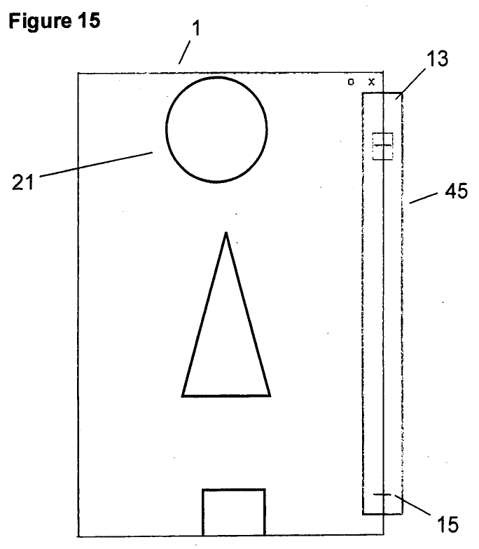

FIG. 15 depicts a VDACC 1 containing three objects 21 which have been simultaneously selected by lasooing the white and blue scroller markers 13 and 15 along the right side of the VDACC. The lasso tool is activated by turn on a lasso switch, labeled “Lasso”, or drawing a “lasso” onscreen, etc. Generally in this software, the preferred lasso color is red, but any color can be used. Shown in FIG. 15 is the scroller markers 13 and 15 after they have been lassoed. A red lasso first appears (not shown) and then the software detects every object that is managed by the VDACC that exists within the area determined by the position of the two scroller markers 13 and 15 that have been lassoed. When all of these objects have been detected, the lasso 45 turns blue. To lasso these two markers the mouse cursor is placed at the left top of the white marker 13, left-clicked and dragged diagonally across the lower blue marker 15 to encircle it along with the white marker. When both the white (the top) and the blue (the bottom) markers for a VDACC are lassoed, this selects every object that is managed by that VDACC. This same approach can be applied to horizontal scrollers as well. Lassoing the white and blue horizontal scrollers for a VDACC likewise selects every object that is managed by that VDACC.

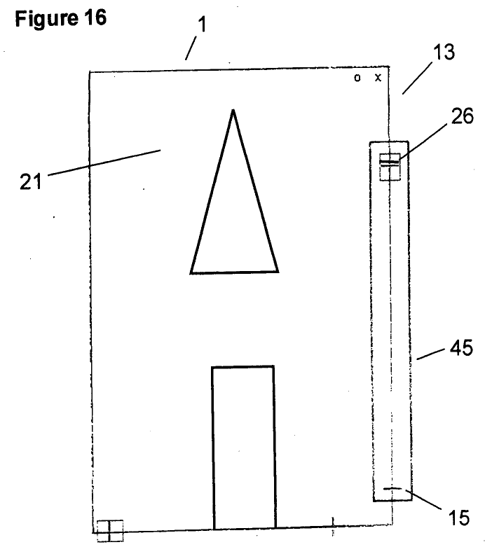

FIG. 16 shows another aspect of lassoing scroller markers on a VDACC. Users can place their own scroller markers by double clicking on the scroller cap. When this is done, a scroller marker is placed at the exact location of the red cross line on the fader cap. In FIG. 16, a marker has been placed by double-clicking (or its equivalent) on the scroller cap and this has placed a marker 26. This marker has been moved up just enough so it can be seen in this illustration. But in practice the black marker 26 will not be visible until the scroller cap is moved up or down to reveal the marker placed under the red cross line on the scroller cap. The red cross line is a short line which is perpendicular to the right and left edges of the scroller cap and is located directly in the middle of the cap measuring from top to bottom.

When a user lassoes a placed marker, like the marker 26, and then lassoes the blue marker 15 beneath it, the following is selected: all of the objects that are visible in the VDACC, plus all of the objects that exist below these objects extending to the bottom of the VDACC.

If a user lassoes a marker, e.g., the marker 26 plus the white marker 13 above it, what would be selected is everything that is visible in the VDACC plus all of the objects that extend to the top of the VDACC.

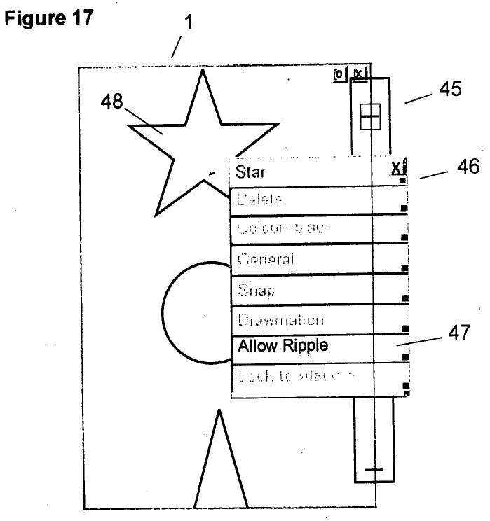

FIG. 17 depicts a VDACC 1 in which the white and blue scroller markers have been lassoed and the lasso rectangle has changed color from red to blue, signifying the selection of the objects contained in the VDACC 1. Then, by right-clicking on any object (in this case the star 48) within the VDACC 1, an Info Canvas 46 appears. The user then left-clicks on the Allow Ripple entry 47 in the Info Canvas for the object 48. The activation of the Allow Ripple function for this object 48 will activate this function for all of the objects managed by this VDACC 1. The reason is that the objects are all selected by the lasso. Since the objects are all selected, any activation of any entry in any Info Canvas for any one of these objects, will activate that entry for all of the VDACC's objects. With Allow Ripple engaged for all objects managed by this VDACC, this will ensure that when any one or more objects within the VDACC is moved up or down (in this case), moved left or right, increased or decreased in size, added or deleted, etc., the relative spatial positions of all the other objects from each other within the VDACC will be maintained. This Allow Ripple function ensures continuity of the horizontal and/or vertical spacing between existing items in a VDACC.

D-17. Layer of VDACC. A VDACC is a graphic object and it acts like a graphic object in the Blackspace environment. For instance, whenever a VDACC is clicked or touched and dragged, it automatically becomes the topmost layer and will appear over the top of anything else appearing in Blackspace. The most recently moved VDACC remains the topmost object until some other object is selected and moved, just as would be the case for the most recently moved graphic object, like a star or circle or picture.

D-18. Assignment of VDACC. Within a VDACC, the user may create, recall, download, import, or otherwise access any onscreen objects. The user may modify, link, edit, actuate, combine or otherwise work on any of the objects within a VDACC. If a VDACC is assigned to something else, such as a triangle, a switch or another VDACC, the VDACC with all its contents and functional relationships is saved to the assigned-to object. The assignment may be made by drawing an appropriate arrow from the VDACC to some other onscreen object, after which that onscreen object may be recalled at any time (such as by hand drawing the object) and activated by tapping it to display the VDACC and all its contents, assignments, and relationships.

D-19. VDACC Data Structures. A VDACC is an example of a graphic object. It has a border and a non-transparent background. It also may have other graphic elements such as “close” and “maximize” switches or a title in the top left corner. It can be resized in the same way as other graphic objects when the mouse is clicked on the resize handle or when the mouse is clicked on the border in proportional or non-proportional resize mode.

In addition to its own graphical elements, the VDACC also owns a data object referred to as a graphic linker. This linker is a list of the graphic objects which are “managed” by the VDACC. Stated another way, the graphic linker is a software object which is basically a list of graphic objects and a set of actions that can be applied to all of the objects in the linker. For example, let's take the action “move.” If the software tells the graphic linker to move a certain distance, then all of the objects that this linker controls will move by this distance.

The VDACC owns a single software object, which is the graphic linker. The VDACC doesn't own all of the objects separately. If a user lassoes some of the objects placed into a VDACC, but not all of them, and the perimeter of the lasso is completely within the boundary of the VDACC (namely, the lasso does not intersect this boundary), then objects can be selected by a lasso in a VDACC without selecting the VDACC itself. In this case, the method of using a lasso can be used to select a portion of the objects in a VDACC. The graphic linker of this VDACC will not participate in this lasso transaction. The lasso lassoes these objects and ignores the fact that these objects are owned by a VDACC. The graphic linker allows objects that it owns to be manipulated by other means independently.

Operations such as moving and resizing operate first on the VDACC itself and then on the list of controls held in the graphic linker. Clipping is a feature of all graphic objects. Every graphic object keeps a reference to two VDACC objects. One is the VDACC to which it belongs, and the other is the VDACC which is to provide clipping information. If the latter reference is “valid” then the drawing routines for the object will only operate within the boundaries of that VDACC.

Scrolling operates on the list of controls in the graphic linker. An independent list of controls is maintained for scrolling purposes which identifies those controls which are entirely outside the perimeter of the VDACC. These controls are not moved until they are scrolled back into view Data Structure.

If an object existing in a VDACC is clicked on and dragged, at the moment it is dragged, it will no longer belong to the graphic linker. When it is placed back into the same VDACC (as would be done if an object were being repositioned on a VDACC) then it is again added to the graphic linker's list for that VDACC. If it is placed outside the perimeter of the VDACC, then it remains removed from that VDACC's graphic linker list.

When an object that is a member of a VDACC's graphic linker is clicked on and moved, this object is removed from that graphic linker's list, but the object still retains clipping information from that VDACC. This clipping information remains as part of the definition for this object, until the mouse and the object it's dragging are moved outside the perimeter of the VDACC. One way to determine what is outside the VDACC is to consider where the tip of the mouse cursor is. If an object that is a member of a VDACC's graphic linker list is moved such that the tip of the mouse cursor moving that object is outside the VDACC, than the object is removed from that VDACC's graphic linker list.

D-19-1. Operating with objects on a VDACC that is sitting on another VDACC. A VDACC that is sitting clipped to another VDACC is referred to as a daughter VDACC. The VDACC that it is clipped to is referred to as the mother VDACC.

If an object that is clipped to a daughter VDACC is dragged such that the tip of the mouse cursor is outside the boundary of the daughter VDACC but inside the perimeter of the mother VDACC and the object is releases, the following happens. The object then joins the linker of the mother VDACC and acquires clipping information from the mother VDACC. When the drawing software is about to draw an object it asks that object whether it's been clipped, and that object looks to see if it has a clipping VDACC. If it has, then the dimensions of that VDACC are passed back to the drawing software.

When the graphic object is drawn, the drawing software asks whether it's been clipped or not. If it is being clipped, then the object will return the rectangle which represents the size of the VDACC which the object has kept this reference to, as being its clipping object, to the drawing software.

Let's look at this another way. Something has told the drawing software that a particular piece of screen needs drawing. This could be caused by dragging an object from one location to another. The drawing software then looks to see what objects are in that particular piece of screen. The software then asks each object in turn whether it's being clipped or not. Each object will know that it's being clipped because it has a reference to a VDACC in it's clipped location. Then the visible area of that VDACC's rectangle will be sent back to the drawing software.

The most basic definition of clipping would be this: if an object is clipped, that object has been added to the graphic linker list of a VDACC.

D-19-2. The size of the VDACC linker and the size of the VDACC can be different. The VDACC has its own size and the VDACC's linker has its own size which is separate from the VDACC's size. The linker can change its size depending upon how big an object is that is placed into a VDACC. The VDACC's size does not change. If an object whose, perimeter exceeds the size of a VDACC's perimeter, is placed into that VDACC, the graphic linker for that VDACC will increase its size to accommodate that object as the object is clipped into the VDACC.

D-19-3. Calculating the position of an object in a VDACC. Everything in Blackspace is calculated on the global drawing surface. Let's say there is a triangle sitting in Primary Blackspace outside the perimeter of a VDACC that is also sitting on Primary Blackspace. If this triangle is then dragged so that the tip of the mouse cursor is inside the perimeter of the VDACC and then a mouse up-click is performed, the object is clipped to the VDACC. The position of this object is calculated not from the edges of the VDACC that it was just placed inside, but rather from the edges of Blackspace (the global drawing surface).

Now the VDACC is moved. The object now sitting on the VDACC has been entered in the graphic linker list for the VDACC. If the VDACC is then moved, the positions of both the VDACC and the object sitting in it are calculated according to where they both are in global Blackspace. The VDACC knows that the object now belongs to it, as the object is listed in its graphic linker, so the object moves with the VDACC as the VDACC is moved.

As the triangle is moved and also after the mouse up-click after moving it the drawing software gets a message saying: “this little bit of the screen needs refreshing. There's a green triangle here.” Then the drawing software says: “does this triangle need clipping?” And then the green triangle tells the drawing software whether it has a clip rectangle reference or not.

Summary and additional details about VDACCs: A VDACC has many properties that enable it to be user friendly and user customizable. As an example, when text is typed into a VDACC, the text automatically wraps when it hits the right side of the VDACC. A VDACC can also be used by other objects to provide a useful operating environment. As an example, when text that is smaller in width is dragged into a VDACC the user can set the text to “Wrap to Edge” and the text will be rewrapped to extend to the right side of the VDACC.

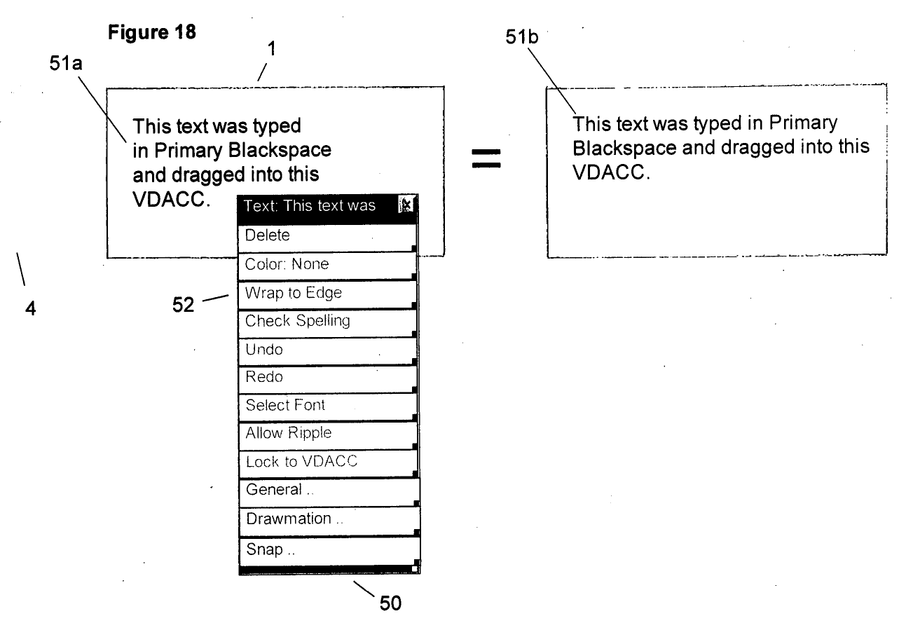

FIG. 18 depicts the automatic text wrap function in a VDACC, referred to as “Wrap to Edge.” This feature enables text that is typed in a VDACC to automatically wrap when it hits the right side of the VDACC. This feature also enables text to automatically wrap when it hits the right side of Primary Blackspace (the right side of a computer screen). In FIG. 18, text 51a was typed in Primary Blackspace 4 and dragged into a VDACC 1. In this case, the text 51a does not automatically wrap as it does not encounter the right side of the VDACC 1. If it is desired to have this text's line widths equal the width of the VDACC 1, “Wrap to Edge” can be activated for that text. The user can right-click on the text 51a to open an Info Canvas 50 for that text. In this Info Canvas 50, the user can left-click on the Wrap to Edge entry 52 to activate this function. The result is that each line of text is extended to the right side of the VDACC 1 and wrapped automatically as shown in example 51b.

Note: text can be made to wrap automatically in Primary Blackspace by the same process as just described for a VDACC. But instead of wrapping when it hits the right side of a VDACC, it wraps when it hits the right side of Primary Blackspace.

3. Auto Agglomerate: Whenever any item (e.g., a picture, video, graphic device (fader, knob, switch, etc.), text, sketches, data files, and the like are dragged into a VDACC or called forth within a VDACC (via the Info Canvas for that VDACC or its equivalent—see the section entitled “Info Canvas” below), these items are automatically agglomerated onto the VDACC without requiring a paste command. Any such item may be clicked or touched and dragged to reposition it within the VDACC or to move it out of the VDACC or into another VDACC. But when a VDACC is dragged, all items within the VDACC are dragged with it, and the visibility of the items on the VDACC remains unchanged.

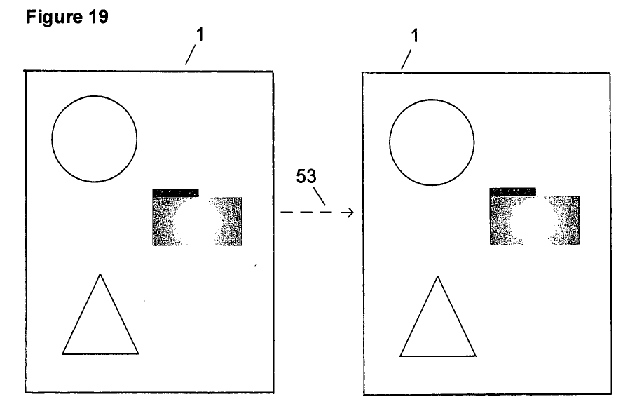

FIG. 19 depicts the agglomeration of objects to a VDACC. In FIG. 19, a VDACC 1 is shown containing three objects, a folder, a star and a rectangle. This VDACC 1 has been modified to remove the close and maximize boxes and the resize button to enable the VDACC to appear as a graphic rectangle. But in a graphics program, the placement of objects on another object would need to be secured by grouping all of the objects together. Otherwise when the rectangle was moved, it would simply slide out from under the circle, triangle and folder.

Using a VDACC as a graphic rectangle remedies this problem. All objects placed within the perimeter of a VDACC are agglomerated to it—become managed by it and belong to it. Now, when the VDACC is moved, the objects contained within it move concurrently. However, any one or more of the objects agglomerated to a VDACC can be repositioned within the VDACC without affecting the positions of any of the other objects within that same VDACC. Still, when the VDACC is moved, all of the objects belonging to it will move and maintain their exact relative positions to one another in the VDACC, as illustrated in FIG. 19.

4. Using a VDACC as a storage device. Clipping may also be exploited when using a VDACC as a storage device. A multitude of small VDACCs may be placed onscreen, and each may contain at least one large onscreen object. Only a small part of each large onscreen object is visible (the remainder is clipped), but each large onscreen object is immediately available by clicking and dragging to Blackspace or to another VDACC. Thus a number of large onscreen objects may be maintained onscreen and immediately available, without occupying a significant amount of display space.

5. Lock to VDACC. When an item, like a photo, is clipped into a VDACC where it fills the entire surface of the VDACC, it is not possible to click on just the VDACC, as there is no blank surface to click on since it is filled with an image, graphic, picture or video. In this case, a user can right click on the item filling the VDACC and in the Info Canvas for that item (see the section entitled “Info Canvas” below) and select “Lock to VDACC”. This will lock the item to the VDACC so that the user can then click on the item and move both the item and the VDACC. This prevents the pulling of the item from the VDACC.

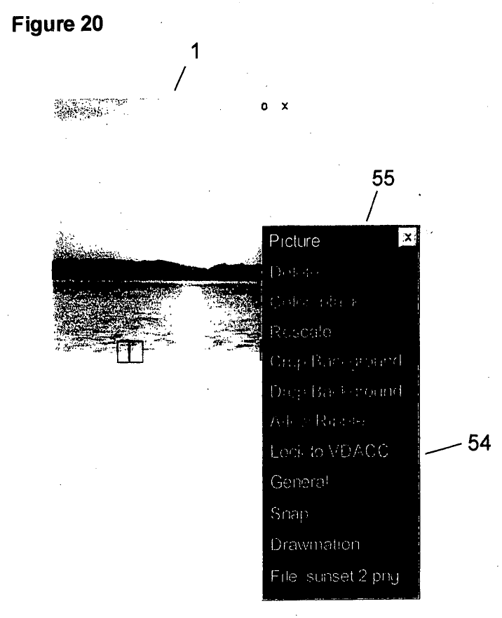

FIG. 20 depicts the locking of an object to a VDACC. In FIG. 20, a VDACC 1 has a picture clipped into it such that the picture fills entire visible area of the VDACC. With this condition, if a user left-clicks on the picture and drags, the picture will be moved not the VDACC 1. If it is desired to be able to move a VDACC by directly left-clicking on any object that completely fills the VDACC's visible area, the Info Canvas entry “Lock to VDACC” can be used for that picture. To use this entry, the picture is right-clicked to open an Info Canvas 55 for the picture. In this Info Canvas 55, the entry “Lock to VDACC” 54 is selected. This will lock the specified item to the VDACC 1 so that the user can then click on the item and move both the item and the VDACC. This prevents the pulling of the item from the VDACC 1 and enables the VDACC to be moved by simply left-clicking on the picture and dragging away.

6. Duplicating a VDACC. Any VDACC may be duplicated by various methods, such as clicking on the VDACC and holding for a prescribed time, e.g., one second, and then dragging away the duplicate to a new location. The original VDACC remains unchanged, and the duplicate has every item that is contained in the original VDACC, including all assignments, connections, and relationships associated with the VDACC and the items thereon.

7. VDACCs may be nested, one within the other, to any depth. But unlike prior art nesting of folders, all nested VDACCs on VDACCs can remain visible and immediately accessible without double clicking to enter a hierarchical nested tree. This feature enables a user to create many varieties of storage arrangements, file structures, and the like.

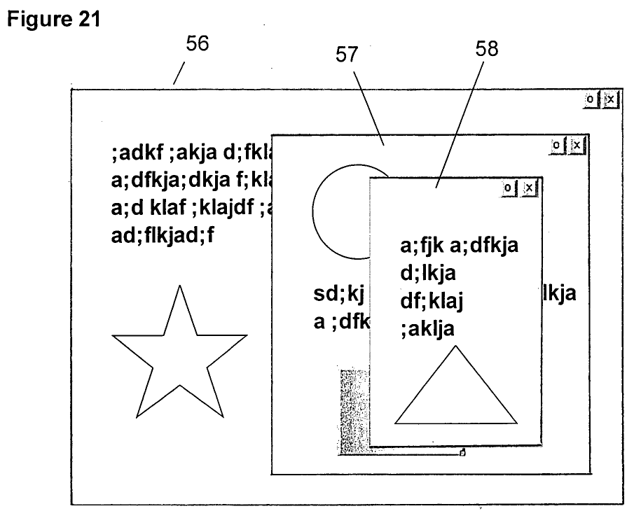

FIG. 21 depicts the nesting and layering function of VDACCs. In FIG. 21, multiple VDACCs 56, 57 and 58 are shown nested within other VDACCs, each containing their own diverse set of objects. The VDACC 56 has the VDACC 57 nested within it its borders and the VDACC 58 is nested within the borders of the VDACC 57. These VDACCs 56, 57 and 58 may be nested, one within the other, to any depth. All nested VDACCs on VDACCs can remain visible and immediately accessible without having to enter a hierarchical nested tree. This feature enables a user to create many varieties of storage arrangements, file structures, and the like using VDACCs.

8. The placement of items in VDACCs and/or in Blackspace does not need to be according to file, object type or program source. Any VDACC may contain any combination of any type of file or object that the system is capable of handling. A VDACC is in one aspect a portable container for blackspace, and the Blackspace within a VDACC is capable of accepting user inputs, recognizing and recalling objects and their associations and actions, and carrying out whatever actions and functions that the user directs.

E. Layering.

This topic was discussed with VDACCS in the previous section D.

F. Info Canvas.

Another important tool of the universal tool set is an Info Canvas (termed “Info Window” in some antecedent patent applications, but hereinafter “Info Canvas.”). As stated previously, in Blackspace, there are no windows, no menus and no user file lists as exist in conventional software. In Blackspace, there are only graphical objects that exist in a single drawing surface or environment. The management of these graphical objects is in the hands of each user, not programmers.

The management of extremely complex graphic data is made easy for users by the existence of VDACCs and their interaction with Blackspace. A further embodiment of a VDACC is used to create another structure called the Info Canvas. Info Canvases are comprised of a collection of VDACCs.

F-1. Two elements of an Info Canvas. Info Canvases have two basic elements. These are: (1) a Container VDACC and (2) one or more information VDACCs (IVDACCs), each with an action assigned to it via an invisible identifier.

A “Container” VDACC is a VDACC that has a simple snap-to function added to it to manage objects within it. Each entry that appears in an Info Canvas is an IVDACC (VDACC in an Info Canvas). IVDACCs are managed in a Container VDACC so that they appear organized in a fashion that emulates data in a window. But unlike data in a window, the list of IVDACCs can be reordered by the user. Furthermore, any one or more IVDACCs can be removed from the Container VDACC and operated outside of the Container VDACC. In addition, any IVDACC can be duplicated and placed and operated anywhere in Blackspace (except in another Container VDACC for another object).

Users can decide which IVDACCs are present in an Info Canvas and which are not. Users can also decide the order of the IVDACCs in an Info Canvas. In addition, users can change the labels for the IVDACCs in an Info Canvas to different text, or replace the text altogether with graphic objects.

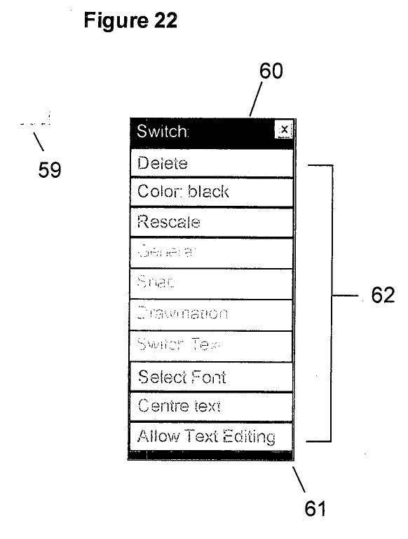

FIG. 22 illustrates the information container structure of Info Canvases. In FIG. 22, an Info Canvas with its Container VDACC 60 is shown. This Info Canvas belongs to a blank switch 59. This Info Canvas is made to appear onscreen by right-clicking on the switch 59. Upon this action, the Info Canvas of the switch 59 appears. As typically is the case with Info Canvases, the top most label is yellow. It indicates the object to which the Info Canvas belongs. In this case it is a switch, the switch 50. At the bottom right corner of the Info Canvas is the resize button 61, which is yellow, consistent with the label for this Info Canvas. The Info Canvas Container VDACC 60 with its yellow label and yellow resize button 61 holds 12 information VDACCs or IVDACCS each of which are either entries or categories of other functions that can be activated. Each entry can be in an activated state that is colored green, or, inactive, colored gray. Each category button is the color silver and when right-clicked all of the IVDACCs assigned to it appear.

F-2. Invisible IVDACC identifiers. An IVDACC can have a virtually infinite variety of labels applied to it without changing its functionality or action. There is no need for the software to learn how to recognize any label in any IVDACC. These labels can literally be anything. The labels can be characters in any language, pictures, hand drawn sketches, recognized objects, or any graphic object. What the user sees as the IVDACC is the label. This label is customizable by a user without ever changing the functionality of the IVDACC, because the IVDACC's functionality is not in its label. The functionality is in an invisible identifier attached to that IVDACC.

Whenever an IVDACC is created, it is given an invisible designator or identifier. This identifier signature stays with this object until it is deleted from the software by a user. This identifier is also copied when a user duplicates an IVDACC. Furthermore, individual IVDACCs can be removed from their Info Canvases (from the Container VDACC of that Info Canvas) and still retain their identifier and their functionality. In addition, when these IVDACCs are pulled from their container VDACC, the container VDACC is updated to “know” where the IVDACCs are, so that the IVDACCs can reappear in this new location when the Info Canvas reappears. Note: The Info Canvas for an object appears when a user right-clicks on that object. Right-clicking on an object toggles the Info Canvas for that object from being onscreen and not being onscreen.

The invisible identifier is not a drawing component. It is the definition of what the action is for the IVDACC. In other words, it is what happens when a user activates an IVDACC in an Info Canvas by any suitable means. As an example, every Info Canvas that has, for instance, the entry “Always Under” in it, has this function assigned to one of the Info Canvas IVDACCs via an invisible identifier. But each IVDACC in each different Info Canvas is different. This is because there is an additional piece of information that is added to this invisible IVDACC identifier.

This additional information is the object that the IVDACC belongs to. Stated another way, this additional information is the object on which the IVDACC's actions are performed. To summarize this point, the invisible identifier for every IVDACC in this software has three parts.
(1) The identifier name
(2) The function or action of that IVDACC—namely, the thing that happens when this IVDACC is clicked on.
(3) The object on which the IVDACC's action(s) are performed.

To further illustrate, let's say we have an Info Canvas for a switch. The Info Canvas includes a number of IVDACCs, such as an “Invisible” IVDACC. For each invisible identifier of the IVDACCs in the Info Canvas, the identifier would include the three parts listed above. Let's take the invisible identifier of the “Invisible” IVDACC as an example. Number 1 above would be the name of the identifier. Number 2 above would be the action of making the switch that belongs to this Info Canvas become invisible. Number 3 above is the switch, the object on which the action of this IVDACC is performed.

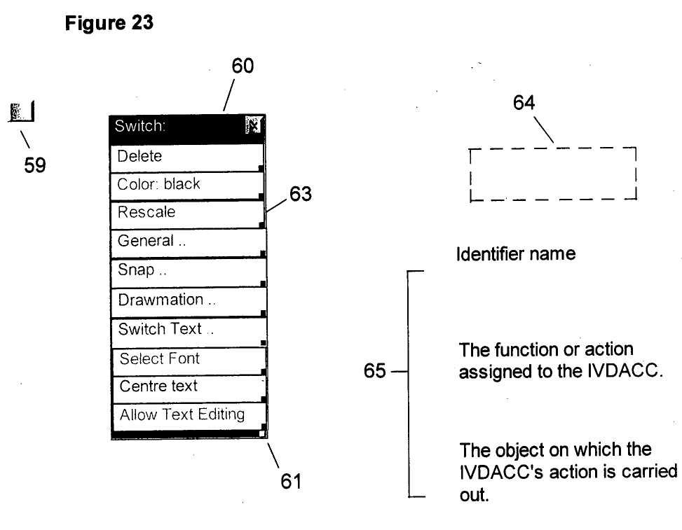

FIG. 23 depicts the three elements of the Invisible Identifier for an IVDACC. FIG. 23 shows a Container VDACC 60. Within the Container VDACC 60 are various entries and categories that make up the Info Canvas for a switch 59. Each IVDACC in an Info Canvas has an invisible identifier assigned to it. While the label given to an IVDACC can be modified to meet the needs of the user, the functionality of each and every IVDACC is defined by an invisible identifier 64. A unique invisible identifier stays with each IVDACC until it is deleted from the software by a user. In FIG. 23, the rectangle drawn with dashed lines refers to the “Invisible Identifier” 64 for a IVDACC. There are three elements 65 for each Invisible Identifier. The three elements 65 are: the specific VDACC to which the IVDACC is assigned, the function or action assigned to the IVDACC, and the object on which the IVDACC's actions are carried out. The text label for an IVDACC has no function or action assigned to it. It is merely a text label that can be retyped or replaced with a graphic. Changes made to an IVDACC label will not affect the function assigned to that IVDACC. So the IVDACC label can be in any language, use any graphic, sketch, picture, etc. This label can be deleted and the functionality will remain for the IVDACC. The function or action that is carried out when an IVDACC is actuated by some method, e.g., left-clicking on its label, a verbal command, etc., remains assigned to the invisible identifier that is unique to that IVDACC.

F-3. There are Info Canvases for Info Canvas IVDACCs. Like a VDACC, an IVDACC is an object manager, managing one or more objects that exist in global Blackspace. It also owns a data object referred to as a graphic linker. This graphic linker manages all of the objects within an IVDACC, e.g., text, graphics, pictures, or drawings, etc. In addition, the Info Canvas also manages something else, which is an action or function specifically assigned to it.

All objects, devices, pictures, video or music in Blackspace have their own Info Canvases. Let's take a blank switch. To see the Info Canvas for this object, a user would right-click on the blank switch and its Info Canvas would appear. But an Info Canvas also exists for each of the IVDACCs in this Info Canvas for the switch. This Info Canvas for an Info Canvas is referred to as a secondary Info Canvas. Let's take the IVDACC with the function “invisible” assigned to it. If a user right-clicks on this IVDACC, an Info Canvas will appear that is dedicated only to that IVDACC. This secondary Info Canvas is used to select functions that affect only this IVDACC, like “delete”, “allow label editing”, or “hide when clicked”.

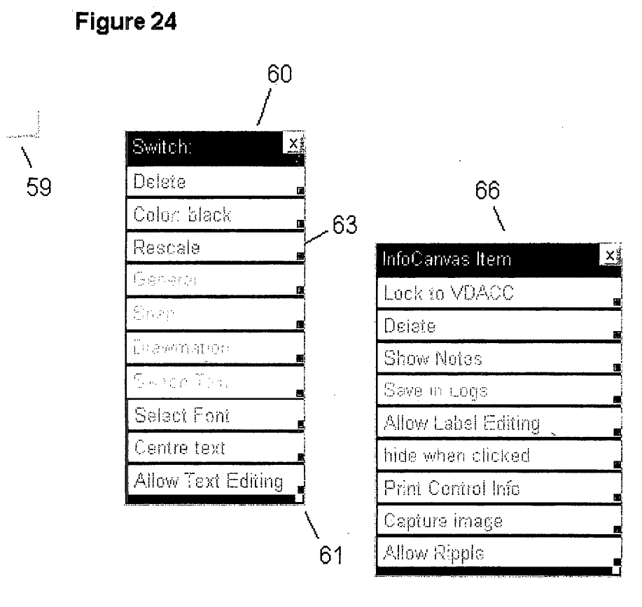

FIG. 24 depicts a secondary Info Canvas 66 for a Primary Info Canvas 60 for a switch 59. The secondary Info Canvas 66 as shown was made visible onscreen by right-clicking on the entry Rescale 63. Each IVDACC in an Info Canvas has its own secondary Info Canvas. In this secondary Info Canvas are functions that apply only to the IVDACC that was right-click on, which is in this case “Rescale.” One noteworthy entry in this secondary Info Canvas is Show Notes. The Primary Info Canvas has this same entry, which enables a user to have a notepad for every Info Canvas for every object in Blackspace. But every IVDACC in every Info Canvas also has its own notepad. This notepad is a VDACC. As a VDACC, it's more than a notepad. It permits a user to place anything into it that can be placed into a VDACC, namely, text, graphics, pictures, sound files, Drawmation, devices, video, etc.

Another noteworthy entry in a secondary Info Canvas is “Hide when clicked.” This entry enables a user to decide whether an Info Canvas will disappear after an IVDACC's function or action has been turned on or off. If “Hide when clicked” is on for a particular IVDACC, then activating that IVDACC's function, e.g., by left-clicking on its label or by verbal command, etc., will cause the Info Canvas that this IVDACC belongs to disappear. If “Hide when clicked” is off, the result will be the opposite.

Still another noteworthy IVDACC in a secondary Info Canvas is “Lock to VDACC.” In reality this entry when turned on, locks the IVDACC that belongs to the secondary Info Canvas containing this entry, to the Container VDACC that it resides in. This container VDACC could be the primary Info Canvas or it could be a category or subcategory in the same Info Canvas.

Summary of Key Features of an Info Canvas: An Info Canvas is not a window in as much as it does not have a structure that cannot be changed. The Info Canvas is made up of individual IVDACCs. The Info Canvas is highly customizable tool for managing other objects and their functions. The customization of the Info Canvas includes its ability to reorder its IVDACCS, change the text labels for its VDACCs, replacing VDACC text labels with graphics, delete or duplicate any individual IVDACC in an Info Canvas, remove any individual IVDACC in an Info Canvas and operating it external to the Info Canvas from which it was removed, and change the size of an IVDACC, modify the behavior or characteristics of any individual IVDACC by making one or more selections in the secondary Info Canvas for that IVDACC.

F-4. The basic operation of an Info Canvas. Every onscreen object has an Info Canvas associated with it that provides access to data and control functions pertaining to its respective onscreen object. Data for the onscreen object may include Name, Color, Assignment, and Show Notes, among other features. Control functions for the onscreen object may include items such as Delete, Select Font, Move/Copy/Lock, Snap-To, Prevent Assignment, Rescale and Glue, among other items. The user may click on any control function to access it and thus alter any function of the respective onscreen object whose Info Canvas is being modified. Likewise, the content of any Info Canvas may be user-modified by adding or deleting items. The Info Canvas of any onscreen object (plus the Info Canvas for Blackspace itself) is accessed by placing the cursor on the object and right-clicking (or double clicking, or the equivalent) to cause the Info Canvas to appear adjacent to its respective object.

F-5. The structure of an Info Canvas. The Info Canvas is not a window. It is a collection of IVDACCs within another VDACC called the Container VDACC. Thus an Info Canvas is comprised of a Container VDACC and one or more individual IVDACCs which snap to locations inside the container VDACC. Each IVDACC has all the properties and characteristics of VDACCs as enumerated above.

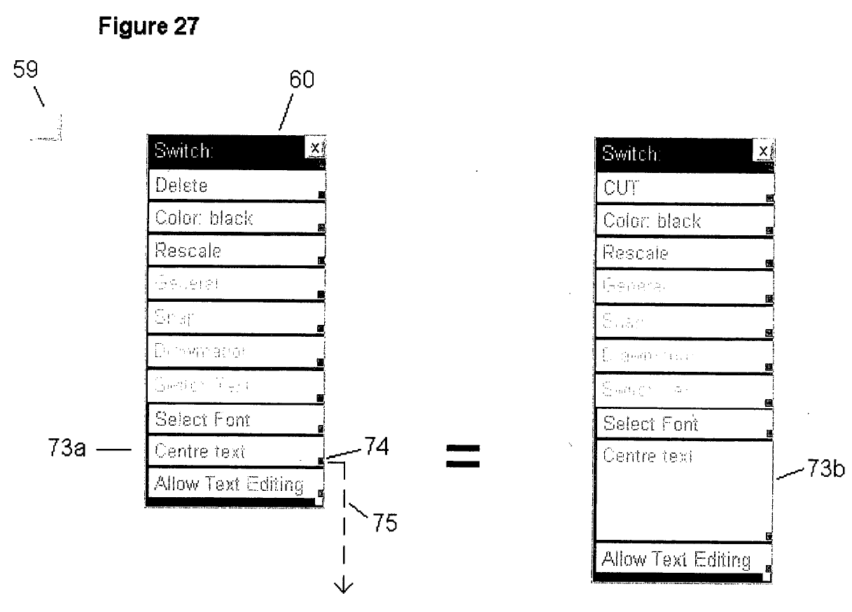

FIG. 27 depicts the resizing of an individual IVDACC 73a in an Info Canvas 60. To accomplish this, the resize button 74 for this IVDACC is clicked on and dragged downwards along path 75. This results in increasing the vertical size of the IVDACC 73a, which is shown as 73b. The purpose of resizing an IVDACC in an Info Canvas is to open up space to draw, type, place pictures and the like into this IVDACC.

F-5-A. Container VDACC. A Container VDACC is a special VDACC having a special property. This property is that a Container VDACC joins together all the IVDACCs that comprise an Info Canvas. Every IVDACC joined to the Container VDACC is assigned an invisible identifier that identifies it as a unique object associated with the Container VDACC. Every IVDACC within the Container VDACC has a function that has been assigned to it and can be actuated by either touching or clicking the IVDACC or its label.

F-5-B. The IVDACC. Each IVDACC is a fully operational VDACC that sits inside the Container VDACC of an Info Canvas. Each IVDACC has a function assigned to it via an invisible designator. The text label for each IVDACC is only for the purpose of user customization of the IVDACC. In other words, the label for each IVDACC does not carry or cause the action assigned to the IVDACC to be carried out. This belongs to its invisible designator.

In an Info Canvas, the individual IVDACCs and the Container VDACC may or may not be set to stack in a vertical column. For instance, the IVDACCs could be stacked in a horizontal row or not stacked at all, but exist as separate IVDACCs outside of the Container VDACC. There are various types of IVDACCs in an Info Canvas: (1) A Category IVDACC, (2) an Entry IVDACC, and (3) a Sub-category IVDACC. Category and Sub-category IVDACCs are generally differentiated from Entry IVDACCs in two ways: (1) their text label is a different color from the text label of an entry IVDACC, and (2) they behave differently when they are actuated. Regarding the first point, any graphic, drawing or picture could also be used for any Category IVDACC or entry IVDACC, so the differentiation possibilities are endless and totally up to the user. As an example, a lighter text color can be used to differentiate the Category IVDACCs from the Entry IVDACCs. Regarding the second point, when a Category or Sub-Category IVDACC is actuated, this results in the appearance of a collection of entries that are assigned to that category or sub-category. Category and Sub-Category IVDACCs do not have functions or actions assigned to them, only collections of Info Canvas entries.

Category IVDACCs. Category IVDACCs are themselves Container VDACCs, which have Sub-Category and Entry IVDACCs contained within them, just as the Category IVDACCs are contained within the main Container VDACC of an Info Canvas.

Sub-Category IVDACCs. A Category IVDACC can contain both Sub-Category IVDACCs and Entry IVDACCs. Sub-category IVDACCs are IVDACCs that are themselves container VDACCs but belong as part of a Category IVDACC. When a Sub-category IVDACC is actuated (e.g., left-clicked on) the Entry IVDACCs that belong to it appear under it or next to it or anywhere onscreen where a user desires.

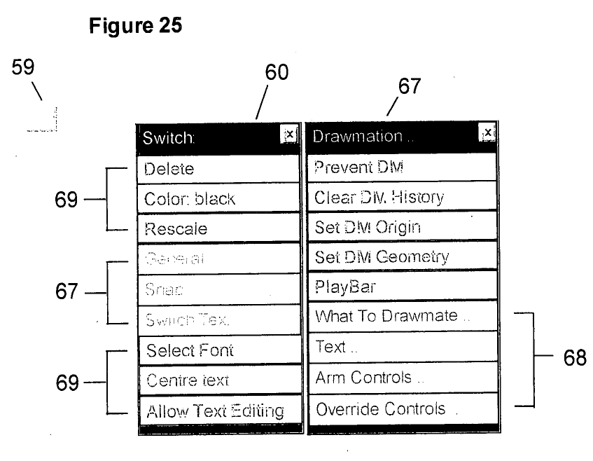

FIG. 25 depicts various types of IVDACCs in an Info Canvas. These include Entry IVDACCs 69, such as Delete, Color and Rescale, as well as, Select Font, Enter Text and Editing. FIG. 25 also shows Category IVDACCs, such as General, Snap and Switch Text. When a Category IVDACC is activated, e.g., by left-clicking on it, the Category IVDACC can slide to the right with all of the IVDACCs that belong to it appearing under it. This is illustrated with the Category “Drawmation” IVDACC. In FIG. 25, the IVDACCs belonging to the Category Drawmation IVDACC 67 appear directly under it. Also shown in this figure are Sub-categories IVDACCs 68. These are generally the color turquoise. Color is the visual identifier for being able to distinguish between entries (gray), categories (silver) and sub-categories (turquoise).

F-5-B1. Replacing an IVDACC label by typing or drawing new text. The text label of an IVDACC may be changed by typing new text. There is a special property here regarding the text labels of IVDACCs. When the Text Mode is on, left-clicking in Blackspace places a text cursor, but a user must be able to operate any IVDACC when in the text mode. Therefore the text on each IVDACC is “immune” from having a text cursor placed into it. Instead, when left-clicking on text in any IVDACC, the action associated with that IVDACC is either activated or deactivated. If a user wishes to customize this IVDACC text label, e.g., type new text, the Info Canvas for this IVDACC is used. To get this Info Canvas onscreen, the IVDACC is right-clicked on and its Info Canvas appears. In this secondary Info Canvas is a collection of IVDACCs that enable a user to modify the behavior of the IVDACC that was right-clicked on to display this secondary Info Canvas. The entry “Allow Text Editing” is activated and this permits the placement of a text cursor into the text label for that IVDACC.

For example, let's say a user wishes to change the text for the IVDACC “Delete.” The IVDACC “Delete” is right-clicked on, and in the secondary Info Canvas for that IVDACC, the entry “Allow Text Editing” is activated by left-clicking (or its equivalent) on this entry. Then a text cursor can be placed into the text label for this IVDACC by turning on a text switch and left-clicking anywhere on the text label of this IVDACC. Finally, new text can be typed to change the IVDACC label.

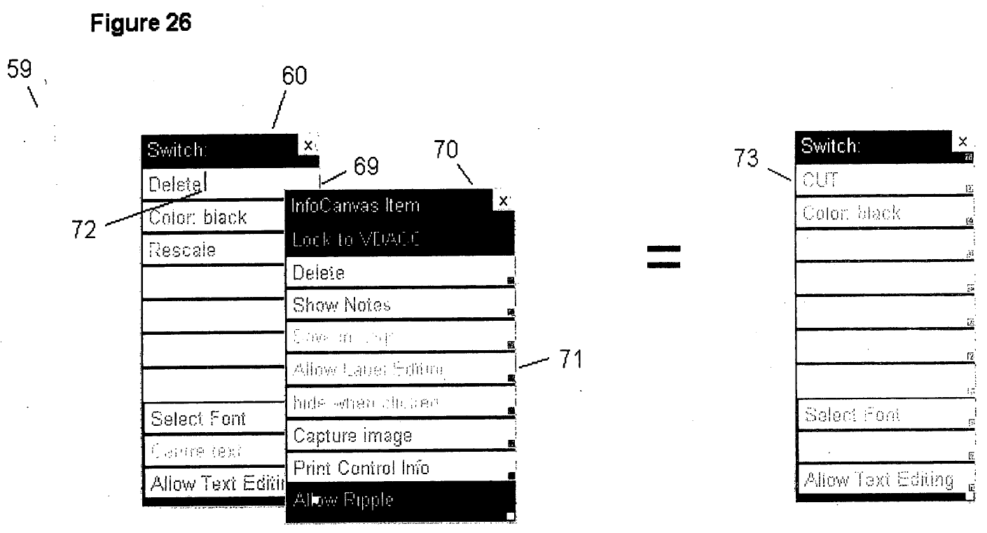

FIG. 26 illustrates the replacement of an IVDACC text label with different text. In FIG. 26, a switch 59 has been right-clicked on to see its Info Canvas 60. The IVDACC 69 is right-clicked on to make its secondary Info Canvas 70 appear onscreen. In this secondary Info Canvas 70, the entry Allow Label Editing 71, is turned on. Note when any entry in an Info Canvas is turned on, it becomes green. Then a text cursor 72 is placed into the text label “Delete” of the IVDACC 69. To type text to replace this text requires deleting the text that is there. There are various ways to do this that are common practices. For instance, one could use the backspace key, the delete key or drag through the text to highlight it and then type new text to replace it. Once the text is deleted, new text is typed to replace the existing text label. This text could be anything in any language, using any characters that can be typed on a computer keyboard or input in any means. The result of this procedure is shown as new text “CUT” 73 for the IVDACC 69.

An example of a collection of IVDACC functions is shown below:
Delete—this enables a user to delete any individual IVDACC that exists in an Info Canvas.
Show Notes—This enables a user to type notes that are associated with an individual IVDACC in an Info Canvas.
Save in Logs—This enables any change made in this IVDACC to be saved to a file that we call a log. A log is defined as a snapshot of the system state. A log saves complete definitions of every control in the system. It contains sufficient information to recreate all of these controls and the state of all the contexts in Blackspace
Revert to Original—This enables a user to eliminate any customization that has been added to an IVDACC and have the IVDACC appear as it did in its default state, before it was customized.
Allow Label Editing—The enables a user to retype the text label for the IVDACC. This could be in any language, e.g., French, Italian, German, Chinese, etc. Since the label does not control the IVDACC's function, any text can be typed. It is purely for the user's benefit. In addition, activating this function for any IVDACC in any Info Canvas, enables a user to replace that text with one or more graphic objects, pictures, and even video.
Hide When Clicked—This determines whether the IVDACC will remain visible after it has been clicked on to either activate or deactivate its assigned function or action. If “Hide when clicked” is off, then when a user clicks on this IVDACC, it will remain visible after its action has been turned on or off (activated or deactivated). If “Hide when clicked” is on, then the IVDACC will promptly disappear when it has been clicked on.
Capture Image—This enables a user to save the IVDACC and its customizations as a picture file, whether .bmp, .png or other format. Each of these IVDACC functions, as just shown above, is managed by a third level Info Canvas. Each of these tertiary Info Canvases includes a list of functions. This list of function or actions found in these Info Canvases is the same as the list shown above.

F-5-B2. Replacing an IVDACC label with a graphic. The text label of an IVDACC may be changed to any form that the user desires to use to represent its content. This feature provides for a high degree of user customization by allowing the user to take any onscreen object, drawing, sketch, or picture and use it as a representative for the function that an individual Info Canvas IVDACC is designated to carry out. Since each IVDACC in an Info Canvas has its own unique invisible identifier assigned to it, the invisible identifier conveys the action or function of the VDACC, and any change in the label is purely for the benefit of the user without affecting the functionality of the VDACC.

The following is a description of the steps to replace a text label for an IVDACC.

1. Any picture, sketch, drawing, device, composite glued object or the like may be created by a user and dragged onto an IVDACC; that is, on top of, overlapping a portion of, or within a minimum proximity of the IVDACC label text.

2. The dragged item is then glued to the text label on the IVDACC. This can be done by lassoing both the dragged item and the IVDACC text label to select them both and then select “glue” in the Info Canvas for the dragged item. This will glue the two together.

“Glue” is a type of grouping function in Blackspace. This gluing together of a dragged graphic and a text label for an IVDACC results in the IVDACC text label disappearing and the dragged item being fixed at the position to which it was dragged. Optionally, a status perimeter may appear circumscribing the glued graphic item. This perimeter typically is formed in either of two colors to indicate the on/off status of the function or action associated with the graphic item; e.g., green indicates ON, and gray indicates OFF. To operate this graphic replacement for a text IVDACC label, a user clicks on the graphic that has replaced a text label (which would normally change its color to green to indicate its being on and to gray to indicate its being off), a green outline appears around the graphic to indicate that it has been turned on. If it was already on (already had a green outline around it), then it will turn gray when it is clicked on to indicate that it is off.

Notwithstanding all that has been stated above regarding the limitations of existing computer onscreen menus and task bars, any user of the present invention may construct menu and task bar equivalents using VDACCs and/or IVDACCs that are maintained or recalled onscreen, as desired. Likewise, although the use of arrow logics is introduced to simplify the establishment of associations and functional relationships between onscreen objects, the user may employ VDACCs as menus and task bars in the prior art mode to achieve the same results as arrow logics of the present invention.

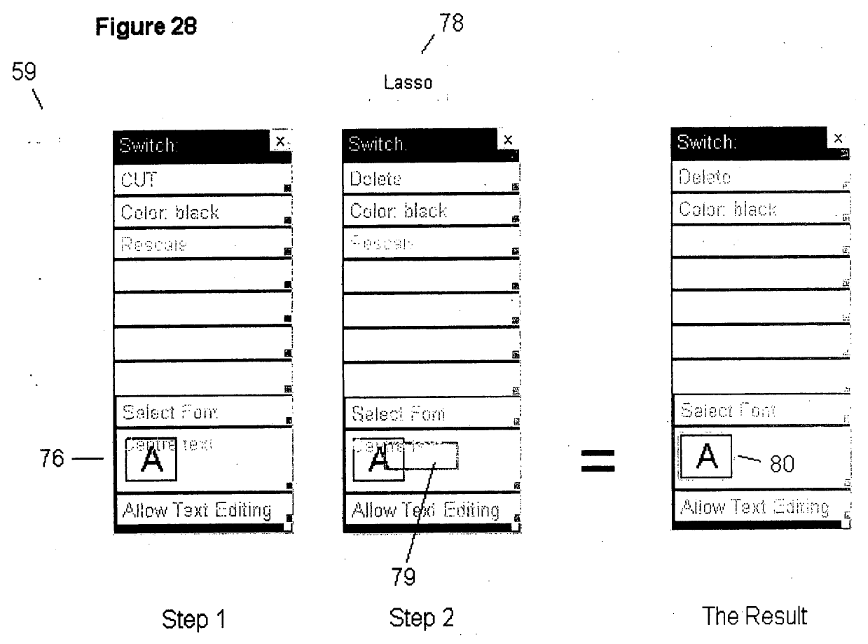

FIG. 28 depicts the replacement of an existing IVDACC text label with a hand drawn graphic. In step one, a hand drawn graphic 76 is dragged to overlap the text label “Center text”. In step two, a lasso rectangle 79 is drawn to intersect both the “Center Text” label and the hand drawn graphic 76. This lasso selects both the original text label and the dragged hand drawn graphic. Then the hand drawn graphic is right-clicked on to make its Info Canvas appear. In this Info Canvas, the entry “Glue” is activated. When the entry “Glue” is activated the following will occur:
(a) The Info Canvas will disappear.
(b) The green text, “Center Text”, will disappear.
(c) The hand drawn graphic will be moved to the top left of the IVDACC
(d) The hand drawn graphic 76 will automatically have a rectangle added to its perimeter.
(e) The color of this rectangle will be green because the original entry in this IVDACC (“Center Text”) was green (on).

This replacement graphic for the IVDACC “Center Text”; will now act as an on-off switch for selecting the function “Center Text”. One way of operating this would be to left-click on the graphic once to turn it on and again to turn it off. When the entry “Center Text” is on, the perimeter rectangle 80 turns green. When this entry is off, the perimeter rectangle 80 turns gray.

F-5-B3. Agglomeration of objects to an IVDACC. The fact that any item placed on a VDACC is agglomerated to that VDACC has been previously mentioned. An IVDACC has the same property. Therefore, anything placed or created on an IVDACC will remain agglomerated to that IVDACC until that item is removed by a user. Therefore, users can draw recognized objects, sketches, notes, type text, or place pictures on any IVDACC in the Container VDACC of an Info Canvas. The ability to do this has many advantages. For instance, a user can create annotations or instructions pertaining to any IVDACC in any Info Canvas for purposes of illustration, explanation, reminders, etc. Furthermore, devices, like knobs, faders and switches can be placed in any IVDACC and used to control anything that can be controlled through links created by the drawing of arrows or the like. (See pending U.S. patent application Ser. No. 09/880,397)

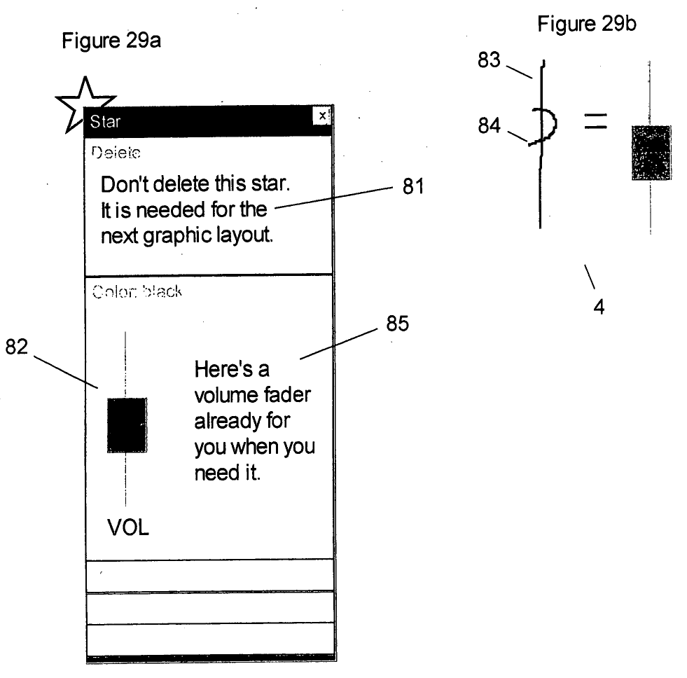

FIG. 29a depicts the integrated use of IVDACCs in advanced labeling. In FIG. 29a, text 81 is added to a Delete IVDACC. To add text to this IVDACC, the user turns on the Text Switch or the Text Edit Switch and then left-clicks into the IVDACC into which the user wishes to type text. Then the user types the text as desired. Also in FIG. 29a, a fader 82 and text 85 are added to a Color IVDACC. To draw a fader in an IVDACC, turn on the RDraw switch, which activates the Draw Mode, then draw a fader which consists of a vertical stroke followed by an arch stroke that intersects the line drawn by the vertical stroke, as illustrated in FIG. 29b. Note, the placement of text, objects, graphics, pictures, devices, audio, etc., into any IVDACC can be done directly. These actions do not require making a selection in a secondary Info Canvas.

FIG. 29b shows that the user can create a fader first by activating the RDraw switch that activates the Draw Mode in Blackspace 4. In this mode the user can then hand draw a vertical line (83) followed by a horizontal arch stroke intersecting the vertical line (84). Upon the upstroke of the drawing of the arch, the fader will be recognized. The fader can now be added to any IVDACC.

F-6. Manipulating IVDACCs of an Info Canvas. The IVDACCs of an Info Canvas can be user manipulated to make duplicates of any IVDACC, to remove any IVDACC from the Info Canvas, to change the order of the IVDACCs in the Info Canvas, among others.

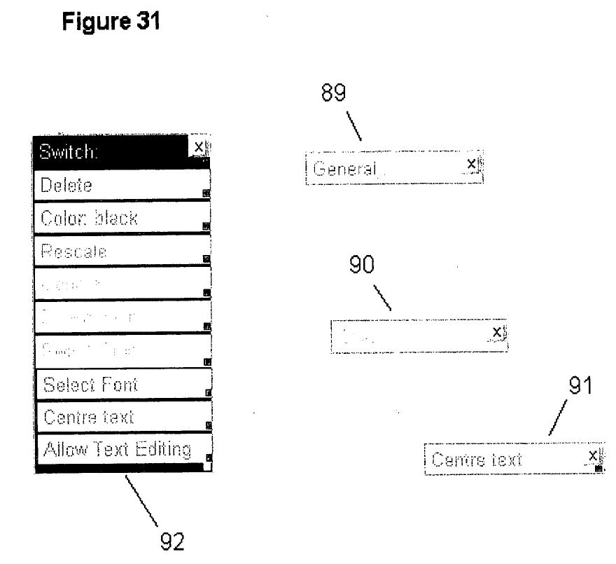

FIG. 31 illustrates the removal of an IVDACC from its Info Canvas and the duplication of two IVDACCs and their removal from their Info Canvas. IVDACCs do not have to be operated from within the Info Canvas to which they belong. IVDACCs can be pulled from their respective Info Canvases and dragged to any location in Blackspace and they can then be fully operated in their new location. Each IVDACC has as part of its object definition, the Info Canvas that it belongs to and it cannot be placed back into any other Info Canvas.

In FIG. 31, an IVDACC 89 has been duplicated and removed from its Info Canvas 92. Notice that the original General IVDACC still remains in the Info Canvas 92. In addition, an IVDACC “Snap” 90 has been removed without being duplicated from the Info Canvas 92. Notice that the category Snap no longer exists in the Info canvas 92. The entry 91, Center Text, has also been duplicated and removed from the Info Canvas 92. When you duplicate an IVDACC, the on/off status of that IVDACC is transferred to its duplicate. Notice that the Center text IVDACC in the Info Canvas 92 and its duplicated 91 are both on.

IVDACCs can be removed or duplicated and removed from any Info Canvas. The Info Canvas can remain visible or it can be deleted from being onscreen. In either event, the duplicated IVDACC that was removed from the Info Canvas will remain fully operational.

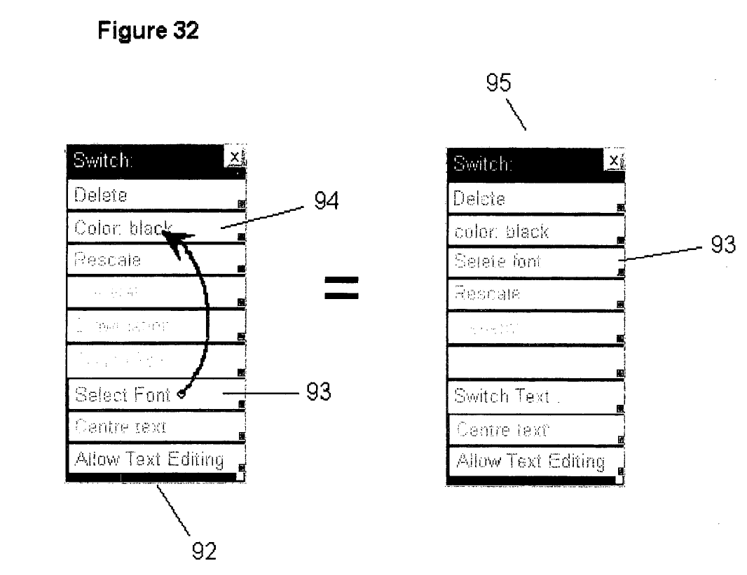

FIG. 32 illustrates the reordering of an IVDACC in an Info Canvas. In FIG. 32, an IVDACC 93 is dragged upward until its upper edge overlaps the IVDACC that it is desired to be inserted under. Then on the mouse up-click the IVDACC 93 snaps back into the Info Canvas 92 in its new location, under an IVDACC 94. When one IVDACC is dragged over another IVDACC, the IVDACC being dragged over can have its perimeter line change color. This can designate to the user that this is the IVDACC that the IVDACC being dragged will snap under in the Info Canvas.

F-7. Info Canvas Data Structures. The Info Canvas is the means whereby the user can control features and settings of objects in Blackspace. It can also display the status of settings in system objects. Nearly all objects in Blackspace have a predefined info canvas structure which can be customized by the user

An Info Canvas is comprised of a Container VDACC (Visual Design and Control Canvas) and various IVDACCs (Information VDACCs). There are two general types of IVDACCs in an Info Canvas: (1) category and sub-category IVDACCs, and (2) entry IVDACCs.

Category and sub-category IVDACCs can also function as container VDACCs in that they can have other IVDACCs placed into them. These include any IVDACC in a specific Info Canvas. Entry IVDACCs cannot have other IVDACCs placed into them, because they do not have the ability to act as a container VDACC.

When any object in Blackspace is right-clicked on, it's Info Canvas appears. There are other methods of calling forth an Info Canvas to appear onscreen. They include: verbal commands, touching a switch or other graphic device that has the action “show Info Canvas” assigned to it, drawing a graphic object that has the action “show Info Canvas” assigned to it, etc. The Info Canvas that first appears for any object is referred to as the Main Info Canvas or Primary Info Canvas. Right-clicking on any IVDACC in this Info Canvas calls forth a Secondary Info Canvas specifically for that IVDACC.

Info Canvases are examples of VDACCs with additional functionality. For example, the entry IVDACC is a VDACC with additional functionality. The Entry IVDACC has a functional name. An Info Canvas can search its list of Entry IVDACCs looking for entries with that name.

The entry IVDACC also contains a list of one or more operations which are performed when its label is clicked on. This list is in the form of the ID of an object in the system together with the name of a routine which that object can perform. This list is referred to as the “click receivers”.

A flag which dictates whether the master Info Canvas will be hidden after the designated action has been performed.

A reference is kept by both Info Canvases and IVDACCs to the Info Canvas which owns them. This is its immediate parent, not the master Info Canvas. This parent could be a category IVDACC or a sub-category IVDACC. This reference is not dependent on whether the IVDACC is graphically attached or not.

One graphic object is designated as the title item, the label for the Container VDACC. This is generally a text object, but it can also be any graphic or a photo. This is the object which when clicked on will cause specialized actions to take place.

A flag to indicate that automatic width setting according to the content should be ignored. Normally an item in an Info Canvas will set its width to be at least large enough to include all members of its graphic linker. This flag overrides that behavior.

Like a VDACC, an Info Canvas contains a graphic linker which lists all the graphic objects that belong to that Info Canvas. Accordingly, any graphic object that is typed, drawn, or placed into a category or sub-category IVDACC in an Info Canvas is controlled by the graphic linker of that Info Canvas. In addition the Info Canvas contains a list of the category, sub-category and entry IVDACCs which directly belong to it.

To summarize this point, the Primary Info Canvas, contains a graphic linker which lists all of the graphic objects that belong to it, and it contains another list of items which belong to the IC whether or not the items are graphically attached or snapped in. In this way IVDACCs can be combined in any combination to make a nested hierarchical structure.

Members of the Info Canvas which are in the graphic linker list have automatic geometry applied when the Info Canvas is shown on screen. The nature of this automatic geometry is to arrange such items in a vertical column where all the members have the same width.

Members which are in the Info Canvas list but not in the graphic linker are treated as independent objects for geometry calculations. They are not within the boundaries of the parent Info Canvas.

When an Info Canvas is first created for a graphic object (e.g., a star, a rectangle, a check mark, etc.), the main Info Canvas is designated as the master Info Canvas for that graphic object. A reference to this master Info Canvas is kept in the object which owns the Info Canvas. Details of this master Info Canvas become part of this object's definition.

Info Canvases have a flag to indicate whether their contents are visible or closed up. Info Canvases also have a flag to indicate that when they are “opened” their IVDACCs should pop-out to a new screen location rather than expanding downward within their parent Info Canvas. This latter flag does not operate in the “master” Info Canvas.

F-7-1. The Info Canvas is designed for maximum user customization. A user can place any IVDACC in an Info Canvas into any category or sub-category IVDACC. The order of IVDACCs and the nested order of IVDACCs in a given Info Canvas is user-definable. For all IVDACCs in an Info Canvas, whether that Info Canvas is a container VDACC, a category or sub-category, the order of the list of these IVDACCs can be changed, the placement of IVDACCs into different categories and sub-categories within the same Info Canvas is fully supported. This provides a very flexible architecture for users.

For instance, in a single Info Canvas, a user could drag the Lock sub-category out of the Info Canvas. Then the user could put the General category inside the Lock category. Then the user could put the Lock category inside the Snap category and so on. A user could place every IVDACC in an entire Info Canvas into a single category or sub-category IVDACC, where the user controls the order and placement of these category, sub-category and entry IVDACCs and determines what the fly-out behavior of these IVDACCs will be. This means that a category IVDACC and the IVDACCs that belong to it fly out to the side or directly below.

There are two limits on the restructuring of an Info Canvases by users. First a user cannot place any category or sub-category IVDACC into an entry IVDACC. Entry IVDACCs cannot act as container VDACCs, but category and sub-category IVDACCs can. Second, IVDACCs can be structured only within an Info Canvas for a specific object. It is not possible to take an IVDACC from an Info Canvas for object 1 and place it into the Info Canvas for object 2. This is because the system needs to preserve the controls for each graphic object as controls for that graphic object. Otherwise, the system could not be operated efficiently.

G. Contexts.

Contexts are another factor in the operation of Blackspace. Contexts affect the applications, functions or operations assigned to arrows and can determine and/or modify the types of actions, functions or operations that arrows will produce when drawn between objects in Blackspace.

H. Specifiers, Known Text and Equivalents

Specifiers are navigational tools in Blackspace. A Specifier is defined herein as a letter or short phrase that is typed or otherwise entered or input (e.g., spoken, drawn or printed) into Blackspace and identified with a category of saved files. For example, an “s” followed by the name of a sound file immediately calls forth that sound file to be displayed onscreen. Typing or inputting a “p” followed by the name of a picture will cause that picture to appear immediately in Blackspace. Typing a “v” followed by the name of a video will cause that video to appear in Blackspace. Typing a “dm” following by the name of a Drawmation will cause that Drawmation to appear in Blackspace.

Typing or inputting an “s” followed by Esc, Enter or its equivalent causes a Sound File Info Canvas to appear with a list of all sound files accessible by the software. Likewise, a “p” followed by Esc, Enter or the equivalent will display a Picture File Info Canvas listing all available picture files. Other specifiers may be provided, such as, but not limited to, L for Log file, D for Data file, and V for Video file, EV for event recordings.

One salient advantage of specifiers is that any item, folder, category, or the like may be immediately called forth without having to search for it. For example, typing “s car2.wav” in Blackspace immediately brings the sound “car2.wav” to Blackspace.

Another feature of specifiers is that they can be used to call forth folders that contain sound files, pictures, data, video, Drawmations, event recordings and the like. For instance, typing “p birds” will call forth the folder “birds”, which in turn can be accessed to see the list of bird pictures contained within it.

A further tool in the universal tool set is Known Text. In general, text that is input into Blackspace through typing, speaking, writing or importing is subject to recognition matching to a user-modifiable list of words. These words, termed Known Text, are defined as text that represents (commands) an action, function, or object. A user may type or otherwise enter a Known Text word to bring forth the action, function or object for that word. Examples of Known Text include Volume, EQ, Brightness, Play, Stop, Proportional, Transparency, among others. Thus, for example, if a user draws a switch onscreen and then types (or enters) the word Play on the switch, the switch becomes a play switch for any file capable of being played. The word Play is recognized as a Known Text term and the software both applies the term to the display of the switch and defines the function of that switch as starting and stopping the playing of a computer file (audio, video, sound, animations, among others).

Known text is an important element in user modification of the Info Canvas of an IVDACC or any other onscreen object. Placing a Known Text term in an Info Canvas causes the action, characteristic or parameter assigned to the Known Text term to be applied to the object to which the Info Canvas belongs. Thus a user may modify, add or delete actions, assignments, characteristics, or limitations to any IVDACC or other object.

All text that is not recognized as Known Text or Specifiers is treated as an onscreen object having the same properties as any other onscreen object. It is significant to note that as an object, a text block may be resized proportionally, so that the font size and spacing shrinks as the object is contracted, and increases as the object expands. Likewise, a text object within a VDACC is automatically resized proportionally (including font size and spacing) when the VDACC is resized in rescale mode.

A fundamental precept of the universal tools computer environment is that it deals with all onscreen objects in accordance with the contexts in which they appear. For example, if a user types or inputs “Volume” adjacent to an onscreen fader controller, the software recognizes that a volume control function is applicable to a fader controller, and thus connects the function to the fader, which becomes a volume control that is user-adjustable. Context is also analyzed and applied to arrow logic transactions so that, for example, a video control switch cannot be directed by arrow logic to control an audio file.

There are a myriad of contexts that are recognized and applied continuously by the software to provide an intuitive environment for user interaction with the various universal tools. As another example, a fader that is connected by an arrow logic command to an audio file becomes a volume control, whereas if that same fader were to be connected instead to a picture file, it would become a brightness control. Or, a fader that is connected by an arrow logic command to another controller becomes the master controller of the other controller. Thus the context in which the fader is used determines the function that the fader will be assigned.

Programming Devices in Blackspace With Known Text.

Context is applied to text inputs in at least two separate levels. A text label (such as “volume) may be interpreted to apply to an onscreen control device if the label is input within a defined distance from the control device, so that the control device becomes a volume controller. If the same text label were instead input elsewhere on the screen, the function is not applied to the control device. Thus a spatial or proximity context is critical in determining the association and control that is created by the user. On another level, a fader labeled as a volume control device may be directed by arrow logics or the like to control the files within a VDACC. Some of those files may be sound files, which will thereafter be volume-controlled by the fader. The other files (that are not sound files) will be unaffected by the fader actuation. This is an object identity context. All text in Blackspace is an object. If it is known text, then it has an additional identity. It's first identity is that it exists to the software as a text object, (as opposed to a picture object or a recognized graphic object), but it has a second identity which represents a known word that itself represents an action or function that can be applied to some object, device, picture, text, etc.

In a further example of an object identity context, an arrow that represents the logic “control what the arrow is drawn from with the object that the arrow is drawn to” that is drawn from one text object in a VDACC to another text object in another VDACC is a context which is recognized to mean that text will flow and autowrap from the one VDACC to the other. Another way of implementing this same feature is drawing the same arrow from a blank VDACC to another blank VDACC. This can also set the auto text wrap feature. In fact, arrows of this type can be draw from one VDACC to another VDACC and from that VDACC to still another and so on. The text will auto wrap from the first VDACC to the second VDACC, from the second VDACC to the third VDACC and so on.

The arrow logic can thus be used to link VDACCs. When a user draws a control arrow, e.g., a red arrow, between two VDACCs, this action is analyzed by the arrow logic system, and the software attempts to link the VDACCs. The linking from a first VDACC to a second VDACC will fail if the first VDACC is already linked to a third VDACC. That is, there is already a link from the first VDACC to the third VDACC. The linking will also fail if the second VDACC is linked in either direction to a third VDACC. That is, there is already link from the second VDACC to the third VDACC or from the third VDACC to the second VDACC.

When the VDACCs are linked, the VDACCs are added to a list of linked VDACCs. If the first VDACC was already linked, then the second VDACC is added to the end of that list. Otherwise, a new list is created. Scrolling in the first VDACC is disabled, since this could interfere with the text operation.

If a user wishes to link several VDACCs, the user must draw an arrow between each VDACC in the desired sequence. For each arrow drawn, the above procedure is followed. If the arrows are not drawn in sequence, the VDACCs will not be properly linked and text will not flow and autowrap from one VDACC to the other VDACCs.

Once two VDACCs are linked, the user can start to type text in the first VDACC. Every time the user edits the text, it's geometry is checked. When the text hits the bottom-right of the VDACC, it will wrap around to the top of the second VDACC, creating a new text control. Now, whenever, the user edits the text in the first VDACC, it will automatically wrap back and forth from the second VDACC as necessary. The user can also use the cursor keys (or mouse buttons) to move between the two VDACCs. If the second VDACC is linked to a third VDACC, the same thing will happen when the text in the second VDACC hits the bottom of that VDACC, and so on, continuing until the last VDACC in the chain is reached.

Another example of context relates to Specifiers described above. A “P” followed by the Enter key (or equivalent) entered in Blackspace calls forth a VDACC listing all available picture files, whereas the same keystroke combination entered into a text object would instead cause the entry of the character “P” in the text object.

Context is also a fundamental aspect of the recognition of arrow logics. For example, all onscreen objects that are substantially circumscribed by the tail of an arrow are recognized in this context as being involved in the transaction that is being carried out with the object or objects at the head of the arrow. Or, a curved arrow drawn in the context of partially circumscribing a knob controller may be recognized to indicate the direction of rotational increase for that controller. The same curved arrow, if drawn instead from a fader to an EQ, would be recognized by this context to comprise a volume controller that feeds its signal to the EQ control.

The context rules are provided to translate the user's inputs and requests into actions. There may be hundreds or thousands of context rules that govern the interactions of onscreen objects and files within the computer. These contexts are continually checked, a task that is no more computationally intensive that a prior art spell checker that checks words as they are typed. As a result, the software exhibits a broad “understanding” of the user inputs and creates an operating environment that is intuitive for the user.

Another fundamental precept of the universal tools computer environment is the use of equivalents. Any object within the environment may be directed to be an equivalent of any other object, no matter what file types these objects may be (photo, data, sound, video, email, graphic, picture, etc.). Thus the user can direct the software to substitute a user-defined object for a machine defined or default object, thereby enabling user customization on a small or grand scale, depending on the desires of the user. Files or functions may be represented by graphics, or client names may be equated with their photos so that clicking on the name calls forth the photo, and vice versa. There is an infinitude of customization opportunities available to the user. For example, a user may type or enter Draw=Art. Thereafter, whenever “ART” is entered, the software calls forth the draw function as the equivalent of Art. Any text entry in an Info Canvas may be set to be equivalent to a graphic or picture, whereafter the graphic or picture is portrayed in place of its text equivalent.

The synergistic effect of the universal tools of the invention is to enable a user to interact with a computer using primarily graphic, hand drawn inputs to the computer to achieve all the functionality that is presently provided by a prior art desktop computer, as well as further functions that are not presently available. The single, universal program accomplishes all tasks without resorting to separate application programs running under an operating system. There is no switching between programs to carry out different tasks such as text/word processing, drawing, audio play or editing, video play or editing, web access, data input or output, or the like. The concept of a “document” does not exist in the universal tools working environment; rather, objects or collections of objects and their associations and connections are saved whenever a VDACC is closed or an assignment is made to an object. In Blackspace, there is no programmed relationship between text in an IVDACC and the function or action assigned to that IVDACC. The text is totally under the control of the user and can be changed indiscriminately without the help of a programmer.

Various Operations of the Software for Blackspace

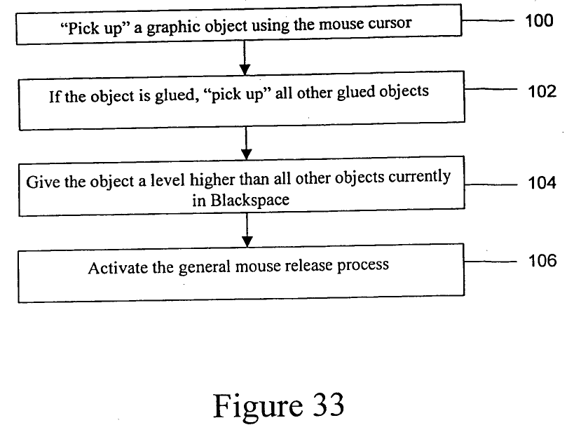

Various operations of the software for Blackspace with respect to VDACCs and IVDACC are now described with reference to flow diagrams of FIGS. 33-46.

Turning now to FIG. 33, a flow diagram for placing an object in a VDACC is shown. At block 100, a graphic object is “picked up” using the mouse cursor, if no drawing or typing mode is active. Next, at block 102, if the object is glued, then all other glued objects are “picked up” as well, since glued objects are considered to be a single graphic object. However, it is still the original object which is operated on by the mouse handling software. Next, at block 104, the object is given a level higher than all the other objects currently in Blackspace. This causes it to be drawn on top of those other objects if it is moved to intersect them. Next, at block 106, the general mouse release process is activated when the mouse is released.

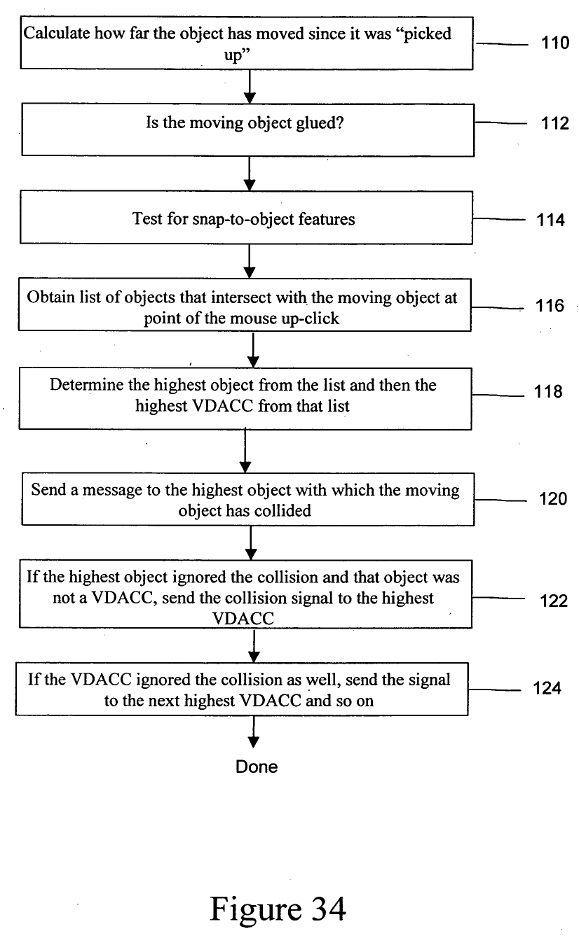

The general mouse release process is now described with reference to the flow diagram of FIG. 34. At block 110, how far the object has moved since it was picked up is calculated. When a user lets go of the mouse after dragging an object, the software immediately works out how far the object has been moved and saves this information as a vector. This is an important piece of information as it enables the object being dragged to snap back to its original position.

For example, if a user drags a password to an object to unlock it, upon the mouse up-click if the password is the correct password, it unlocks the object and then snaps back to its original position. The same thing happens when a password is dragged to an object to lock it in the first place.

Another example of this behavior is with objects in Drawmation (see simultaneously filed U.S. patent application Ser. No. ______, entitled “System and Method for Recording and Replaying Property Changes on Graphic Elements in a Computer Environment”, which is specifically incorporated by reference herein.). If a user records data for an object in Drawmation and wishes to see a play bar for that object, the object can be dragged to intersect a timeline. This action causes a play bar to be placed under the timeline and then on the mouse up-click the object snaps back to its original position.

Next, at block 112, a determination is made whether the moving object is glued. Next, at block 114, the object is tested for snap-to-object features.

Next, at block 116, a list of objects that intersect with the moving object at point of the mouse up-click is obtained. This list is obtained from the drawing software managing global Blackspace. It asks the drawing surface how many different objects occupy this place on the screen?

Next, at block 118, the highest object from the list, and then the highest VDACC from that list are determined. When the software gets a list of objects at that point, then it goes through and looks for the highest normal object and the highest VDACC. First the software polls the canvas (the global drawing surface) and says what objects am I intersecting? Ah there's a mother VDACC and a daughter VDACC. (a daughter VDACC is defined herein as the VDACC that is in another VDACC and a mother VDACC is defined herein as the VDACC that contains the daughter VDACC) Which is the highest? OK it's the daughter VDACC. Where's the graphic linker for that object? I'm joining this object's graphic linker.

Next, at block 120, a message is sent to the highest object with which that the moving object has collided. The receiving object can respond that either it has performed some operation as a result of that collision, or that it has ignored it.

Next, at block 122, if the highest object ignored the collision, and that object was not a VDACC itself, then the highest VDACC is sent the collision signal. This in turn can either accept or ignore the collision. An example of an object that would not be accepted when it collides with a VDACC or IVDACC would an object that has “prevent clipping” turned on in its Info Canvas. When such an object is dragged over a VDACC, it will not clip into the VDACC unless it is fully enclosed by that VDACC, therefore its collision with that VDACC will be ignored. Another example would be dragging an object, which has been converted to a password, to unlock an object that was locked with another password. The object being dragged will have its collision with the locked graphic object ignored, because it is the wrong password.

Next, at block 124, if the VDACC ignored the collision as well, then the signal is sent to the next lowest VDACC and so on until either the collision is accepted or there are no more VDACCs which intersect the moving object.

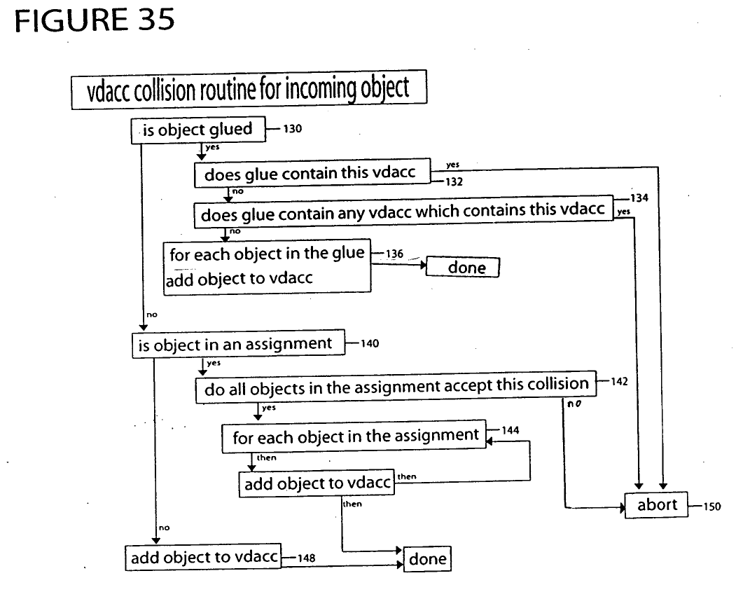

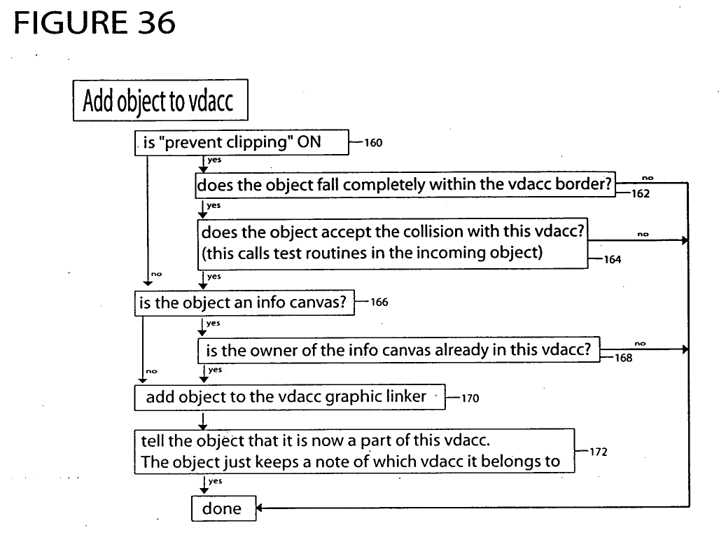

Turning now to FIG. 35, a flow diagram for performing a VDACC collision routine for incoming object. At block 130, a determination is made whether the incoming object is glued. If no, a determination is made whether the object is in an assignment, at block 140. If no, the object is added to the VDACC, at block 148, and the process is done. The process of adding an object to a VDACC is described below with respect to FIG. 36.

However, if at block 130, the object is determined to be glued, a determination is made whether the glue contains this VDACC. In other words, is the VDACC glued to this object? If yes, then the process is aborted, at block 150. If no, a determination is made whether the glue contains any VDACC, which in turn contains this VDACC, at block 134. If yes, the process is aborted. If no, each object in the glue is added to the VDACC, at step 136. That is, this adding step is repeated for all of the objects that are glued together and the process is done.

Referring again to block 140, if it is determined that the object is in an assignment, then a determination is made whether all objects in the assignment accept this collision, at block 142. There are some conditions in which an object cannot collide with another object. For instance, one of the objects in an assignment may belong to another VDACC. If the collision is not accepted, then the process is aborted. If the collision is accepted, then for each object in the assignment, the object is added to the VDACC, at block 144 and subsequent block, and the process is done.

Turning now to FIG. 36, a flow diagram for adding an object to a VDACC is shown. At block 160, a determination is made whether “prevent clipping” is on. If yes, then another determination is made whether the object falls completely within the VDACC border, at block 162. If no, the process is done. If yes, then a determination is made whether the object accepts the collision with this VDACC, at block 164. This calls test routines in the incoming object. If yes, then a determination is made whether the object is an info canvas, at block 166. If no, the process proceeds to block 170, where the control is added to the VDACC graphic linker. If no, a determination is made whether the owner of the Info Canvas is already in this VDACC. If no, then the process is done. If yes, then control is added to the VDACC graphic linker. As used herein, the word “control” means graphic object.

After the control is added to the VDACC graphic linker, the control is told that it is now a part of this VDACC and the control just keeps a note of which VDACC it belongs to, at block 172, and the process is done.

If an object is dragged into a VDACC so that its perimeter falls completely within the perimeter of the VDACC of if the tip of the mouse cursor is within the perimeter of the VDACC but part of the object's perimeter is not, then the object is immediately clipped into that VDACC and it is added to the graphic linker of that VDACC. If, in the Info Canvas for this object, the entry “Prevent Clipping” is turned on, then dragging this object into the VDACC will not result in its being added to the graphic linker list of that VDACC.

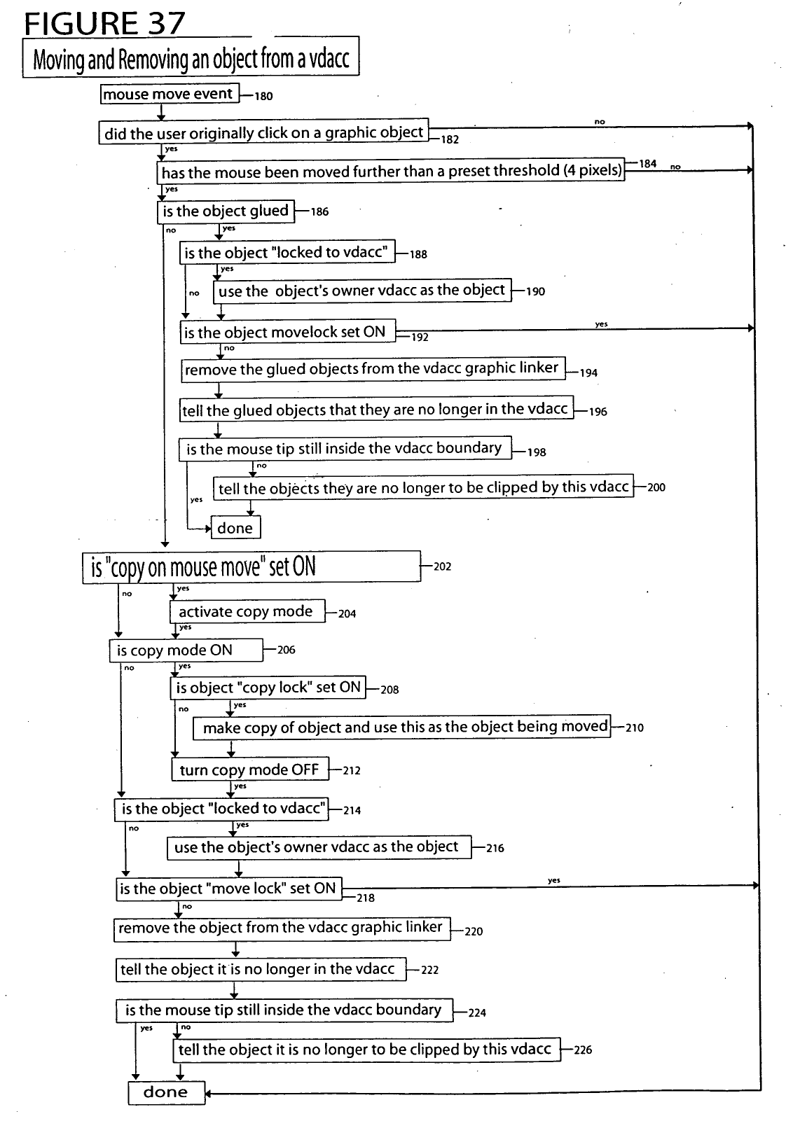

Turning now to FIG. 37, a flow diagram for moving and removing an object from a VDACC is shown. When the mouse is clicked on an object and then moved in a VDACC (and a drawing or text mode is not selected), the object is detached from the VDACC and taken to the top of the layering tree. Although the object is no longer a member of the VDACC, clipping is maintained until the mouse moves outside the VDACC's boundaries.

At block 180, a mouse is moved by a user. If yes, a determination is made whether the user originally clicked on a graphic object, at block 182. If no, the process is done. If yes, a determination is made whether the mouse has been moved further than a preset threshold (4 pixels), at block 184. This distance threshold can be any number of pixels. Its default is 4 pixels. This means that if an object is moves less than 4 pixels, it not considered to have been moved. If the mouse has moved, then a determination is made whether the object is glued, at block 186. If no, then the process proceeds to block 202. If yes, then a determination is made whether the object is “locked to VDACC”, at block 188. If no, then the process proceeds to block 192. If yes, then the object's owner VDACC is used as the object, at block 190.

An example of this would be having a photo clipped into a VDACC where the photo fills the entire visible area of the VDACC. In order to move the VDACC by clicking on and dragging the picture, the picture would have to be locked to the VDACC. This way when the picture is clicked on and dragged, it is the VDACC and its contents that are moved instead of just the picture.

At block 192, a determination is made whether the object movelock is set ON. If yes, then the process is done (exit the routine). If no, then the glued object is removed from the VDACC graphic linker, at block 194. Next, at block 196, the glued objects are told that they are no longer in the VDACC. Next, at block 198, a determination is made whether the mouse tip is still inside the VDACC boundary. If yes, the process is done. If no, then the objects are told that they are no longer to be clipped by this VDACC and the process is done. This last step is to update the object's definition and clear them so they no longer have any pointers to the VDACC. Note: when the tip of the mouse cursor is moved outside a VDACC, the object that was inside that VDACC immediately updates its clipping information and is no longer clipped to that VDACC. This happens before the mouse up-click. It happens the moment the mouse tip passes outside the VDACC that the object was clipped into.

Next, at block 202, a determination is made whether “copy on mouse move” is set ON. If no, the process proceeds to block 206. If yes, the copy mode is activated, at block 204. Next, at block 206, a determination is made whether copy mode is ON. If no, the process proceeds to block 214. If yes, then another determination is made whether the object “copy lock” is set ON. If no, then the process proceeds to block 212. If yes, copy of the object is made and the copy is used as the object being moved. Next, at block 212, the copy mode is turned OFF.

Next, at block 214, a determination is made whether the object is “locked to VDACC”. If no, then the process proceeds to block 218. If yes, the object's owner VDACC is used as the object, at block 216.

Next, at block 218, a determination is made whether the object “move lock” is set ON. If yes, the process is done. If no, the object is removed from the VDACC graphic linker, at block 220. Next, at block 222, the object is told that the is no longer in the VDACC.

Next, at block 224, a determination is made whether the mouse tip is still inside the VDACC boundary. If yes, the process is done. If no, the object is told that the object is no longer to be clipped by this VDACC.

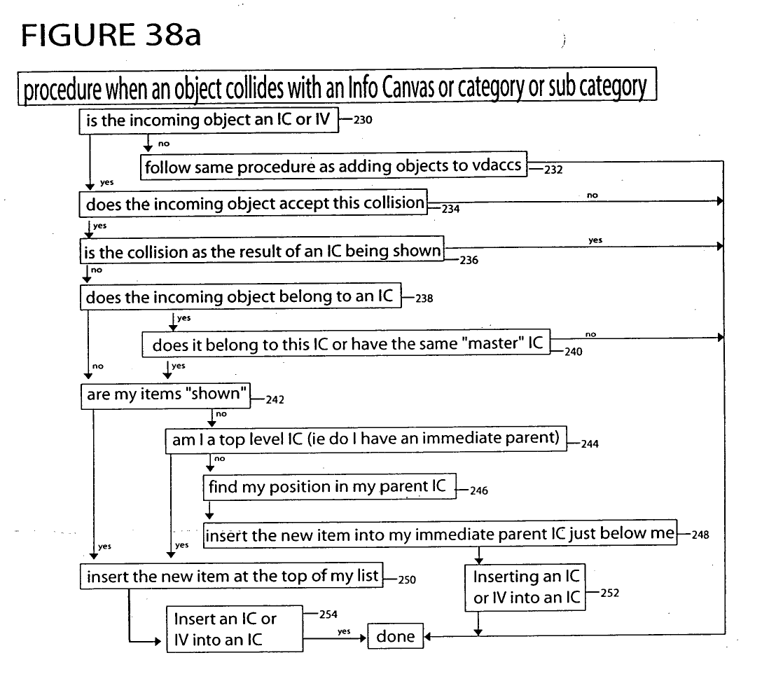

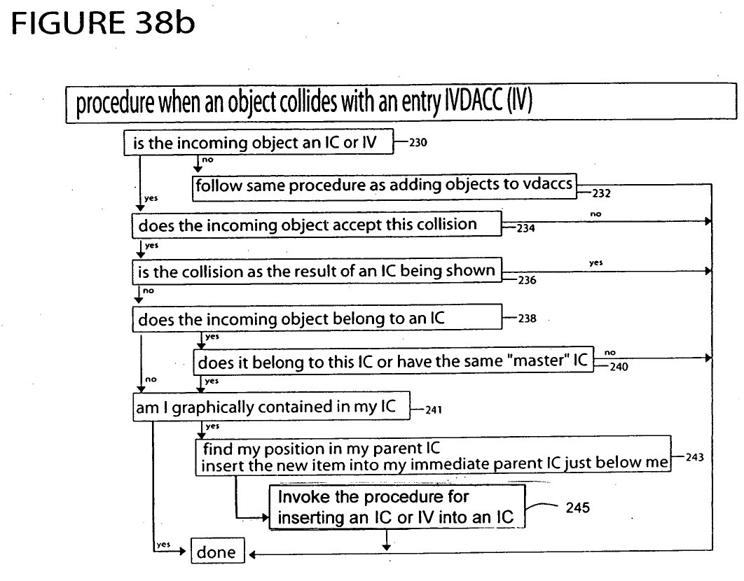

Turning now to FIGS. 38a and 38b, flow diagrams of procedures when an object collides with an Info Canvas or an IVDACC are shown. Normally, Info Canvases are constructed by the system object that they relate to (e.g., a green star or a red rectangle), according to a scheme devised by the software programmer. For example, right-clicking on a star will cause the default Info Canvas for a star to be created. However the Info Canvas can be customized by the user according to their own desires.

In both cases, broadly speaking, the same procedure is followed. When the programmer creates an IVDACC, it is added to the Info Canvas in a similar fashion to what happens when the user drags an IVDACC onto an IVDACC. Category and sub-category IVDACCs and entry IVDACCs follow the same rules as VDACCS for accepting collisions when an object is dragged over and released onto an IVDACC. However there are some additional tests.

Dynamically Created Info Canvases

All Info Canvases are created on-the-fly the first time a user right-clicks on an object. This has the benefit of keeping the processor load for the creation of Info Canvases for graphic objects in the system to a minimum. Info Canvases are created as a user needs them. If an object is never right-clicked on, the Info Canvas for that object is never created.

Another behavior of Info Canvases is this. Once an Info Canvas is created for an object, it can be modified. If it is then closed, these modifications are not lost. They remain as part of the definition of the object to whom this Info Canvas belongs. If desired, this Info Canvas and its modifications (customizations) can be saved to a log (a Blackspace file) where they are preserved for later use.

With respect to the flow diagrams of FIGS. 38a and 38b, the term “object” refers to any graphic object, device, photo, video, etc. that exists in the Blackspace system. The term “IC” means any Info Canvas or IVDACC that is either a category or sub-category. Entry IVDACCs are excluded. The flow diagram of FIG. 38a shows the procedure when an object collides with an Info Canvas. At block 230, a determination is made whether an incoming object is an Info Canvas (IC) or an IVDACC (IV). If no, then the same procedure for adding object to VDACCs is followed, at block 232, and the process is done. If yes, then a determination is made whether the incoming object accepts this collision, at block 234. If no, the process is done. If yes, then a determination is made whether the collision is the result of an IC being shown, at block 236. “Being shown” means that the Info Canvas may appear over the top of another object or group of objects when its parent object is right-clicked on. The software does not want to agglomerate this Info Canvas to these objects just because the Info Canvas has collided with them by virtue of the fact that is appeared on top of them.

If yes, then the process is done. The collisions are ignored. If no, then a determination is made whether the incoming object belongs to an Info Canvas, at block 238. If no, then the process proceeds to block 242. If yes, then a determination is made whether the incoming object belongs to this Info Canvas or have the same “master” Info Canvas, at block 240. If no then the process is done. If yes, then a determination is made whether my items are “shown”, at block 242. “My” means the Info Canvas that this object is colliding with. “Shown” means that a category has been expanded (opened) so all of this IVDACCs are visible onscreen.

If “shown”, the process proceeds to block 250, where the new item is inserted at the top of my list. The item is another IVDACC. Let's say the item has collided with the category General. In this case, the item will go to the top of the list of this category. Namely, it will be the top IVDACC as listed under General.

If not “shown”, then a determination is made whether I am a top level IC (i.e., do I have an immediate parent?), at block 244. “Immediate parent” means an IC that contains this item as part of its organized list. An IVDACC that has no immediate parent is typically sitting on the Blackspace canvas by itself. If yes, the process proceeds to block 150. If no, then my position in my parent IC is found, at block 246. Next, at block 248, the new item is inserted into my immediate parent IC just below me.

After block 250, an IC or an IV is inserted into the IC with which the incoming object has collided, at block 254 and the process is then done. Similarly, after block 248, an IC or an IV is inserted into the IC with which the incoming object has collided, at block 252, and the process is done. The process of inserting an Info Canvas or Category or Sub-category IVDACC into an Info Canvas is described next.

Turning now to FIG. 38b, this flow diagram shows the procedure when an object collides with an IVDACC. Up to and including block 238, this procedure is the same as the procedure when an object collides with an Info Canvas. However, in the current procedure, if the incoming object does not belong to an IC, then the process proceeds to block 241, where a determination is made whether I am graphically contained in my IC. “Graphically contained” means that this item has been snapped into the automatic geometry of its parent. In other words, it is a member of its parent's graphic linker. This step is also performed if the incoming object does belong to an IC and it does belong to this IC or have the same “master” IC.

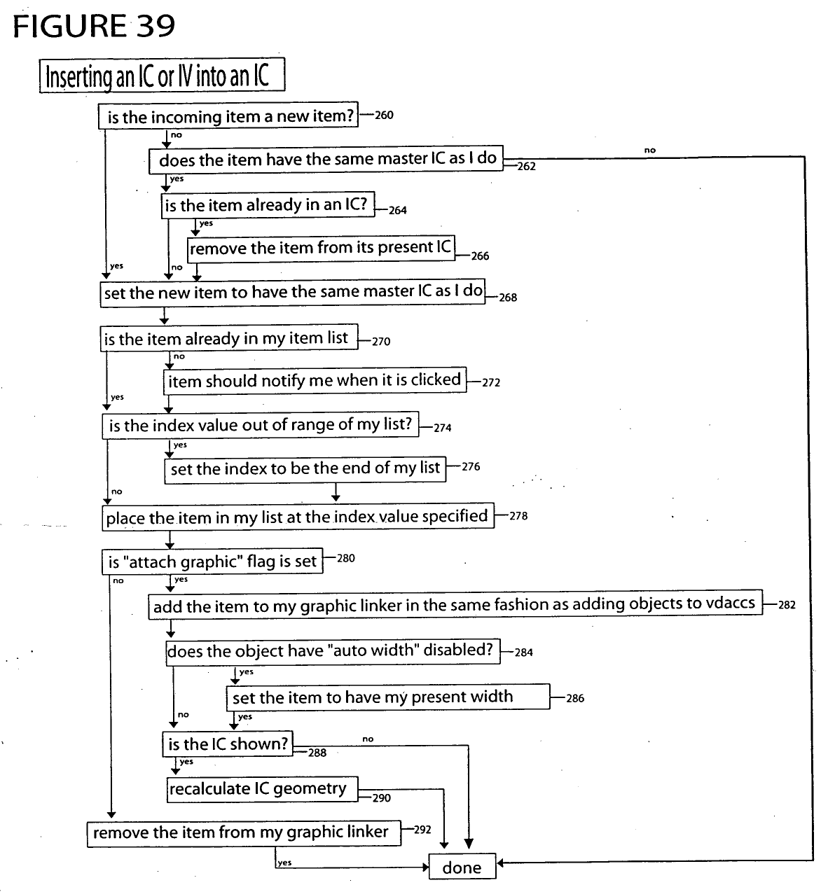

If, at block 241, it is determined that I am not graphically contained in my IC, then the process is done. Otherwise, the process proceeds to block 243, where my position in my parent IC is found and the new item is inserted into my immediate parent IC, just below me. Next, at block 245, the procedure for inserting an IC or IV into an IC is invoked (as shown in FIG. 39).

Turning now to FIG. 39, a flow diagram of a procedure in an Info Canvas to insert a new item is shown. For the purposes of this flow chart, the item has already been determined to be a category or sub-category IVDACC. This procedure is invoked whenever an IVDACC is inserted into an Info Canvas, for example, by user dragging, automatic insertion by the software, or when loading information from a saved log. Two pieces of information are passed into this procedure:
(1) An index. This is the position in the list that the new item should adopt.
(2) A flag. This flag says whether the item is to be inserted graphically into this Info Canvas.

The index is the position in the list where the object will go. If the Info Canvas has 10 IVDACCs in it and the user wants to put his/her IVDACC in position 5, then the index would be 5.

Referring now to the flow diagram of FIG. 39, a determination is made whether the incoming item is a new item, at block 260. If yes, then the process proceeds to block 268. If no, a determination is made whether the incoming item has the same master Info Canvas as I do, at block 262. If no, then the process is done. If yes, a determination is made whether the item is already in an Info Canvas, at block 264. If no, then the process proceeds to block 268. If yes, the item is removed from its present Info Canvas, at block 266.

At block 268, the new item is to have the same master IC as I do. This means the IVDACC that is being dragged to the Info Canvas or IVDACC will have the same parent IVDACC or Info Canvas as what it is being dragged to. Next, at block 70, a determination is made whether the item is already in my item list. That is, is the IVDACC that is being dragged already listed in the Info Canvas or IVDACC to which it is being dragged? If yes, then the process proceeds to block 274. If no, then the item should notify me when it is clicked, at block 272.

Next, at block 274, a determination is made whether the index value is out of range of my list. If no, then the process proceeds to block 278. If yes, the index is set to be the end of my list, at block 276. Next, at block 278, the item is placed in my list at the index value specified.

Next, at block 280, a determination is made whether “attach graphic” flag is set. This is a flag to attach the graphic to what it has collided with. It determines whether the incoming object will be snapped into the automatic geometry calculations or whether it will remain as an independent graphic on screen. If no, the item is removed from my graphic linker, at block 292, and the process is done. If yes, the item is added to my graphic linker in the same fashion as adding objects to VDACCs, at block 282. This adds the IVDACC to the graphic linker of the Info Canvas just as a VDACC would add a star object dragged into it to its graphic linker.

Next, at block 284, a determination is made whether the object has “auto width” disabled. If no, then the process proceeds to block 288. If yes, the item is set to have my present width, at block 286. The snapping of IVDACCs into a container VDACC (either a Primary Info Canvas container or a category or sub-category container) makes the width of the dragged IVDACC conform to the width of the IVDACC to which it is being dragged.

Next, at block 288, a determination is made whether the IC is shown. If yes, Info Canvas geometry is recalculated (described below), at block 290, and the process is done.

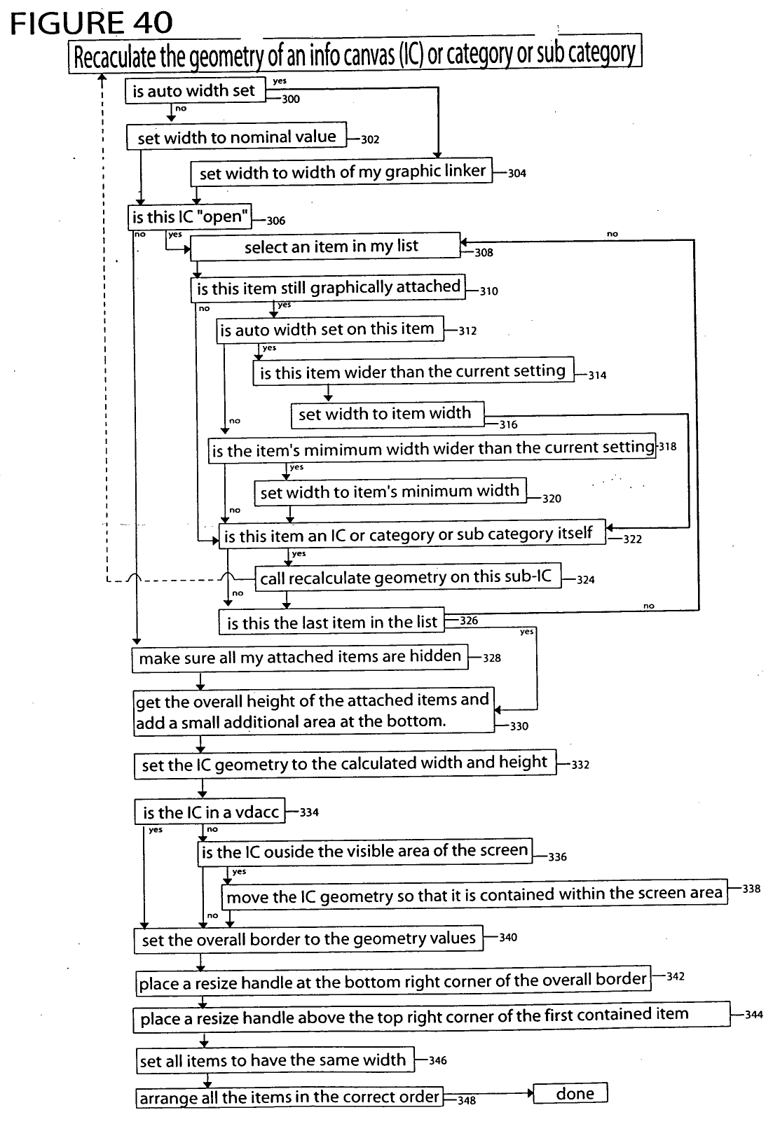

Turning now to FIG. 40, a flow diagram for recalculating the geometry of an Info Canvas is shown. At block 300, a determination is made whether “auto width” is set. If yes, then the process proceeds to block 304. If no, the width is set to a nominal value, at block 302. The process then proceeds to block 306. At block 304, the width is set to width of my graphic linker.

Next, at block 306, a determination is made whether this Info Canvas is “open”. If no, then the process proceeds to block 328. If yes, an item in my list is selected, at block 308. In the first instance, the selected item is the first item in the list. Next, at block 310, a determination is made whether this item is still graphically attached. If no, then the process proceeds to block 322. If yes, a determination is made whether “auto width” is set on this item, at block 312. If no, then the process proceeds to block 318. If yes, then a determination is made whether the item is wider than the current setting, at block 314. Next, at block 316, the width is set to the item width, and then the process proceeds to block 322.

At block 318, a determination is made whether the item's minimum width is wider than the current setting. If no, then the process proceeds to block 322. If yes, the width is set to item's minimum width. Next, at block 322, a determination is made the item is an Info Canvas. If no, then the process proceeds to block 326. If yes, recalculate geometry is called on this sub-Info Canvas, at block 324.

Next, at block 326, a determination is made whether this is the last item in the list. If no, then the process proceeds back to block 308. If yes, then the process proceeds to block 330.

At block 328, all my attached items are made sure to be hidden. Next, at block 330, the overall height of the attached items is gotten and a small additional area is added at the bottom. Next, at block 332, the Info Canvas geometry is set to the calculated width and height.

Next, at block 334, a determination is made whether the Info Canvas is in a VDACC. If yes, then the process proceeds to block 340. If no, a determination is made whether the Info Canvas is outside the visible area of the screen. If no, then the process proceeds to block 340. If yes, the Info Canvas geometry is moved so that it is contained within the screen area.

At block 340, the overall border is set to the geometry values. Next, at block 342, a resize handle is placed at the bottom right corner of the overall border. Next, at block 344, a resize handle is placed at the top right corner of the first contained item. Next, at block 346, all items are set to have the same width. Next, at block 348, all the items are arranged in the correct order and the process is done.

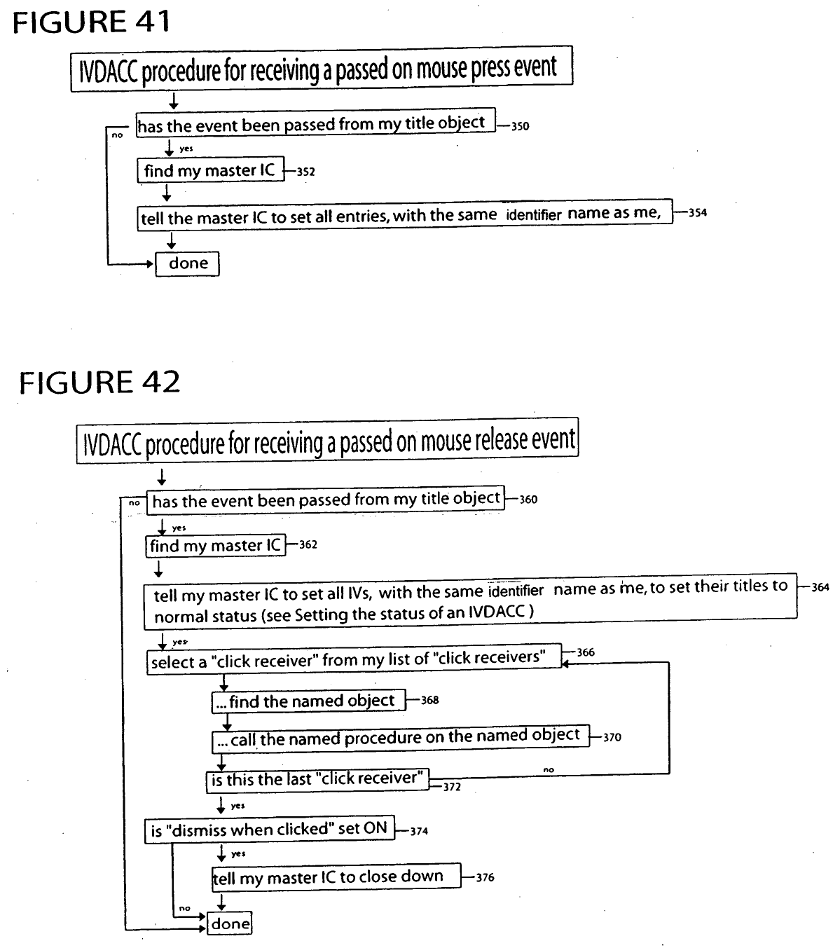

Turning now to FIG. 41, a flow diagram of IVDACC procedure for receiving a passed on mouse press event is shown. “Receiving a passed on mouse press event” means that an IVDACC has received a mouse event having been handed it by its label. An example of a mouse press event would be left-clicking on an IVDACC.

When a graphic object is designated as the title (the label) for an Info Canvas or IVDACC, the object is told that it should pass mouse press and mouse release events to the Info Canvas or IVDACC, instead of processing the event itself.

Regarding the flow diagram of FIG. 41, at block 350, a determination is made whether the mouse press event has been passed from my title object. In other words, has a user clicked on the label? If no, the process is done. If yes, the master IC of the IVDACC is found, at block 352. In other words, find the Primary Info Canvas that the IVDACC that has been clicked on belongs to. Next, at block 354, the master IC is told to set all entries with my identifier name to set their titles BLUE and the process is done. When the function for an IVDACC operates as a momentary switch, the text for its label momentarily turns blue when it's left-clicked on.

Turning now to FIG. 42, a flow diagram of IVDACC procedure for receiving a passed on mouse release event is shown. At block 360, a determination is made whether a mouse release event has been passed from my title object. If no, the process is done. If yes, the master IC of the IVDACC is found, at block 362. Next, at block 364, the master IC is told to set all IVs with my identifier name to set their titles to normal status (see Setting the status of an IVDACC below). This means that the IVDACC label is no longer the color blue and it returns to being either green (indicates that the function for that IVDACC is on) or gray (indicates that the function for that IVDACC is off).

Next, at block 366, a “click receiver” is selected from my list of “click receivers.” Normally, there would only be one click receiver. The click receivers are the object and function which were designated as being the action that is called forth when you left-click on the label for an IVDACC. An example of a click receiver would be the entry “Invisible” in an IVDACC. The click receivers would contain a list of an object and an identifier name, like “switch, make invisible.”

Next, at block 368, the named object is found. Next, at block 370, the named procedure is called on the named object. With respect to blocks 368 and 370, the object is the generally the object that was clicked on the original call forth the Primary Info Canvas that contains the IVDACC that is being clicked on. But this is not always the case. For instance, if the entry “Show Inkwell” in the Blackspace Info Canvas is activated, this causes the Inkwell to appear on screen. In this case, the object is not the object originally clicked on to cause the Info Canvas to appear. Here it is the inkwell. The action “show inkwell” applies to an inkwell, not to Blackspace, which is what was right-clicked on to cause the Blackspace Info Canvas to appear.

Next, at block 372, a determination is made whether the current click receiver is the last click receiver from the list. If no, then the process proceeds back to block 360. If yes, a determination is made whether “dismiss when clicked” is set ON, at block 374. If no, the process is done. If yes, the master IC is told to close down, at block 376, and the process is done. What close down means is that when the label is left-clicked on, the Primary Info Canvas that is its parent will disappear.

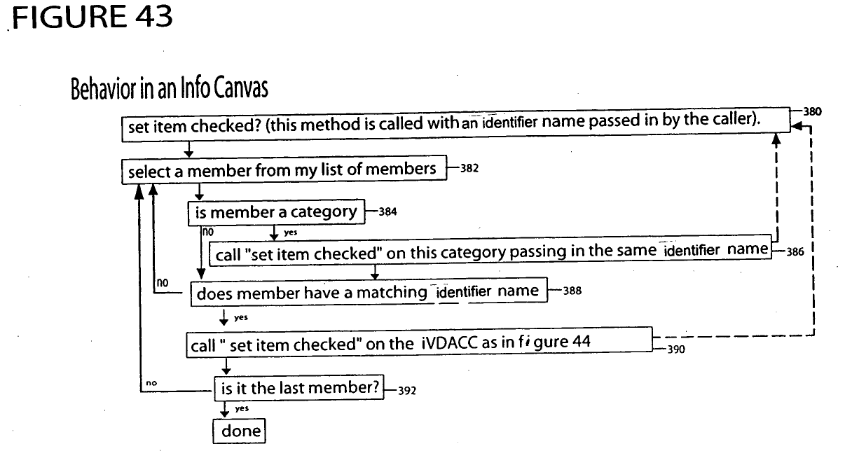

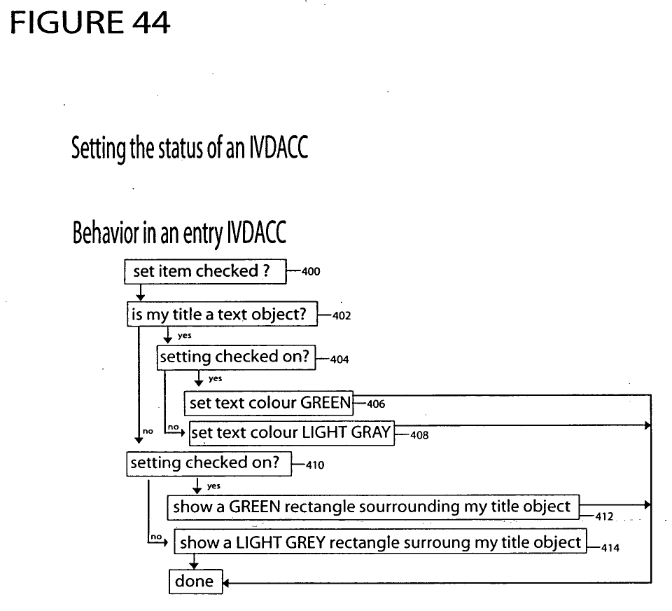

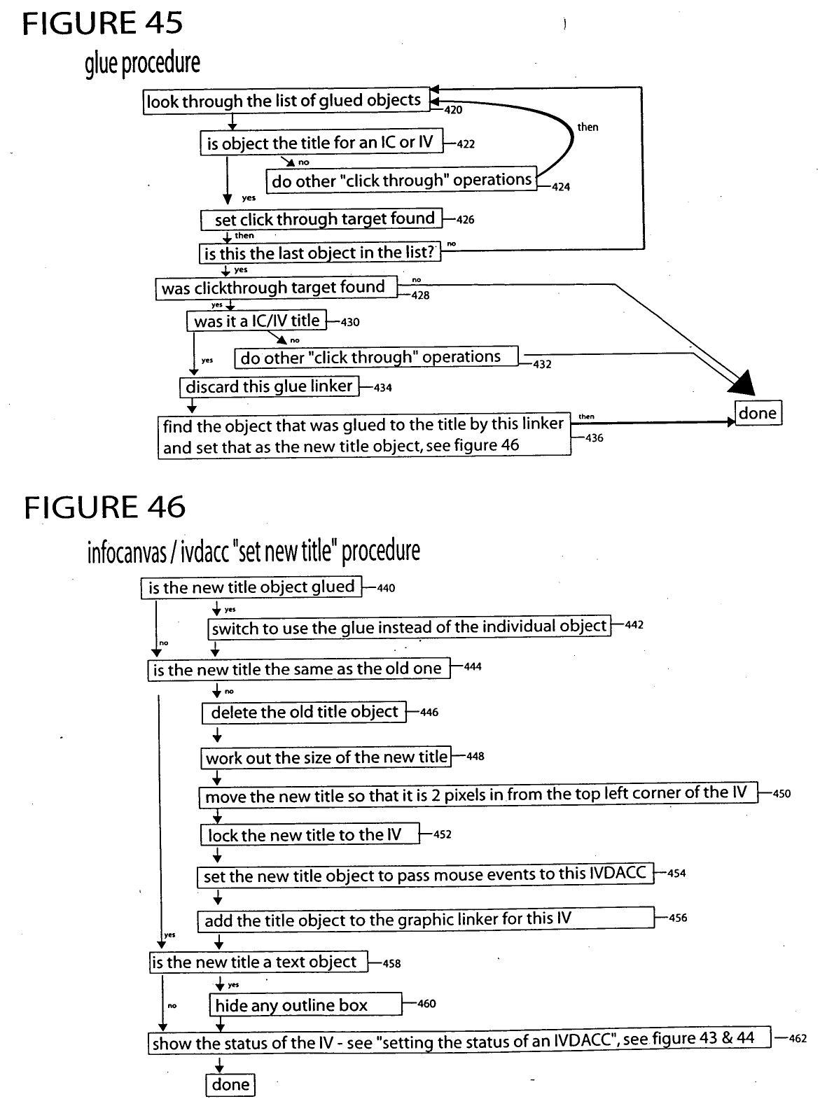

Turning now to FIG. 43, a flow diagram for setting the status of an IVDACC (behavior in an Info Canvas) is shown. This method is called with an identifier name passed in by the caller. “Set item checked?” at block 380 is the name of this procedure. Iterate through all my members. “Members” is all the objects in the list of entries, categories and sub-categories in an Info Canvas. One of my members is selected at block 382. Next, at block 384, a determination is made whether the member is a category or sub-category. If no, then the process proceeds to block 388. If yes, then “set item checked” is called on this Info Canvas passing in the same identifier name, at block 386. The process then proceeds back to block 380. Thus, this is a recursive behavior. When you come to a category you're calling the method “set item checked” on an Info Canvas. It goes through its list and if it reaches a category, it calls “set item checked” on that object and it gives it the same parameters that it was given when it was called.

The “call” means call a function. This is an example of this process: a switch is right-clicked on and its Info Canvas appears. Let's say the entry “invisible” is being turned on. The software looks at the list of IVDACCs in the Info Canvas for the switch. The first thing is “Delete”, no it's not this, “Color: cyan”, no it's not this, “Rescale”—no it's not this, “General.” This is a category so it's opened and its list is looked at. So the software goes here and finds the entry “Invisible”. Then it calls “invisible” to be “on” under the category General. Then the software continues down the list under General, “Always Under”, no it's not this, “Always Over”, no it's not this, until it gets to the end. All these comparisons are with identifier names not with the text in the IVDACC labels.

At block 388, a determination is made whether the member has a matching identifier name. If no, then the process proceeds to block 392. If yes, “set item checked” is called on the IVDACC as in the flow diagram of FIG. 44. Next, at block 392, a determination is made whether the current member is the last member. If no, then the process proceeds back to block 382. If yes, then process is done.

Turning now to FIG. 44, a flow diagram for setting the status of an IVDACC (behavior in an entry IVDACC) is shown. IVDACCs have a status flag which is either “checked” or “not checked”. This is used to indicate the on or off condition of some feature associated with that entry IVDACC. Any part of the software can set any entry IVDACC to be checked (turned on) or not, but this is usually managed by the info canvas that the entry IVDACC belongs to. This is so that different parts of the IC keep in sync with each other.

Setting the checked state of entry IVDACCs is entirely the responsibility of the object it refers to. There is nothing in an IVDACC which controls whether the label for an IVDACC is green or gray, on or off. This status is controlled by what owns the Info Canvas, in other words the object that was right-clicked on to cause the Info Canvas to appear onscreen. This object issues instructions to turn any one or more of the IVDACCs on or off in its Info Canvas. The entry IVDACCs themselves keep track of whether they are on or off.

There is no internal or automatic connection between clicking on an entry IVDACC and setting its checked status. Each object in the Blackspace system can own an IC and when it wants to display the change of some internal condition (e.g., “invisible”). It can ask its Info Canvas to set all appropriate items to be checked.

Referring to the flow diagram of FIG. 44, “set item checked?” at block 400 is the name of the procedure. The “item” is the entry IVDACC. Next, a determination is made whether my title is a text object, at block 402. This means was the label for an IVDACC replaced with a picture, drawing or some type of non-text graphic object. If no, then the process proceeds to block 410. If yes, another determination is made whether the setting is checked on, at block 404. An example of this would be having the label “Invisible” turn green, indicating that it is on. If yes, then the text colour is set GREEN, at block 406, and the process is done. If no, then the text colour is set LIGHT GRAY, and the process is done.

At block 410, a determination is made whether the setting is checked on. This means “turn on the label for this IVDACC?” If yes, a GREEN rectangle surrounding my title object is shown, at block 412 and the process is done. If no, a LIGHT GREY rectangle surrounding my title object is shown, and the process is done.

Blocks 410, 412 and 414 are related to the ability to replace any text label in any IVDACC with a graphic. This graphic can be an individual graphic or a collection of graphics that are glued together. When the graphic or glued conglomerate graphic object is used to replace a text object in an IVDACC (which doesn't have to be an entry, it could be a category or sub-category), the original text label disappears the moment the graphic object is glued to the IVDACC text label. This is accomplished by lassoing the text object and the dragged graphic object and selecting “Glue” in the Info Canvas for the dragged object.

If the dragged object is a glued conglomerate of graphic objects, they are dealt with an object by having the system recognize the glue as the object. This is an important point, as this method enables users of this system to create complex conglomerates of objects that are glued and have them recognized as though they were a single object. One way that the software does this is to recognize the glue and not the objects. In either case, when a text object is replaced with a dragged graphic, a bounding rectangle appears around the perimeter of the dragged object as it sits in the IVDACC in place of that IVDACC's text label. Then when the “set item checked” procedure is called, the on/off status of this IVDACC will be changed. When the status is “on”, the bounding rectangle is green. When the status is “off”, the bounding rectangle is gray. Other colors can be used, but these are generally the default colors for the system.

Turning now to FIG. 45, a flow diagram for a part of a glue procedure is shown. At block 420, the list of glued objects is looked through. Next, at block 422, a determination is made whether the object is the title for an Info Canvas or IVDACC. If yes, then the process proceeds to block 426. If no, other “click through” operations are performed and reiterate this procedure until a title is found.

At block 426, “click through target found” is set. Next, at block 428, a determination is made whether click through target was found. If no, the process is done. If yes, then another determination is made whether the target was a title of an Info Canvas/IVDACC, at block 430. This means does the label belong to an IVDACC? If no, then other “click through” operations are performed, at block 432.

At block 434, this glue linker is discarded. Next, at block 436, the object that was glued to the title by this linker is found and that object is set as the new title object and the glue process is done. This continues to the flow diagram of FIG. 46, which is a flow diagram for a “set new title” procedure of an Info Canvas/IVDACC.

The title (label) object for an IVDACC or an Info canvas can be changed without affecting its function. The user procedure for doing this is the same as that for applying a graphic label to a switch, i.e., by gluing the new title to the old title. The title as a default in the system is a text object that appears on each IVDACC to identify it's function or purpose. An example would be “invisible” or “Delete.”

The flow diagram of FIG. 46 describes the procedure after a user has dragged a graphic object over the top of a text object in an IVDACC and has lassoed both objects and selected “Glue” in the Info Canvas for the dragged graphic object. As an example, let's say that the label “Invisible” and a hand drawn happy face that was dragged over it have been lassoed and in the Info Canvas for the happy face the entry “Glue” has been turned on.

At block 440, a determination is made whether the new title object is glued. The new title is the new graphic that was dragged to replace the text label for the IVDACC as described in the flow diagram of FIG. 45. The decision at block 440 then means is this new graphic a glued conglomerate object? In other words, is the object made up of multiple graphic objects that were glued together before it was dragged and glued to the text label for the IVDACC. If no, then the process proceeds to block 444. If yes, the software is switched to use the glue instead of the individual object, at block 442.

This is what this means. The software has the capability of recognizing the glue that was used to glue multiple objects together as an object. In other words, the software enables glue to operate as if it were an object. Therefore, if a user creates an object that is comprised of multiple objects that are glued together, this glued conglomerate can appear to the software as a single object.

The step at block 442 is saying, OK, an object has been detected that has been glued to the label for an IVDACC and is it itself a glued object? If so, the glue will be used as the new title (label) for the IVDACC and not the individual objects that were glued. The glue becomes the label object and not the individual objects that were glued together to create a composite graphic object. The software supports the ability to change the definition of objects according to a process that is applied to them. In this case it's the process glue applied to a group of individual graphic objects.

At block 444, a determination is made the new title is the same as the old one. This is a test that is done to cover error conditions, which may arise. A simple example of this is that a user may be moving an IVDACC label accidentally. Maybe the label is removed from the IVDACC and placed back after the mistake was rectified. If the new title is the same, then the process proceeds to block 458. If the new title is not the same, the old title object is deleted, at block 446.

Next, at block 448, the size of the new title is worked out. That is, the geometry of the replacement graphic that was dragged to replace the original text object in the IVDACC is determined. Next, at block 450, the new title is moved so that it is 2 pixels in from the top left corner of the IVDACC. This location is set so that when a one pixel wide line is created as a bounding rectangle around the object, there is room for this line not to collide with the edge of the IVDACC where the new label will reside.

Next, at block 452, the new title is locked to the IVDACC. The new label graphic is locked so it cannot be accidentally clicked on and dragged from the IVDACC. Next, at block 454, the new title object is set to pass mouse events to this IVDACC. This step enables the clicking on the new label to operate the function or action of the IVDACC that the new label is sitting on. Next, at block 456, the title object is added to the graphic linker for this IVDACC. The new label is added to the graphic linker for the IVDACC that it has become the label for.

At block 458, a determination is made whether the new title is a text object. If no, the process proceeds to block 462. If yes, any outline box is hidden, at block 460. If the old label is being re-established, for instance, then a bounding rectangle will not be needed to show the on/off status of the label. The label's color change from green to gray will indicate this. Next, at block 462, the status of the IVDACC is shown (see “setting the status of an IVDACC”), and the process is done. In this step, a bounding rectangle that is drawn using a one pixel wide is placed around the new graphic label. This bounding rectangle will change its color to green when the function for the IVDACC has been activated and will change its color to gray when the function for the IVDACC has been deactivated. Any pair of colors could be used to indicate these on/off statuses.

Picture Cropping Feature of VDACCs

Another feature of VDACCs is that the VDACCs allow a user to crop pictures.

General principles

The VDACC is a container object which provides graphical clipping on the objects it contains. See the VDACC flow diagrams in FIGS. 33-37 and the corresponding descriptions.

If a picture object is dragged into a VDACC, then the parts of the picture which are outside the VDACC boundaries are not visible to the user. If the edges of the VDACC are made invisible, then the user perceives that he/she has a picture which has been cropped down to the size of the VDACC's visible perimeter.

In this situation, the user can decide to save just the visible part of the picture. This is a useful technique for creating picture files which are cropped down parts of an original larger image.

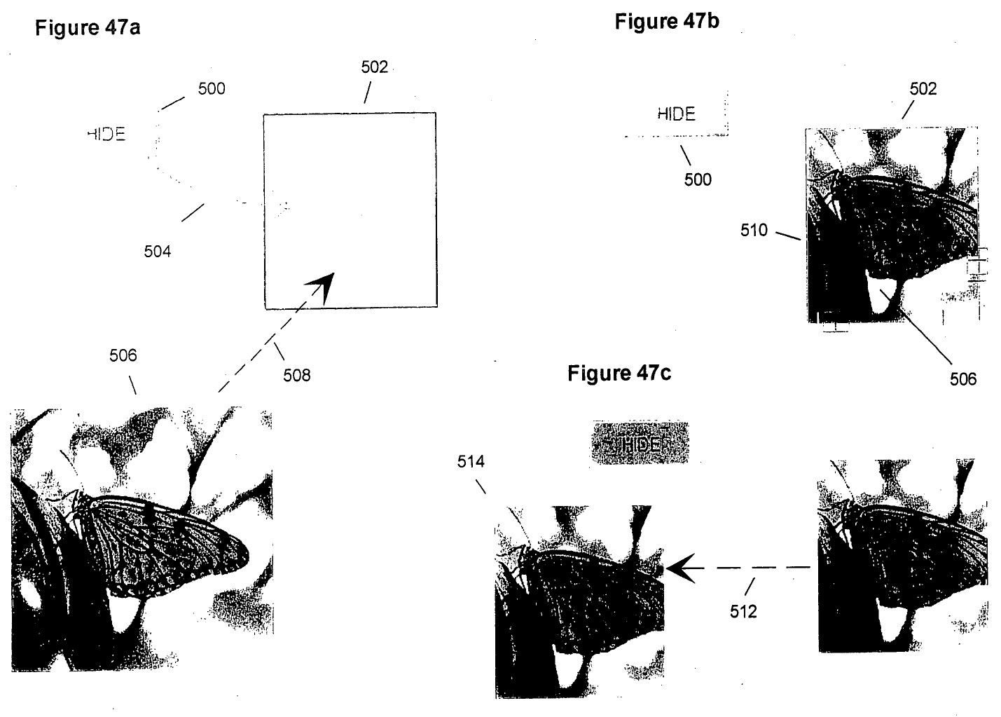

A method for using a hide switch to crop a picture is described with reference to FIGS. 47a-47c.

1. Create a “hide” switch 500. This is accomplished by using Object Points (See pending U.S. patent application Ser. No. 10/103,680 entitled “Method for Controlling Electronic Devices Using Object Point Tool”, filed on Mar. 22, 2002, which is incorporated herein by reference). To create a switch using Object Points, left-click on two points within one second, where the two points are more than a defined distance apart, e.g., ¼^{th} inch. Upon the mouse up-click a switch will appear. Then type the word: “Hide” on the switch.

When the word “Hide” is typed on the switch 500, it is not recognized by the switch manager as having any particular function at this stage and so the switch remains inactive.

2. Create a VDACC 502. This can be done by using the VRT switch 500 to draw a VDACC. (See pending U.S. patent application Ser. No. 10/053,075)

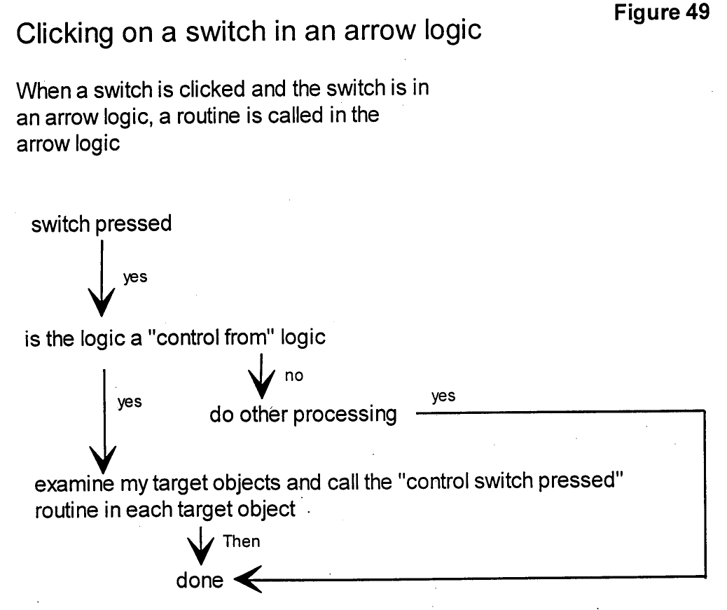

3. Select the color red in the Onscreen Inkwell and draw a red “Control From” arrow 504 from the switch 500 to the VDACC 502. (description of how an arrow determines what it is drawn from and what it is drawn to is described below with reference to the flow diagram of FIG. 49) After the arrow 504 is drawn perform a mouse up-click and the arrowhead for this arrow will turn white. This indicates the it has been drawn between two objects that provide a valid context for its arrow logic.

4. Left-click on the white arrowhead of the red arrow 504. This completes the procedure of creating a VDACC controlled by a hide switch.

5. Recall a picture to Blackspace. One way to do this is to use a specifier. A specifier is a letter or phrase that the software recognizes as causing an action. This software supports many specifiers, including “s” for sound, “p” for picture, “v” for video, “d” for data, etc. Type a “p” in Blackspace and hit the Esc key or its equivalent and the Picture Files VDACC will appear onscreen. Double click on the name of a picture file in this VDACC and that picture (photo) will appear in Blackspace.

6. Drag the picture 506 into the VDACC 502 (shown as path 508) that is controlled by the Hide switch 500, such that the picture clips into the VDACC. The idea here is to drag a picture into the VDACC that is larger than the VDACC. The VDACC can be resized smaller if the picture is not larger than the VDACC. When the picture is dragged into the VDACC 502, the picture is clipped into the VDACC. This causes one or more scroller caps 510 to appear on one or more the edges of the VDACC.

7. Click on the Hide switch 500. This will cause the VDACC 502 to disappear. This includes all visible portions of the VDACC 502, e.g., its perimeter line, its close and maximize boxes and its resize button.

8. Immediately after step 7, click and hold for a specified time, e.g., one second, on the picture 508 that is in the VDACC 502 and drag away (for example along path 512) a copy of the picture 514. This copy will be the exact size of the perimeter of the VDACC 502.

9. Save this picture and give it a name and a file type. Right-click on the picture 514 and in its Info Canvas select “Capture Image.” This will bring to the screen a save media VDACC. In this VDACC select the type of image file, e.g., .png, .bmp, .jpeg, .gif, etc. Type a name for the image file and left-click on “Save.” This completes the process of cropping a picture in a VDACC and saving the cropped picture as a picture file with a new name.

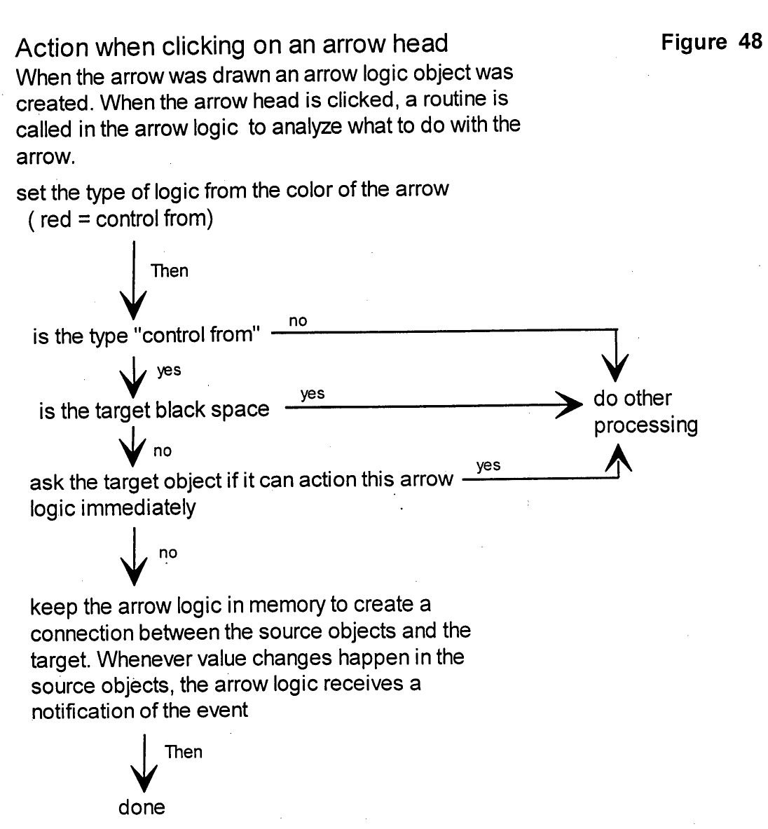

Turning now to FIG. 48, a flow diagram of action when clicking on an arrowhead is shown. The flow diagram of FIG. 48 is now described.

When you click on the arrowhead, the mouse click calls a routine for the arrow which says I've made an arrow logic so I'll call a routine in the arrow logic. And that analyzes all the objects which have been intersected by the head and the tail.

Then, set the type of logic from the color of the arrow. In this case, it's red, so it's a “control from” arrow logic.

Then, is the target black space? That means the tip of the arrow is pointing to black space. If yes, then do other processing.

If, no, then ask the target object if it can action this arrow logic immediately? In the case of cropping a picture the user needs to be able to make the decision as to what is cropped and when it is cropped, so having the arrow logic carried out immediately would not be appropriate.

If no, then keep the arrow logic in memory to create a connection between the source objects and the target. Whenever value changes happen in the source objects, the arrow logic receives a notification of the event. Then the process is done.

What that means, is rather than doing an action right away, all we're doing is setting up a connection between the source objects and the target object and then just leave that connection sitting there waiting for something to happen on the source object, and when it does, the arrow logic is still present to receive that event and pass it on to the target. The target is the VDACC that contains the picture.

At this point, the hide switch is ready to be activated to cause the arrow logic to hide the VDACC. This in turn has the effect of cropping the image in the VDACC. This is because the normal behavior of a VDACC makes any part of any image clipped into it invisible where it is outside the perimeter of the VDACC. Once the VDACC itself it hidden by turning on the hide switch, a duplicate of the image can be made by clicking and holding on the image and dragging away a copy. Once a copy is made, it can be saved as a picture file.

Up to the point where the cropped image is saved as a picture file, it is still inside the VDACC, even though the VDACC is completely invisible. This has strong value for using such pictures in a layout. The value is this. This picture along with its invisible VDACC can be placed in a text document, e.g., a brochure or advertisement. Multiple pictures, each in their own VDACC can be placed into this same document. The benefit is that as long as the cropped pictures are still in a VDACC, the hide switch can be turned off, revealing the invisible VDACCs for each of the pictures.

Then the pictures can be repositioned in their VDACCs or the VDACCs can be resized larger or smaller. Both actions will cause the picture to be cropped differently when the hide switch is turned back on. By this approach, a user can create layouts with numerous “cropped” pictures in VDACCs, but the capability to change the crop for any and all of the pictures will remain as long as they stay in their respective VDACCs and as long as the VDACCs remain under the control of the hide switch.

Turning now to FIG. 49, a flow diagram for clicking on a switch in an arrow logic is shown. When a switch is clicked and the switch is in an arrow logic, a routine is called in the arrow logic. The flow diagram of FIG. 49 is now described. An arrow logic is itself an object. It's the object that was created when the arrow is drawn and it made a “control from” arrow logic, which in this case owns the switch (hide switch) as the source and the VDACC as the target. So this arrow logic is present in the system.

Then, is the switch pressed? When the arrow logic receives the switch press signal, it immediately calls the method in the target which is called control press, that's the name of a routine in all objects which is actioned when the arrow logic calls it.

Is the logic a control logic? If no, do other processing. If yes, then examine my target objects and call the “control switch pressed” routine in each target

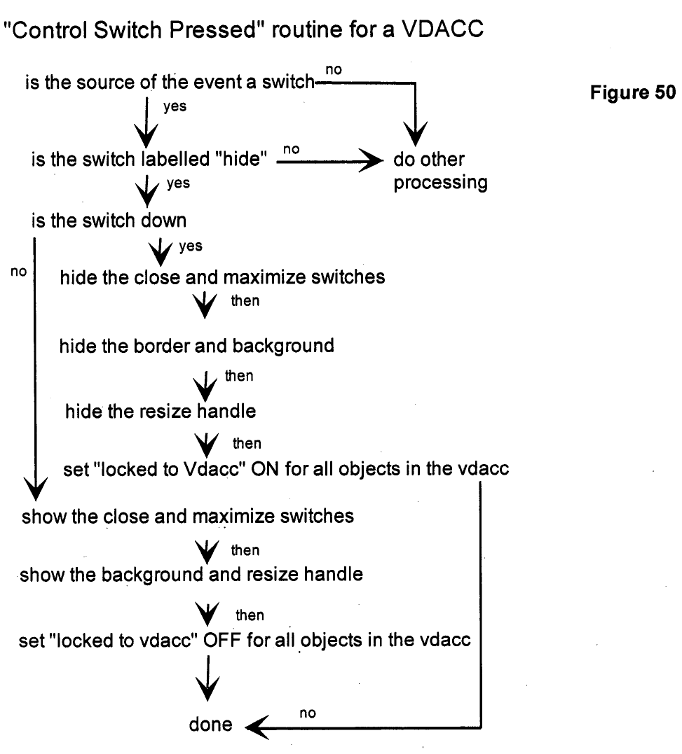

Turning now to FIG. 50, a flow diagram for a control switch pressed routine for a VDACC is shown. The flow diagram of FIG. 50 is now described.

Is the source of the event a switch, if no, do other processing. If yes, then is the switch labeled “hide?”.

If no, do other processing. If yes, is the switch down? In other words, is the source switch turned on?

If no, then show the close and maximize switches. Then, show the background and resize handle, and set “locked to VDACC” OFF for all objects in the VDACC. Then the process is done.

Referring back to is the switch down? If yes, then hide the close and maximize switches. Then hide the VDACC's border and background. Then hide the resize handle. And the process is done.

All of these things are what is required to hide the VDACC. These are all the visible elements of the VDACC that are hidden when the hide switch is depressed. Note: Lock to VDACC is turned on because the picture is filling the entire inner area of the VDACC. So, there is no way to effectively move the VDACC. If a user left-clicks on the picture, it will move the picture, not the VDACC. By locking the picture to the VDACC, a user can click on the picture and move the VDACC when the picture is moved.

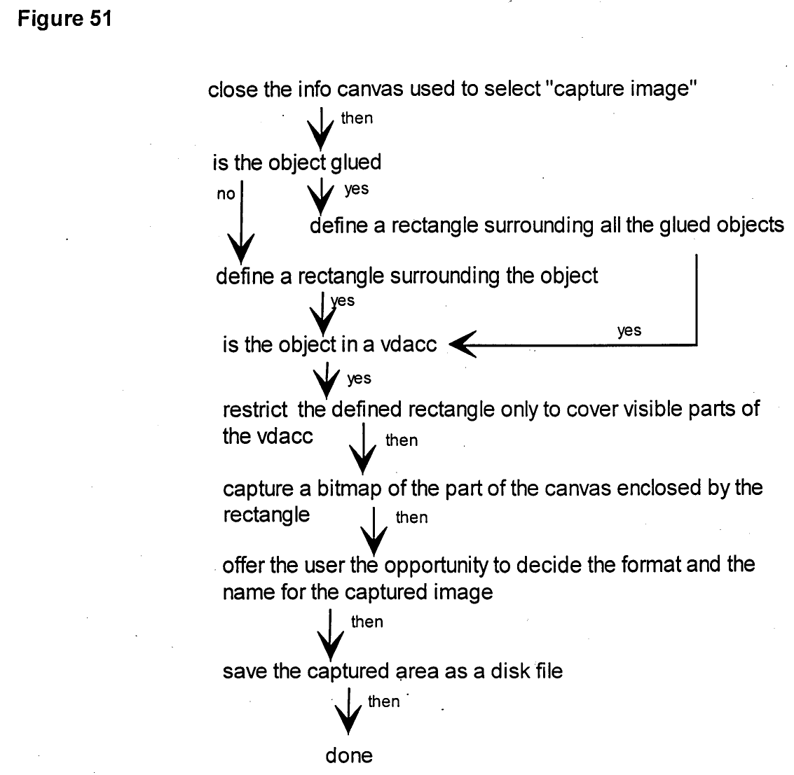

Turning now to FIG. 51, a flow diagram for saving a picture is shown. The flow diagram of FIG. 51 is now described.

Select “capture image” in the general category of a picture's Info Canvas. This saves a copy of the section of screen occupied by the picture as a bitmap.

If the object selected is clipped into a VDACC then the area captured is restricted to the visible part of the object.

Close the info canvas used to select capture image. This is done to get rid of the Info Canvas before a user starts creating any bitmaps of the image so that the Info Canvas doesn't appear in the captured image. This is so the Info Canvas isn't over top of the image.

Is the object glued? The object is the object that was right clicked on. If no, define a rectangle surrounding the objects. That rectangle is defined by the perimeter of the object. If the object is clipped into a VDACC, this rectangle is defined as the perimeter of the VDACC. This is the case, even when a VDACC is invisible as when a hide switch that controls a VDACC is on.

If yes, then define a rectangle surrounding all the glued objects. A rectangle is created that bounds the entire group of glued objects.

Then, is the object in a VDACC? If yes, then restrict the defined rectangle only to cover visible parts of the VDACC. Only what is visible in a VDACC will be captured as an image (saved as a picture).

Then, capture a bit map of the part of the canvas enclosed by the rectangle. The rectangle is passed to the drawing surface software and that has a mechanism where you can say create a bit map from this area of the screen.

Then, offer the user the opportunity to decide the format and the name for the captured image. A pop up of the picture save file browser appears that enables the user to select the type of picture format, e.g., .png, .jpeg, .bmp, .gif, etc., for what the user is about to save.

Then, save the captured area as a disk file and the process is done.

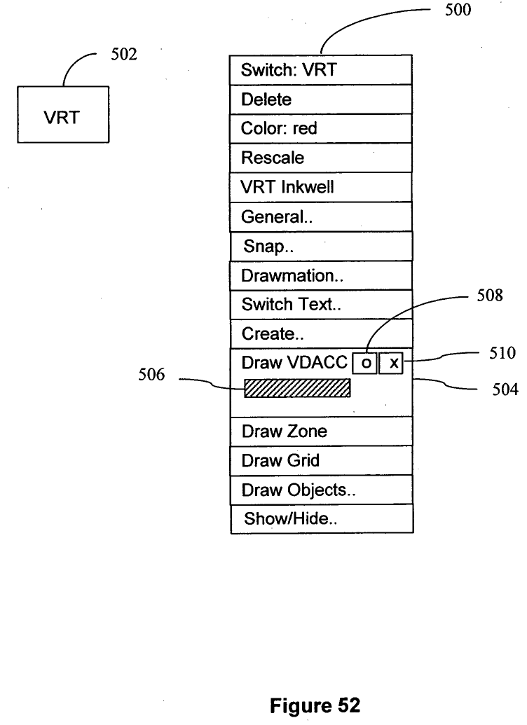

Turning now to FIG. 52, an Info Canvas 500 for a VRT switch 502 is shown. The Info Canvas 500 includes an entry “Draw VDACC” 504. In the entry “Draw VDACC” 504, there is a rectangular region 506 and two switches 508 and 510. The rectangular region 506 can be filled with a user-defined color by, for example, using a free draw inkwell. The fill color of the rectangular region 506 determines the fill color of VDACCs that are created when the entry “Draw VDACC” 504 is activated. As an example, if the fill color of the rectangular regions 506 is set to the color red, then the fill color of any VDACC created will have a fill color of red.

The switches 508 and 510 correspond to maximize and close switches of VDACCs, respectively. In fact, these switch may have the same appearance as the maximize and close switches of VDACCs. The maximize and close switches of a VDACC are illustrated in FIG. 1. The activation of one or both of these switches 508 and 510 determines whether newly created VDACCs will include maximize and/or close switches. As an example, if only the switch 508 is activated, then newly created VDACCs will only have maximize switches. Similarly, if only the switch 510 is activated, then newly created VDACCs will only have close switches. If both switches 508 and 510 are activated, then newly created VDACCs will have both maximize and close switches. If neither switch is activated, then newly crated VDACC will have neither maximize switches nor close switches.

Although the invention has been described herein as a software program, in other embodiments, the invention may be implemented in any combination of software, hardware and/or firmware. An embodiment of the invention includes a storage medium, readable by a computer, tangibly embodying a program of instructions executable by the computer to produce the GUI and to perform method steps for operating in the GUI, as described herein.

Although specific embodiments of the invention have been described and illustrated, the invention is not to be limited to the specific forms or arrangements of parts so described and illustrated. The scope of the invention is to be defined by the claims appended hereto and their equivalents.

1. (canceled).

2. (canceled).

3. (canceled).

4. (canceled).

5. (canceled).

6. A graphic user interface for an electronic device with a display comprising:
a global drawing surface on which different graphic elements can be created, said different graphic element existing on said global drawing surface; and
a display-and-control graphic element on said global drawing surface having a local drawing surface on which additional graphic elements can be created, said display-and-control graphic element having a viewable area that can selectively display a portion of said local drawing surface such that some of said local drawing surface is not displayed, said display-and-control graphic element being configured such that said additional graphic elements on said local drawing area are managed by said display-and-control graphic but exist on said global drawing surface.

7. The graphic user interface of claim 6 wherein said display-and-control graphic element is configured such that said local drawing surface provides a same operational environment as said global drawing surface.

8. The graphic user interface of claim 7 wherein said display-and-control graphic element includes one of a maximize switch and a close switch.

9. The graphic user interface of claim 6 wherein a first graphic element of said additional graphic elements in said display-and-control graphic element is functionally linked with a second graphic element of said different graphic elements on said global drawing surface.

10. The graphic user interface of claim 9 wherein said first graphic element in said display-and-control graphic element and said second graphic element on said global drawing surface are configured such that said first graphic element is controlled by said second graphic element.

11. The graphic user interface of claim 9 wherein said first graphic element in said display-and-control graphic element and said second graphic element on said global drawing surface are configured such that said second graphic element is controlled by said first graphic element.

12. The graphic user interface of claim 9 wherein said different graphic elements, said additional graphic elements and said display-and-control graphic element can be saved as a log, including relative positions and functional associations of said different graphic elements, said additional graphic elements and said display-and-control graphic element.

13. The graphic user interface of claim 6 further comprising a second display-and-control graphic element on said global drawing surface, said second display-and-control graphic element including a graphic element that is functionally linked with a particular graphic element, said particular graphic element being one of said different graphic elements on said global drawing surface or one of said additional graphic elements in said display-and-control graphic element.

14. The graphic user interface of claim 6 further comprising a second display-and-control graphic element on said local drawing surface of said display-and-control graphic element such that said second display-and-control graphic element is located within said display-and-control graphic element, said second display-and-control graphic element including a graphic element that is functionally linked with a particular graphic element, said particular graphic element being one of said different graphic elements on said global drawing surface or one of said additional graphic elements in said display-and-control graphic element.

15. The graphic user interface of claim 6 further comprising a graphic control device on said global drawing surface, said graphic control device being functionally linked with a particular graphic element of said additional graphic elements in said display-and-control graphic element such that a relative layering position of said particular graphic element is controlled by said graphic control device.

16. The graphic user interface of claim 6 further comprising a second display-and-control graphic element associated with a particular graphic element of said different graphic elements, said second display-and-control graphic element being configured to be activated to modify a property of said particular graphic element.

17. The graphic user interface of claim 16 wherein said second display-and-control graphic element is one of a set of display-and-control graphic elements, each display-and-control graphic element of said set being configured to be activated to modify a unique property of said particular graphic element.

18. A program storage device readable by a machine, tangibly embodying a program of instructions executable by said machine to provide a graphic user interface on a display, said graphic user interface comprising:
a global drawing surface on which different graphic elements can be created, said different graphic element existing on said global drawing surface; and
a display-and-control graphic element on said global drawing surface having a local drawing surface on which additional graphic elements can be created, said display-and-control graphic element having a viewable area that can selectively display a portion of said local drawing surface such that some of said local drawing surface is not displayed, said display-and-control graphic element being configured such that said additional graphic elements on said local drawing area are managed by said display-and-control graphic but exist on said global drawing surface.

19. The program storage device of claim 18 wherein said display-and-control graphic element is configured such that said local drawing surface provides a same operational environment as said global drawing surface.

20. The program storage device of claim 19 wherein said display-and-control graphic element includes one of a maximize switch and a close switch.

21. The program storage device of claim 20 wherein a first graphic element of said additional graphic elements in said display-and-control graphic element is functionally linked with a second graphic element of said different graphic elements on said global drawing surface.

22. The program storage device of claim 21 wherein said first graphic element in said display-and-control graphic element and said second graphic element on said global drawing surface are configured such that said first graphic element is controlled by said second graphic element.

23. The program storage device of claim 21 wherein said first graphic element in said display-and-control graphic element and said second graphic element on said global drawing surface are configured such that said second graphic element is controlled by said first graphic element.

24. The program storage device of claim 21 wherein said different graphic elements, said additional graphic elements and said display-and-control graphic element can be saved as a log, including relative positions and functional associations of said different graphic elements, said additional graphic elements and said display-and-control graphic element.

25. The program storage device of claim 18 wherein said graphic user interface further comprises a second display-and-control graphic element on said global drawing surface, said second display-and-control graphic element including a graphic element that is functionally linked with a particular graphic element, said particular graphic element being one of said different graphic elements on said global drawing surface or one of said additional graphic elements in said display-and-control graphic element.

26. The program storage device of claim 18 wherein said graphic user interface further comprises a second display-and-control graphic element on said local drawing surface display-and-control graphic element such that said second display-and-control graphic element is located within said display-and-control graphic element, said second display-and-control graphic element including a graphic element that is functionally linked with a particular graphic element, said particular graphic element being one of said different graphic elements on said global drawing surface or one of said additional graphic elements in said display-and-control graphic element.

27. The program storage device of claim 18 further comprising a graphic control device on said global drawing surface, said graphic control device being functionally linked with a particular graphic element of said additional graphic elements in said display-and-control graphic element such that a relative layering position of said particular graphic element is controlled by said graphic control device.

28. The program storage device of claim 18 wherein said graphic user interface further comprises a second display-and-control graphic element associated with a particular graphic element of said different graphic elements, said second display-and-control graphic element being configured to be activated to modify a property of said particular graphic element.

29. The program storage device of claim 28 wherein said second display-and-control graphic element is one of a set of display-and-control graphic elements, each display-and-control graphic element of said set being configured to be activated to modify a unique property of said particular graphic element.

30. A method for providing a computer environment comprising:
generating a display-and-control graphic element having a local drawing surface on a global drawing surface, said display-and-control graphic element having a viewable area that can selectively display a portion of said local drawing surface such that some of said local drawing surface is not displayed; and
creating a graphic element on said local drawing surface of said display-and-control graphic element such that said graphic element is managed by said display-and-control graphic but exist on said global drawing surface.

31. The method of claim 30 wherein said display-and-control graphic element is configured such that said local drawing surface provides a same operational environment as said global drawing surface.

32. The method of claim 30 further comprising functionally linking said graphic element in said display-and-control graphic element with a second graphic element on said global drawing surface.

33. The method of claim 32 wherein said functionally linking includes functionally linking said graphic element in said display-and-control graphic element with a second graphic element on said global drawing surface such that said graphic element is controlled by said second graphic element.

34. The method of claim 32 wherein said functionally linking includes functionally linking said graphic element in said display-and-control graphic element with a second graphic element on said global drawing surface such that said second graphic element is controlled by said graphic element.

35. The method of claim 32 further comprising saving said graphic element, said second graphic element and said display-and-control graphic element, including relative positions and functional associations of said graphic element, said second graphic element and said display-and-control graphic element, as a log.

36. The method of claim 30 further comprising:
generating a second display-and-control graphic element on said global drawing surface;
creating a second graphic element in said second display-and-control graphic element; and
functionally linking said graphic element in said display-and-control graphic element with said second graphic element in said second display-and-control graphic element.

37. The method of claim 30 further comprising:
generating a second display-and-control graphic element on said local drawing surface of said display-and-control graphic element such that said second display-and-control graphic element is located within said display-and-control graphic element;
creating a second graphic element in said second display-and-control graphic element; and
functionally linking said graphic element in said display-and-control graphic element with said second graphic element in said second display-and-control graphic element.

38. The method of claim 30 further comprising functionally linking a graphic control device on said global drawing surface with said graphic element such that a relative layering position of said graphic element with respect to other graphic elements on said local global surface of said display-and-control graphic element is controlled by said graphic control device.

39. The method of claim 30 further comprising generating a second display-and-control graphic element on said global drawing surface that is associated with a particular graphic element on said global drawing surface, said second display-and-control graphic element being configured to be activated to modify a property of said particular graphic element.

40. The method of claim 39 wherein said generating of said second display-and-control graphic element includes generating a set of display-and-control graphic elements, each display-and-control graphic element of said set being configured to be activated to modify a unique property of said particular graphic element.
